(19) United States
(12) Patent Application Publication
(10) Pub. No.: US 2026/0011215 A1
(43) Pub. Date: Jan. 8, 2026

(54) ELECTRONIC GAMING SYSTEMS AND METHODS FOR PRESENTING WHEEL-BASED AND INTERACTIVE BONUS GAMES

(71) Applicant: Aristocrat Technologies, Inc., Las Vegas, NV (US)

(72) Inventors: Jeffrey Uss, Reno, NV (US); Brittany Nelson, Reno, NV (US); David Marsh, Charlottesville, VA (US); Daniel Marston, Reno, NV (US); Zachary Cooper, Reno, NV (US); Eric Taylor, Carson City, NV (US); Kevin Walcomb, Reno, NV (US)

(21) Appl. No.: 18/766,188

(22) Filed: Jul. 8, 2024

(51) Int. Cl. G07F 17/32; G06F 3/0488

(52) U.S. Cl. CPC G07F 17/326; G06F 3/0488; G07F 17/3244

(57) ABSTRACT

An electronic gaming system is provided. The electronic gaming system includes a game controller in communication with a display device. The game controller controls the display device to display a base reel game, determine that a base reel game outcome triggers a bonus wheel game, and control the display device to display the bonus wheel game. Displaying the bonus wheel game includes displaying a wheel feature including a plurality of wedges, where each wedge depicts a credit value or an action feature and displaying pointer(s) configured to identify one of the plurality of wedges. Displaying the bonus wheel game also includes controlling at least one of the wheel feature or the at least one pointer to rotate and subsequently stop to determine a bonus wheel game outcome. The bonus wheel game outcome includes the credit value and/or the action feature depicted on the wedge(s) identified by the pointer(s).

### TECHNICAL FIELD

The field of disclosure relates generally to electronic gaming, and more specifically, to electronic gaming systems and methods that present a bonus game having a spinning wheel that includes player interaction and multiple points on the spinning wheel for enhanced awards.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Upon initiation of play, the RNG randomly determines a game outcome and symbols are then selected which correspond to that outcome. Notably, some games may include an element of skill on the part of the player and are therefore not entirely random.

### BRIEF DESCRIPTION

In one aspect, an electronic gaming system includes a display device, and a game controller in communication with the display device. The game controller including at least one processor and at least one memory, the at least one memory for storing instructions, which when executed by the at least one processor, cause the game controller to: control the display device to display a base reel game including a plurality of reels; determine that a base reel game outcome of the base reel game triggers a bonus wheel game; and control the display device to display the bonus wheel game including: causing to be displayed a wheel feature including a plurality of wedges, each wedge of the plurality of wedges depicting one of a credit value or an action feature, causing to be displayed at least one pointer positioned adjacent the wheel feature and configured to identify one of the plurality of wedges of the wheel feature, and control at least one of the wheel feature or the at least one pointer to rotate and subsequently stop to determine a bonus wheel game outcome for a first free spin of at least one free spin, the bonus wheel game outcome including at least one of (i) the credit value depicted on at least one wedge of the plurality of wedges identified by the at least one pointer, or (ii) the action feature depicted on at least one wedge of the plurality of wedges identified by the at least one pointer. The instructions may direct additional, less, or alternate functionality, including that discussed elsewhere herein.

In another aspect, an electronic gaming system includes at least one touch enabled display device, and a game controller in communication with the at least one touch enabled display device. The game controller including at least one processor and at least one memory, the at least one memory for storing instructions, which when executed by the at least one processor, cause the game controller to: control the at least one touch enabled display device to display a base reel game including a plurality of reels; determine that a base reel game outcome of the base reel game triggers an interactive bonus game; and control the at least one touch enabled display device to display the interactive bonus game including: causing to be displayed a plurality of interactive bonus game symbols displayed on the at least one touch enabled display device, each of the plurality of interactive bonus game symbols associated with a credit value or an action feature, and in response to at least one interactive bonus game symbol of the plurality of interactive bonus game symbols being selected via the at least one touch enabled display device, determine an interactive bonus game outcome for a first free play of at least one free play for the interactive bonus game, the interactive bonus game outcome including at least one of (i) the credit value associated with the at least one, selected interactive bonus game symbol of the plurality of interactive bonus game symbols, or (ii) the action feature associated with the at least one, selected interactive bonus game symbol of the plurality of interactive bonus game symbols. The instructions may direct additional, less, or alternate functionality, including that discussed elsewhere herein.

In another aspect, a method of electronic gaming implemented on an electronic gaming machine includes: causing to be displayed a base reel game including a plurality of reels; determining that a base reel game outcome of the base reel game triggers a bonus wheel game; causing to be displayed the bonus wheel game including: a wheel feature including a plurality of wedges, each wedge of the plurality of wedges depicting one of a credit value or an action feature, and at least one pointer positioned adjacent the wheel feature and configured to identify one of the plurality of wedges of the wheel feature; and controlling at least one of the wheel feature or the at least one pointer to rotate and subsequently stop to determine a bonus wheel game outcome for a first free spin of at least one free spin, the bonus wheel game outcome including at least one of (i) the credit value depicted on at least one wedge of the plurality of wedges identified by the at least one pointer, or (ii) the action feature depicted on at least one wedge of the plurality of wedges identified by the at least one pointer. The method may include additional, less or alternate actions, including those discussed elsewhere herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example user interface or screenshot of a base reel game of an example electronic game in accordance with the present disclosure.

FIG. 5 illustrates an example user interface or screenshot of one implementation of a bonus wheel game of the example electronic game in accordance with the present disclosure.

FIG. 6A illustrates an example user interface or screenshot of a base reel game of an example electronic game that triggers a bonus wheel game in accordance with the present disclosure.

FIGS. 6B-6G each illustrate an example user interface or screenshot of another implementation of the bonus wheel game shown in FIG. 5 and initiated after the base reel game shown in FIG. 6A, the bonus wheel game having multiple free spins and action features in accordance with the present disclosure.

FIG. 6H illustrates an example user interface or screenshot of the base reel game shown in FIG. 6A after triggering and playing the bonus wheel game shown in FIGS. 6B-6G in accordance with the present disclosure.

FIGS. 7A and 7B illustrate views of an example wheel feature utilized in another implementation of the bonus wheel game shown in FIG. 5, the wheel featuring having multiple pointers in accordance with the present disclosure.

FIGS. 8A-8C illustrate views of an example wheel feature utilized in an implementation of the bonus wheel game shown in FIG. 5, the wheel featuring having multiple pointers and undergoing an action feature to form a multiplier pointer in accordance with the present disclosure.

FIGS. 8D and 8E illustrate views of an example wheel feature utilized in another implementation of the bonus wheel game shown in FIG. 5, the wheel featuring having multiple pointers and undergoing an action feature to form a multiplier pointer in accordance with the present disclosure.

FIGS. 9A and 9B illustrate views of an example wheel feature utilized in an implementation of the bonus wheel game shown in FIG. 5, the wheel featuring having multiple pointers, and a plurality of action features associated with wedges of the wheel feature in accordance with the present disclosure.

FIGS. 10A and 10B illustrate views of an example wheel feature utilized in another implementation of the bonus wheel game shown in FIG. 5, the wheel featuring having multiple pointers, and a boost action features for increasing credit values depicted on the wheel feature in accordance with the present disclosure.

FIGS. 11A-11C illustrate views of an example wheel feature utilized in an implementation of the bonus wheel game shown in FIG. 5, the wheel featuring having an inner pointer and an outer, rim pointer in accordance with the present disclosure.

FIGS. 12A-12C illustrate views of an example wheel feature utilized in another implementation of the bonus wheel game shown in FIG. 5, the wheel featuring having multiple inner pointers, outer rim pointers, and action feature associated with wedges of the wheel feature in accordance with the present disclosure.

FIG. 13 illustrates a view of an example wheel feature utilized in an implementation of the bonus wheel game shown in FIG. 5, the wheel featuring having an inner wheel feature, an outer wheel feature, and a plurality of pointers extending to either the inner wheel feature or the outer wheel feature in accordance with the present disclosure.

FIG. 14 illustrates a view of an example wheel feature utilized in an implementation of the bonus wheel game shown in FIG. 5, the wheel featuring having an inner wheel feature, an outer wheel feature, a plurality of inner pointers, and a plurality of outer, rim pointers in accordance with the present disclosure.

FIG. 15A illustrates an example user interface or screenshot of a base reel game of an example electronic game that triggers an interactive bonus game in accordance with the present disclosure.

FIGS. 15B-15J each illustrate an example user interface or screenshot of another implementation of the interactive bonus game initiated after the base reel game shown in FIG. 15A, the interactive bonus game having multiple free plays and action features in accordance with the present disclosure.

FIGS. 16A-16D each illustrate an example user interface or screenshot of an implementation of an interactive bonus game initiated after a base reel game, the interactive bonus game having multiple free plays and action features in accordance with the present disclosure.

FIGS. 17A-17E each illustrate an example user interface or screenshot of another implementation of an interactive bonus game initiated after a base reel game, the interactive bonus game having multiple free plays and action features in accordance with the present disclosure.

FIGS. 18A-18D each illustrate an example user interface or screenshot of an implementation of an interactive bonus game initiated after a base reel game, the interactive bonus game having multiple free plays and action features in accordance with the present disclosure.

### DETAILED DESCRIPTION

In conventional electronic gaming systems and methods, awards and/or outcomes of a primary game may be presented to a player as awards and/or outcomes of a secondary game. For example, an electronic gaming device operating a Class II (e.g., bingo or keno) game may present an outcome of the Class II game as a reel game (e.g., a slot game) simulation. The outcome of the Class II game is determinative of an outcome of the simulated reel game. For example, an award value associated with the Class II game outcome may be presented in the simulated reel game outcome as a symbol combination and/or one or more special symbols that correspond to the same award value. In some known Class II games, the award value of the Class II game outcome may be partitioned or distributed across a base reel game outcome and one or more bonus game outcomes (e.g., outcomes of one or more free reel or wheel spins). For example, an award value associated with one or more winning bingo patterns may be presented as being awarded in a base reel game outcome and one or more bonus game outcomes. While some variations exist for presenting the Class II game outcome across the base reel game outcome and/or the one or more bonus game outcomes exist, the variability and flexibility in presenting these outcomes remain limited. A need exists to address these limitations to facilitate increasing player excitement, interaction, and engagement.

Embodiments of the present disclosure provide systems and methods for displaying base reel game outcomes that may include a triggering of one or more wheel-based and/or interactive bonus games. The wheel-based bonus game described herein provides players with a fast-paced animation and the displaying of (potentially) multiple awards or credit values. Additionally, interactive bonus games allow the player to interact with the gaming machine to select awards and credit values during the game. Furthermore, each bonus game can include action features that further adjust, manipulate, and/or alter the bonus game to benefit the player. The operative features, action features, and/or interactive features of the bonus games provide additional entertainment aspects of an electronic game by increasing the variability and flexibility in presenting winning outcomes of the bonus game (e.g., winning symbol combinations and/or special symbols).

The action features may include, for example, creating additional pointers in the wheel-based bonus game to increase the chances and/or credit values the player can be awarded during each play of the bonus game. The action features may further include creating multiplier points in the wheel-based bonus game to increase the credit values awarded to the player during the bonus game by a predetermined factor (e.g., 2×, 3×, 5×, etc.). Additionally, the action features can include adding a free spin or free play for the bonus game to increase the number of turns or rounds a player gets to receive awards during the bonus game. For the interactive bonus game, the action features can similarly include multiplier action features, where credit values associated with player selected bonus game symbols are increased by a predetermined factor. Additionally, action features can include adding additional free plays in the interactive bonus game, allowing the players to select an additional bonus game symbol and/or to play an additional round of selecting bonus game symbols to increase awards.

Various combinations of the operative features, action features, and/or interactive features may be implemented to further increase the variability and flexibility in presenting winning outcomes of the bonus games. In example systems and methods described herein, the presented base reel game outcome and bonus game outcome(s) correspond to an output of a gaming device. The output of the gaming device may be a primary game outcome, such as a Class II (e.g., bingo) game outcome, a Class III (e.g., RNG based) game outcome, and/or an outcome of another wagering game. In Class II games, a total award value of one or more winning outcomes (e.g., winning bingo patterns) may be partitioned or distributed across a base reel game outcome and one or more bonus game outcomes. Applying one or more operative features, action features, and/or interactive features to the bonus game facilitates increasing the flexibility and variability in how Class II game outcomes are presented as an outcome of the bonus game, and facilitates increasing player excitement during the bonus game as each feature may be perceived as providing an additional opportunity for a winning bonus game outcome (e.g., by adding additional pointers to the wheel feature, adding free spins or free plays to the bonus game, etc.), and/or an increased monetary value awarded for a winning bonus game outcome (e.g., by applying a multiplier to winning outcomes via multiplier pointers/multiplier action features). The increased flexibility and variability in the gaming device is achieved without requiring additional memory or other computational resources. In Class III games, the gaming device output may itself be the outcome of the base reel and bonus games (e.g., the gaming device output may be a randomly determined symbol combination and/or special symbol(s) displayed in the game outcome), and the features may be randomly applied to provide additional opportunities to achieve a winning outcome of the bonus game outcome and/or to increase a value awarded for a winning bonus game outcome, thereby facilitating increasing randomness in Class III bonus game outcomes and increasing player excitement and engagement.

The example systems and methods of the present disclosure represent a technical improvement in the field of electronic gaming. Technical improvements represented by the present disclosure include: (i) presenting Class II and Class III game outcomes as one or more outcomes of a bonus game having one or more action and/or interactive features; (ii) applying one or more action and/or interactive features to the bonus game in varying combinations concurrently; (iii) utilizing a special or trigger symbol associated with the action feature(s) for the bonus game to provide additional gameplay features/winning opportunities in the base reel game; (iv) increasing the flexibility and variability in presenting award values of a game outcome as one or more bonus game outcomes to facilitate increasing player interest and excitement; (v) providing players the opportunity to actively participate and physically select awards and outcomes for the bonus games; (vi) displaying immediate bonus game feedback to a player; and/or (vii) displaying potential reward opportunities to the player for a bonus game in advance of triggering the bonus game. Additional and/or alternative technical improvements may exist.

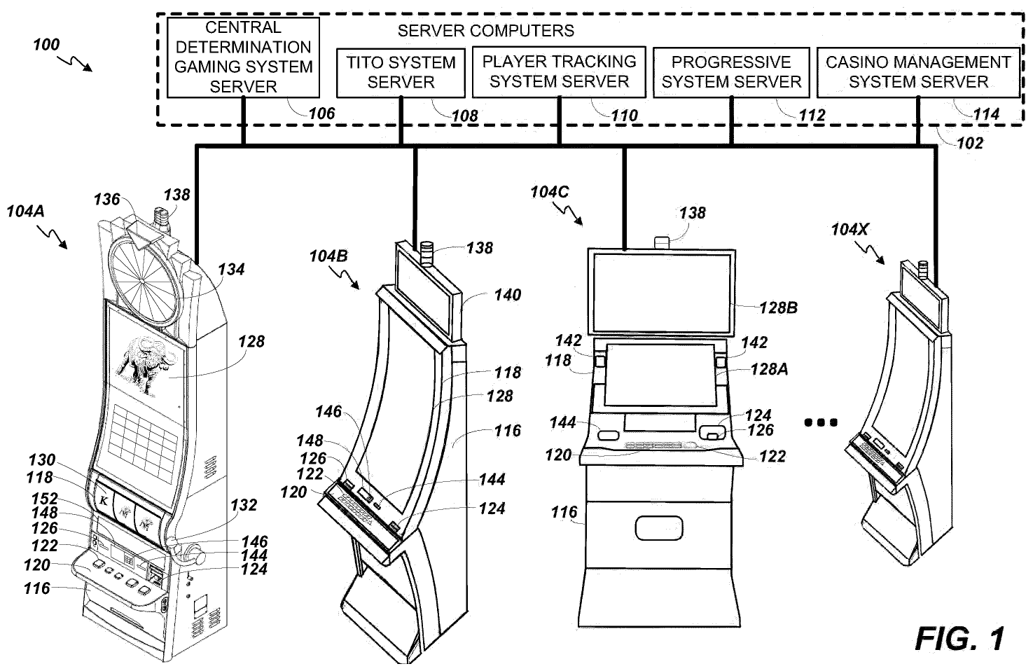

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

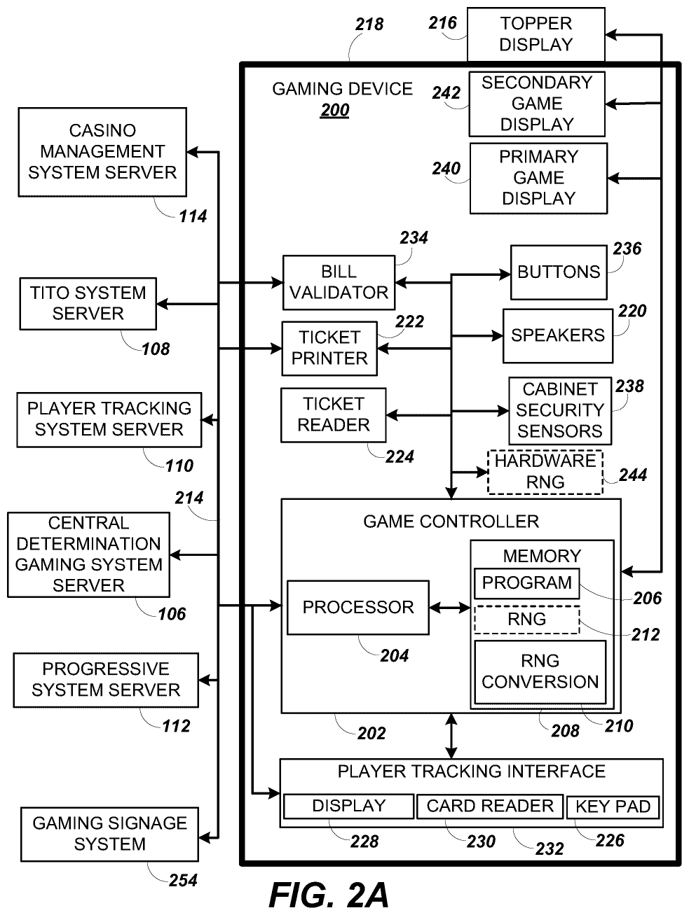

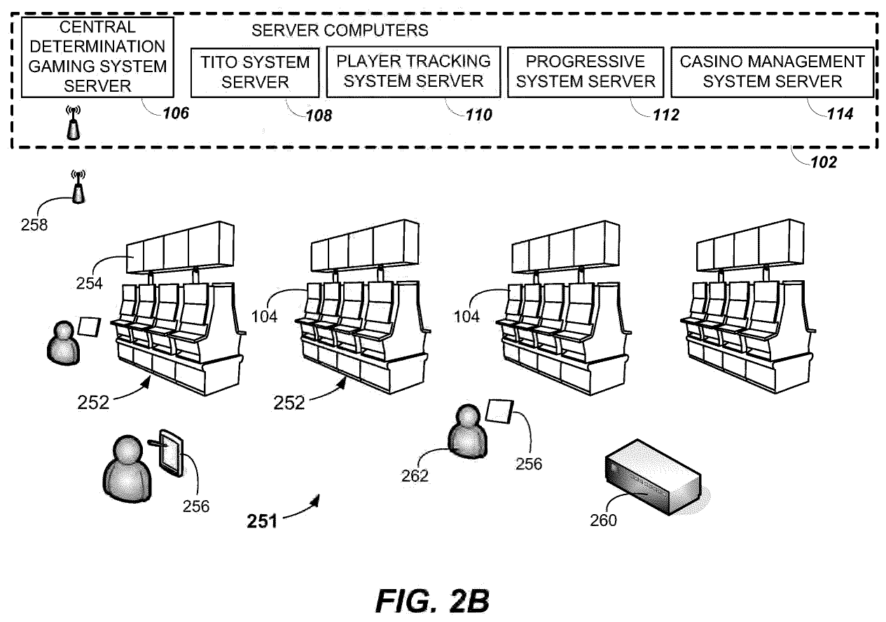

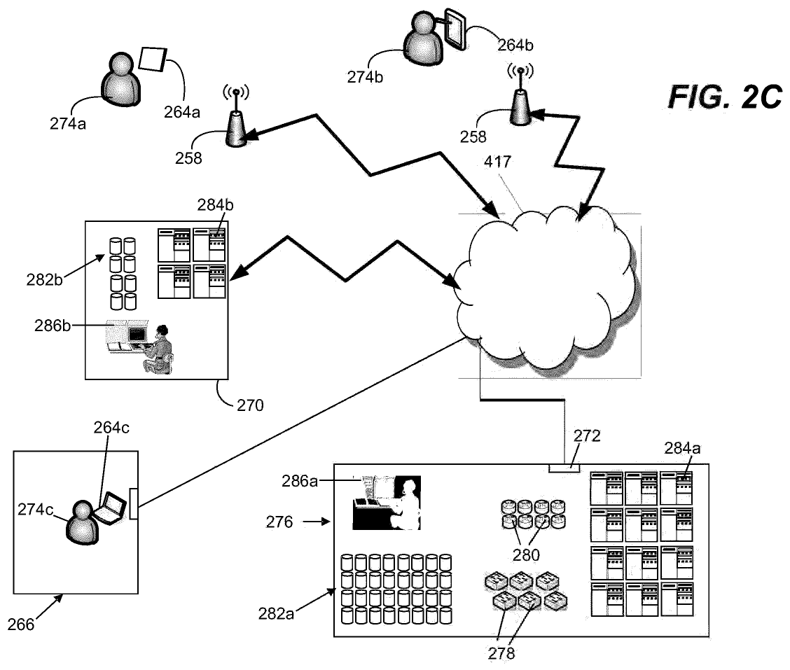

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random-access memory (DRAM), magnetic random-access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

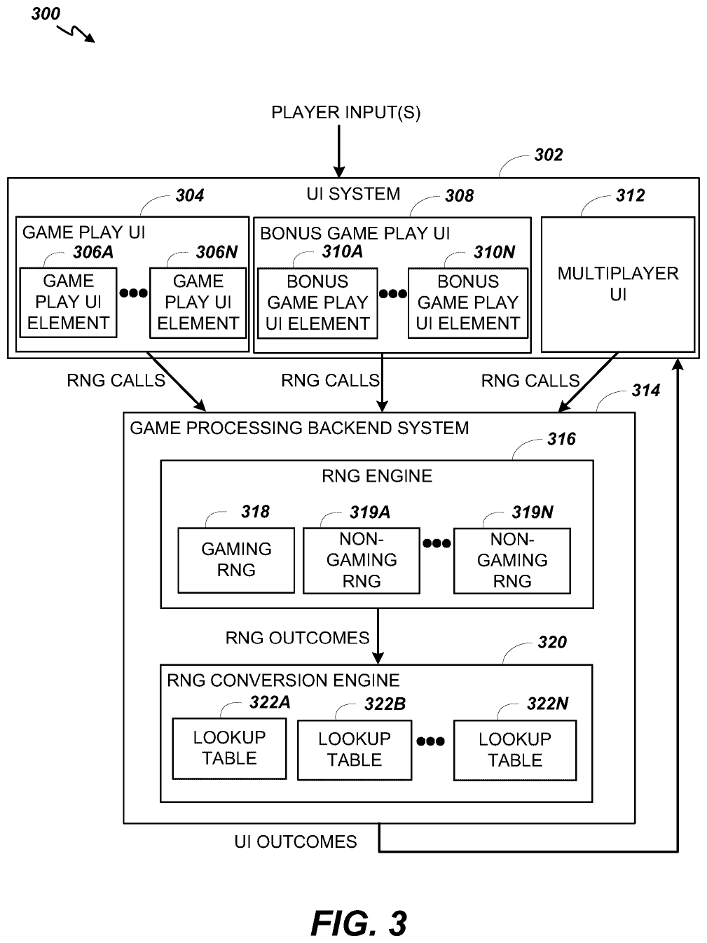

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

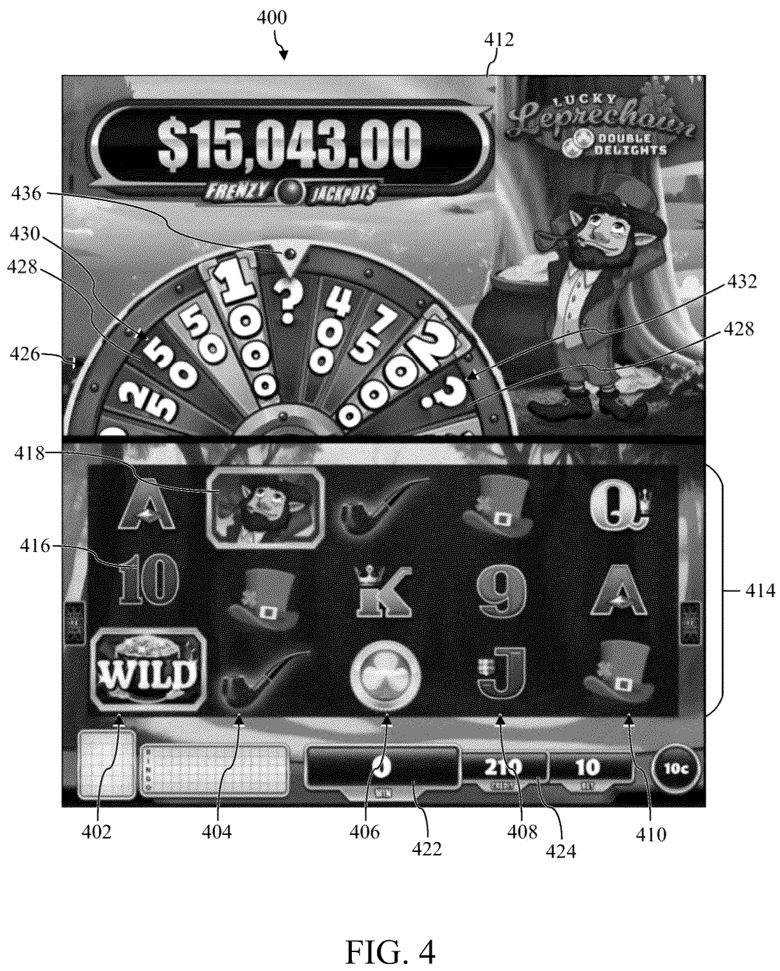

FIG. 4 is a user interface or screenshot of an example base reel game 400 played on a gaming device (e.g., gaming devices 104A-104X in FIG. 1, and/or gaming device 200 and/or mobile gaming device 256 in FIG. 2). Specifically, FIG. 4 shows a base reel game 400, in which a base reel game outcome is displayed that corresponds to (e.g., presents, represents, and/or is determined from) an output of the gaming device. The output may be a primary game outcome determined in response to a wager or credit input received from a player. In example implementations, described in further detail herein, the primary game outcome is a Class II (e.g., bingo) game outcome. Although the example implementations are described herein primarily with reference to presenting outcomes of a Class II (e.g., bingo) game using the base reel game 400, in other implementations, the base reel game outcome may be and/or corresponds to an outcome of a Class III or Las-Vegas style game. In various implementations, the base reel game 400 may be implemented to present an outcome of any suitable game of chance. Specific details of the type of primary game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X and 200. Specifically, a player may fund the base reel game 400 via bill validator 234 and/or ticket reader 224. Once funded, the base reel game 400, which includes a first plurality of reels 402, 404, 406, 408, and/or 410, each including a plurality of game symbols 414, may appear on a primary display 412. The first plurality of reels 402-410 may be physical reels and/or virtual reels. As used herein, physical reels are mechanical in nature and may be physically rotated during gameplay. In contrast, virtual reels are rendered or visually created by game controller 202 on display 412. Display 412 shown in FIG. 4 can correspond to, for example, a primary game display 240 and/or main display 128, 128A, and where reels 402-410 are merely animated to give the appearance of being spun. The first plurality of reels 402-410 of the example base reel game 400 include five reels. In other examples, the number of reels may range from one reel to five or more reels in number. The base reel game 400 may be played on display 412 (e.g., display 128, 128A, 128B) of EGM 104 (see, FIG. 1). However, in other implementations, the base reel game 400 may be played on several displays including display 412 and/or an additional or secondary displays.

In other implementations, the base reel game 400 may be played on a single display and/or on greater than two displays. In the example shown in FIG. 4, the base reel game 400 includes a first reel matrix on the primary display 412. The first reel matrix includes a plurality of symbol positions arranged in a plurality of rows and a plurality of columns. The first reel matrix may also therefore be referred to as a “matrix of symbol positions.” While, in the example shown in FIG. 4, the first reel matrix is displayed on the primary display 412 (e.g., display 128A), the first reel matrix may appear in other locations on an EGM 104A-104X and/or on other displays, such as, for example, the secondary display 128B, a display of button deck 120, and the like.

In the example embodiment shown in FIG. 4, the plurality of reels 402-410 form five distinct reels and/or five columns. Each reel 402-410 also includes a predetermined number of rows as well. In the example, the number of predetermined rows for each reel 402-410 includes has three (3) rows. As a result, in the example embodiment, the plurality of reels 402-410 for base reel game 400 include a 3×5 arrangement, as depicted on display 412, and include fifteen (15) game symbol positions. In other implementations, the plurality of reels 402-410 may be any size/uniformity (e.g., 2×2, 3×3, 4×4, 10×10, etc.), and a number of game symbol positions for the plurality of reels 402-410 may vary depending upon a number of rows and columns of the plurality of reels 402-410. In some implementations, the plurality of reels 402-410 may be replaced by one or more mechanical reels, and the implementations described herein work equally well with mechanical reels as with the virtual plurality of reels 402-410, as shown in FIG. 4. Each row of the plurality of reels 402-410 may be designated by a row number (e.g., “1,” “2,” “3,” etc.). Each column of the plurality of reels 402-410 may be designated by a column letter (e.g., “A,” “B,” “C,” “D,” “E,” etc.). Each game symbol position of the plurality of reels 402-410 may therefore be designated by a symbol position identifier comprising a row number (e.g., “1,” “2,” “3,” etc.) and a column letter (e.g., “A,” “B,” “C,” “D,” “E,” etc.). For example, the upper-left-most game symbol position, occurring at the intersection of row 1 and column A, may be designated by the game symbol position identifier “1A.” In another example, the bottom most game symbol position for reel 410, occurring at the intersection of row 3 and column E, may be designated by the game symbol position identifier “3E.”

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however, mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

As shown in the example of FIG. 4, and as discussed herein, the plurality of game symbols 414 included and/or displayed within the plurality of reels 402-410 include and/or are formed from various symbol types. For example, graphic game symbols 416 of the plurality of game symbols 414 include predetermined graphics, symbols, and/or art works that can be based on a theme, story, and/or visual representation of base reel game 400. Additionally, or alternatively, graphic game symbols 416 include suitable graphics, symbols, and/or artworks commonly associated with gaming device (e.g., “BAR,” “SPIN,” “WILD,” etc.). In Class II games, and as discussed herein, graphic game symbols help, at least in part, in creating façades for base reel game 400 and/or bonus wheel game 500. In an exemplary embodiment, the plurality of game symbols 414 may also include action feature symbols 418. Action feature symbols 418 are associated with a particular action feature. For example, action feature symbol 418 can be associated with a “free spin feature,” which may trigger a bonus wheel game 500 at the completion of base reel game 400, as discussed herein. Similar to graphic game symbols 416, and in Class II games, action feature symbols 418 help, at least in part, in creating façades for base reel game 400 and/or bonus wheel game 500. Conversely in a Class III game the presence of action feature symbol 418 (or a predetermined triggering number of action feature symbols) in base reel game 400 can indicate to a user that bonus wheel game 500 may be triggered.

In operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games).

In the example implementation, the reel outcome of the base reel game 400 corresponds to, presents, represents, and/or is determined from a Class II (e.g., bingo) game outcome. In some implementations, a player and/or a gaming device (e.g., gaming devices 104A-104X and 200) may be provided with a bingo card, such as by a bingo gaming system server (e.g., the server 106). For example, a player may be provided a new bingo card each time a “Spin” or “Play” button is pressed by the player (e.g., via user interface), provided the player has made a wager. In some examples, more than one bingo card may be generated in response to wager. A bingo number listing (also referred to as a “ball call”) may be randomly generated, such as by bingo gaming system server 106. The bingo card may be compared to the current bingo number listing, and numbered cells on the bingo card that match numbers in the bingo number listing may be marked or “daubed” on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, and the process repeats. In some examples, a single play of the bingo game includes a wager, a bingo card, a bingo number listing, a matching of the numbers called with those on a bingo card, a determination of a bingo game outcome, and a presentation of an associated award, if any. As described herein, the presentation of the associated award is implemented using the base reel game 400 and, if conditions are satisfied by the award, a bonus wheel game 500 is triggered and played, as described in more detail below.

To determine a bingo game outcome, the bingo card may be daubed by the game controller 202 (e.g., via the processor 204) based upon a list of numbers included in the ball call. Once the bingo card is daubed, the game controller 202 may compare the numbers daubed on the bingo card to every winning pattern in a database of winning patterns to determine one or more winning outcomes of the bingo game outcome. As those of skill will appreciate, the number of winning patterns may be determined based upon the ball call. The daubed bingo card may also be displayed (e.g., on the primary display 412 or a secondary display), such as, for example, by highlighting each daubed number, and the ball call may be displayed as well. Moreover, a table or database of winning patterns may be stored in a computer memory of any of EGMs 104A-104X or 200, such as memory 208, which may be a tangible, non-transitory, computer-readable memory. If the daubed bingo card does not include a pattern that matches a pattern in the database of winning patterns, then a losing bingo outcome is determined, and no award may be provided or presented to the player. If the bingo card does include a pattern that matches a pattern in the database of winning patterns, then a winning bingo outcome is determined, and an award may be presented to the player, as described herein.

The bingo game outcome may, in some instances, include a plurality of winning patterns. Different winning patterns may be associated with different awards. The award for a winning bingo game outcome may be based on an amount wagered, an associated bingo game paytable, an associated set of rules for the bingo game, a probability (and/or likelihood) of achieving a particular bingo pattern/combination, an amount of bingo numbers needed to achieve the particular bingo pattern/combination, and/or other considerations. In some examples, the player may be awarded for multiple patterns (e.g., all winning patterns) that are matched when the daubed bingo card is evaluated against the database of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game are also possible and are within the scope of this disclosure.

The bingo game outcome may be presented to the player via a spinning reel game simulation. That is, for each play of the bingo game, the bingo game outcome is presented as a reel outcome (e.g., base reel game outcome) or a sequence of reel outcomes in a reel game (e.g., base reel game 400, bonus wheel game 500). In the example shown in FIG. 4, a bingo game outcome (not shown) is presented by the base reel game 400 simulation as a spin and stop sequence or multiple spin and stop sequences of the plurality of reels 402-410. The spin and stop sequence(s) and associated outcome(s) of a reel game (e.g., the base reel game 400) that present the bingo game (or another Class II game) outcome may also be referred to as a “façade” or a “script.” A table or database may be stored in a computer memory of any of EGMs 104A-104X or 200 and/or the server computers 102, such as memory 208, that associates bingo game outcomes with façades for presenting the bingo game outcomes. The game controller 202 (e.g., via the processor 204) may thereby query the table or database to identify façades, which each contain one or more spin and stop sequence(s) and associated outcome(s) of the reel game, to present a bingo game outcome. The processor 204 may randomly select from multiple façades identified for a given bingo game outcome. For example, for a given bingo game outcome, a number of façades, e.g., five, ten, fifteen, or any other number of different ways (façades), may exist and be stored in the table or database to present the bingo game outcome. A façade may be randomly selected from multiple identified façades for a given bingo game outcome, for example, based upon a random number provided by the RNG 212. When a façade is selected by the processor 204 to present a bingo game outcome, the processor 204 may control the reel game to present the one or more spin and stop sequence(s) and associated outcome(s) contained in the façade.

In the example implementation, for a given bingo game outcome, the processor 204 selects a façade for presenting the bingo game outcome. Based on the selected façade, the processor 204 controls the base reel game 400 to cause display of one or more spin and stop sequences of the plurality of reels 402-410 and the associated outcome(s) of the base reel game 400. One or more combinations of game symbols 414 and/or one or more special symbol types (e.g., action feature symbols 418) in the base reel game outcome of the base reel game 400 may be associated with an award value that is equal to an award value of the bingo game outcome. Similarly, a losing bingo game outcome may be displayed as a losing base reel game outcome of the base game 400 (e.g., no winning game symbol 414 combinations or winning special symbols 418 are displayed).

To illustrate, the base reel game 400 may be initiated in response to a bingo game outcome that includes a winning pattern having an award value of 100 credits. The processor 204 queries the table or database to identify façades for presenting the winning pattern and/or the award value as one or more spin and stop sequences of the plurality of reels 402-410 and the associated base reel game outcome(s) of the base reel game 400. The processor 204 then selects one of the identified façades for the bingo game outcome and initiates a play of the base reel game 400. During the base reel game 400, based on the selected façade, the processor 204 causes the first plurality of reels 402-410 to spin and stop to display a combination of game symbols 414 that include a winning symbol combination corresponding to a 100 credit award value (shown in FIG. 4) that matches the award value of the winning bingo game outcome. The award value is then displayed in a win meter 422 and subsequently added to a credit meter 424. The win meter 422 displays an immediately awarded value for an outcome the base reel game 400, and the credit meter 424 displays a credit balance (calculated as a sum total of credits input and awards accrued minus wagers placed) accrued until a player cashes out. Each of the win meter 422 and the credit meter 424 are shown displayed on display 412, however, each may appear in other locations on an EGM 104A-104X or 200 and/or on other displays, such as, for example, a secondary display 128B, a display of button deck 120, and the like.

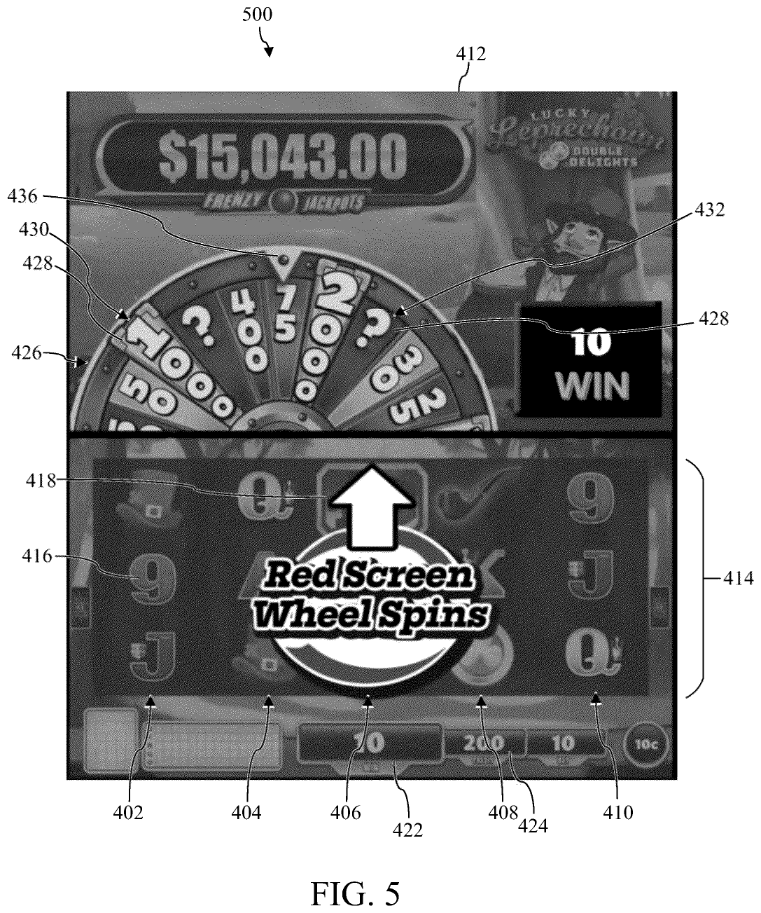

FIG. 5 is an exemplary user interface or screenshot of an example bonus wheel game 500 initiated after play of the base reel game 400 is displayed. The bonus wheel game 500 is triggered by the primary game outcome (e.g., base reel game outcome) satisfying a bonus wheel game condition, described in further detail below. In the example implementation, the bonus wheel game 500 may include a number of free spins or rotations of a wheel feature 426 included in bonus wheel game 500, as discussed herein. Thus, the bonus wheel game 500 may also be referred to herein as a bonus wheel game 500 or a free spin bonus wheel game 500. In various implementations, the bonus wheel game 500 may be played as a primary or base game and/or as a bonus game that is initiated after play of a primary game (e.g., the base reel game 400). In other words, the functionality described herein with respect to free spin bonus wheel game 500 may be implemented in any base reel game as well as in any bonus game. Moreover, the bonus wheel game 500 is not limited to a wheel game and may be implemented as another suitable wagering game. However, in the illustrated implementation, the bonus wheel game 500 is a bonus wheel-based game that includes one or more free spins or rotations of wheel feature 426 and is initiated after play of the base reel game 400.

The bonus wheel game 500 is triggered in response to a game controller (e.g., the game controller 202) determining that a bonus wheel game condition is satisfied by the primary or base reel game outcome. The primary game outcome may include a number of (e.g., multiple) awards or winning game outcomes (e.g., winning combinations, patterns, etc.). For example, the game controller 202 may determine that a bingo game outcome includes a number of (e.g., multiple) winning bingo patterns. The bonus wheel game condition may be satisfied by a predefined or preselected number of awards or winning game outcomes of the primary or base reel game outcome. For example, in Class II bingo game implementations, the bonus wheel game condition may be a predefined or preselected number of winning bingo patterns included in the bingo game outcome (e.g., base reel game outcome). The game controller 202 may identify and translate the number of winning patterns occurring on the bingo card to a number of free spins in the free spin bonus wheel game 500. For example, if a number “n” winning patterns are identified on the bingo card, the game controller 202 may award a number “n” free spins during the free spin bonus wheel game 500. Likewise, the game controller 202 may not trigger free spin bonus wheel game 500 until the number of winning patterns exceeds a predefined or preselected number of winning patterns (e.g., two or more winning patterns). To this end, the game controller 202 may, in some implementations, count, or determine a number of, winning patterns and/or free spins awarded.

In various implementations, a bonus wheel game condition may include any suitable trigger condition, such as, for example, generation by RNG 212 of an RNG outcome (e.g., a random number within a range of random numbers) and performing a lookup operation to map the random number to a decision as to whether the bonus wheel game condition is satisfied. The RNG outcome for mapping to the decision as to whether the bonus wheel game condition is satisfied may be generated after each play of a base game (e.g., the base reel game 400), or may itself be randomly generated based on an additionally generated RNG outcome. Additionally, and/or alternatively, in a Class III implementation, the bonus wheel game condition may be satisfied when a preselected or predefined symbol combination and/or a preselected or predefined symbol type (e.g., action feature symbol 418) is displayed on the plurality of reels 402-410 in an outcome the base reel game 400. For example, a game symbol 414 combination and/or symbol type associated with a game award, such as action feature symbol 418, that is greater than or equal to a predetermined award value may satisfy the bonus wheel game condition. In some implementations, a preselected or predefined game symbol 414 combination and/or symbol type being displayed in an outcome of a base reel game may generate an RNG outcome that is mapped to a decision as to whether the bonus wheel game condition is satisfied.

In some implementations, and as described in additional detail herein, the bonus wheel game condition may be satisfied when a number of winning patterns in a primary Class II game (e.g., a bingo game) exceeds a predefined or preselected number of winning patterns. In other implementations, the bonus wheel game condition may be satisfied when an award associated with a bingo winning pattern is greater than or equal to a predetermined award value and/or when the predetermined award value is capable of being partitioned into or distributed across a predefined or preselected number of free spins. It will, however, be appreciated that these bonus wheel game conditions are described by way of example only and that other bonus wheel game conditions may be implemented as well.

When the free spin bonus wheel game 500 is triggered, the game controller 202 may award at least one or more free spins of the wheel feature 426 associated with bonus wheel game 500 displayed on display 412. The number of free spins awarded may be based upon any suitable criterion or group of criteria, such as, for example, the value of the random number generated by RNG 212, the game symbol 414, 416 combinations occurring on reels 402-410 in a base reel game outcome of the base reel game 400, and the like.

In another Class II implementation, the number of free spins awarded may correspond to a number of segments or partitions of a subdivided bingo game award. For example, when the bonus wheel game condition is satisfied by a bingo game award of sufficient value (as described above), the bingo game award may be subdivided into a plurality of smaller awards, each of which may be associated with a free spin. As an example, a bingo game award of 1,000 credits may be subdivided into eight smaller awards, e.g., of 125 credits each. In other examples, the eight awards may be of different, i.e., unequal, amounts. Each of the eight smaller awards may be associated with an individual free spin, and each of these individual free spins may provide or award one of the eight smaller awards.

In at least one Class III implementation, the number of free spins awarded may correspond to a number of partitions of a subdivided game award in the Class III base game. For example, when the bonus wheel game condition is satisfied by a primary or base reel game award of sufficient value (as described above), the game award may be subdivided into a plurality of smaller awards, each of which may be associated with a free spin and provided in conjunction with one of the smaller sub-awards.

In another Class II or Class III implementation, each free spin may correspond to a particular game outcome, such as any winning and/or non-winning game outcome. For example, winning and/or non-winning game outcomes may, in some implementations, result in free spins. However, and in at least some implementations, only winning game outcomes may result in free spins. Moreover, as described above, in some implementations, the game controller 202 may simply (randomly) award a number of free spins.

Thus, the free spin bonus wheel game 500 may be implemented in Class II and Class III implementations, and a bonus wheel game condition and/or a number of free spins awarded during the free spin bonus wheel game 500 may be variously determined. In addition, the methods for determining the bonus wheel game condition and/or a number of free spins described above are merely illustrative, and it will be appreciated that other approaches are contemplated and within the scope of the present disclosure.

The free spin bonus wheel game 500 may be provided with a displayed indication that the bonus wheel game 500 is distinct from the base reel game 400. For example, and in addition to being displayed in a distinct portion of display 412 than base reel game 400, the free spin bonus wheel game 500 may be provided in conjunction with a change to an overlaid translucent or transparent colored graphic effect (shown in FIG. 5) around the plurality of reels 402-410 and display 412. For instance, in one implementation, display 412 may change to include a red color overlay or a “red screen.” The red screen may be displayed for the duration of the bonus wheel game 500 to let a player know that each free spin of wheel feature 426 will be accompanied by an award (e.g., corresponding to an award of each of the multiple winning patterns of the bingo game outcome). In other implementations, words, symbols, letters, metamorphics, and/or other visual effects may be displayed on or adjacent the plurality of reels 402-410, display 412, wheel feature 426, and/or auxiliary displays, in addition to and/or alternative to the displayed red screen.

An outcome of each free spin of the bonus wheel game 500 may, in some implementations, correspond to an award value associated with the primary or base reel game outcome. For example, the outcome of each free spin of the bonus wheel game 500 may correspond to a winning bingo pattern. The game controller 202 may, as a result, determine or identify (e.g., by querying a table or database stored in a memory as described below) an award value associated with an outcome of each free spin based upon the corresponding winning game outcome or award of the primary game outcome. For example, if a winning bingo pattern associated with a first free spin or bonus wheel game outcome corresponds to an award of 100 credits (e.g., determined based upon a bingo paytable), the game controller 202 may spin wheel feature 426 during the first free spin, and control display of wheel feature 426 to provide an award in association with a first free spin or first bonus wheel game outcome of 100 credits. Thus, each free spin of the wheel feature 426 may include displaying a winning free spin or bonus wheel game outcome, and an award value of each bonus wheel game outcome may correspond to an award value associated with the winning bingo pattern (or more broadly, a winning game outcome) mapped or corresponding to the free spin. As discussed herein, the award value corresponds and/or is associated with a credit value displayed on each of the plurality of wedges 428 included in wheel feature 426 of bonus wheel game 500.

In some embodiments, the credit values displayed on the wheel feature 426 are randomly selected using an RNG and a table stored in memory. In other embodiments, the credit values or symbols are selected based upon the winning outcomes associated with the player. In other words, when a player received a winning outcome, the overall credit value associated with the winning outcome is part of a look up within a façade table that helps to determine how the overall credit value will be awarded to the player (e.g., how many spins and what value is awarded on each spin) and, as part of that lookup, the values and symbols to be displayed on the wheel feature 426 are provided.

In the example implementation, the bonus wheel game 500 is simulated in conjunction with the base reel game 400 as a façade for presenting a bingo game outcome that satisfies the bonus wheel game condition. As described above with reference to the base reel game 400, a table or database may be stored in a computer memory of any of EGMs 104A-104X or 200 and/or the server computers 102, such as memory 208, that associates bingo game outcomes with façades for presenting the bingo game outcomes, and the game controller 202 (e.g., via the processor 204) may query the table or database to identify façades to present a bingo game outcome. For certain bingo game outcomes, for example, those that include a predefined or preselected number of winning patterns and/or one or more winning patterns associated with a certain award value, one or more façades may exist that present the bingo game outcome as outcomes of the base reel game 400 and outcome(s) of one or more free spins of the bonus wheel game 500. These bingo game outcomes satisfy the bonus wheel game condition as they are able to be presented by one or more façades that contain outcome(s) of the base reel game 400 and outcome(s) of one or more free spins of the bonus wheel game 500. The processor 204 may select a façade for presenting the bingo game outcome that satisfies the bonus wheel game condition and based on the selected façade, the processor 204 causes display of one or more spin and stop sequences of the plurality of reels 402-410 and the associated outcome(s) of the base reel game 400 and one or more free spins of the wheel feature 426 and the associated outcome(s) of the bonus wheel game 500. One or more combinations of game symbols 414 and/or one or more special symbol types in the outcomes of the base reel game 400, and the credit values associated with wedges 428 of wheel feature 426 for the bonus wheel game 500 may be associated with an award value that is equal to an award value of the bingo game outcome.

To illustrate, the bingo game outcome may include multiple winning patterns associated with a 10 credit, a 100 credit, and a 1000 credit pattern win. The processor 204 queries the table or database to identify façades for presenting the winning patterns and/or the award value(s) as one or more spin and stop sequences and the associated outcome(s) of the base reel game 400 and one or more free spins and the associated outcome(s) of the bonus wheel game 500. For example, one or more façades may exist that contain a spin and stop sequence and associated outcome of the base reel game 400 for presenting the 10 credit pattern win and one or more free spins of wheel feature 426 and the associated outcome(s) of the bonus wheel game 500 for presenting the 100 credit pattern win and the 1000 credit pattern win, and the processor 204 identifies these façades by querying the table or database. The processor 204 then selects (e.g., randomly selects based upon a random number provided by the RNG 212) one of the identified façades for the bingo game outcome and, in response and based on the selected façade, the processor 204 causes display of the spin and stop sequence and associated outcome of the base reel game 400 for presenting the 10 credit pattern win and one or more free spins of wheel feature 426 and the associated outcome(s) of the bonus wheel game 500 for presenting the 100 credit pattern win and the 1000 credit pattern win.

A total award value accrued during the base reel game 400 and the free spins of the bonus wheel game 500 may be displayed, such as, for example, in the win meter 422. The award value displayed in the win meter 422 during the free spin bonus wheel game 500 may increase incrementally (e.g., as determined by the selected façade) after each free spin or bonus wheel game outcome to build player excitement, such as, for example, where the player knows that a number of free spins have been awarded based upon the appearance of the free spin bonus wheel game 500, but where the player does not know specifically how many free spins of wheel feature 426 have been awarded. In some implementations, the processor 204 may control (e.g., as determined by the selected façade) the free spin sequence during the free spin bonus wheel game 500 such that an equal or greater award value is presented after each successive free spin to facilitate further increasing player excitement. Once the number of free spins awarded during the bonus wheel game 500 has been reached, the total award value may be added to the credit meter 424 and the free spin bonus wheel game 500 is completed. Upon completion of the bonus wheel game 500, the displayed indication (e.g., the red screen) may be removed to visually inform the player that the bonus wheel game 500 has been completed.

Additional detail related to the displayed indication (e.g., the red screen) during bonus wheel game 500 may be obtained with reference to U.S. patent application Ser. No. 18/303,002, filed Apr. 19, 2023, and entitled ELECTRONIC GAMING SYSTEMS AND METHODS FOR PRESENTING A BONUS GAME WITH ENHANCEMENT FEATURES, the disclosure of which is hereby incorporated by reference herein in its entirety.

The features of the free spin bonus wheel game 500 (e.g., the displayed red screen and/or the progressive display of increasing award values during successive spins of the wheel feature 426 associated with the bonus wheel game 500) may only facilitate increasing player excitement to a limited extent. Still referring to FIG. 5, during the bonus wheel game 500, each free spin includes a spin and stop sequence of the wheel feature 426. Even though the player may anticipate a winning outcome for each free spin, the player may not perceive that the bonus wheel game 500 provides any additional opportunity for a winning outcome beyond the opportunities provided during the base reel game 400.

Accordingly, with additional reference to FIGS. 5-14 generally, the free spin bonus wheel game 500 may include action features that increase the flexibility in presenting winning outcomes during the number of free spins that correspond to winning outcomes or awards of the base reel game outcome or primary outcome (e.g., a bingo game outcome). The action features of bonus wheel game 500 facilitate increasing player excitement during the bonus wheel game 500 as each action feature is perceived as providing an additional opportunity for a winning free spin or bonus wheel game outcome (e.g., free spin wedges, etc.), and/or an increased monetary value awarded for a winning free spin or bonus wheel game outcome (e.g., multiplier wedges, boost wedges, etc.).

In the non-limiting example shown in FIG. 5, and as discussed herein, bonus wheel game 500, and all associated features, is displayed in display 412. Bonus wheel game 500 may be continuously displayed on display 412 and/or may be displayed during base reel game 400. However, bonus wheel game 500 may remain “inactive” during the playing of base reel game 400 and/or during the displaying of base reel game outcomes that may not trigger bonus wheel game 500.

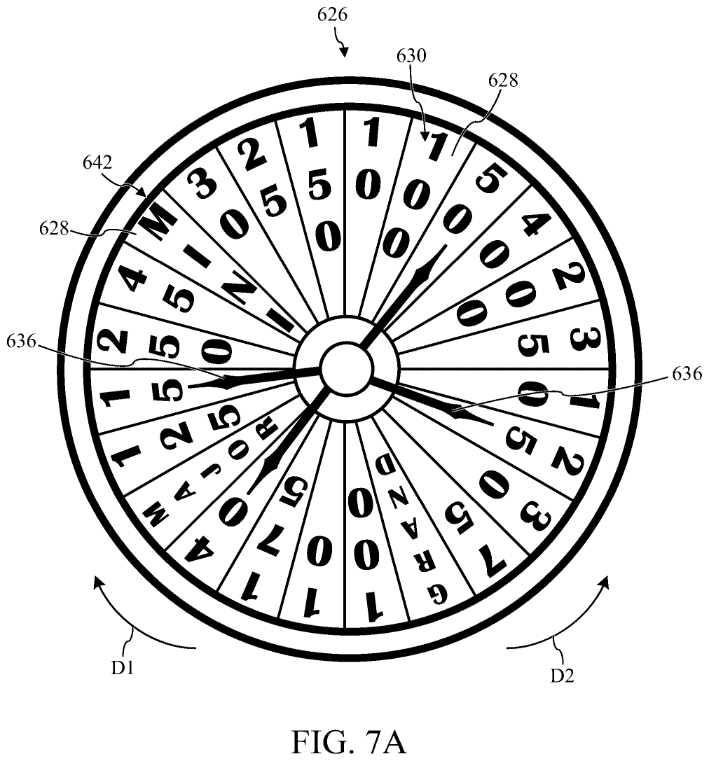

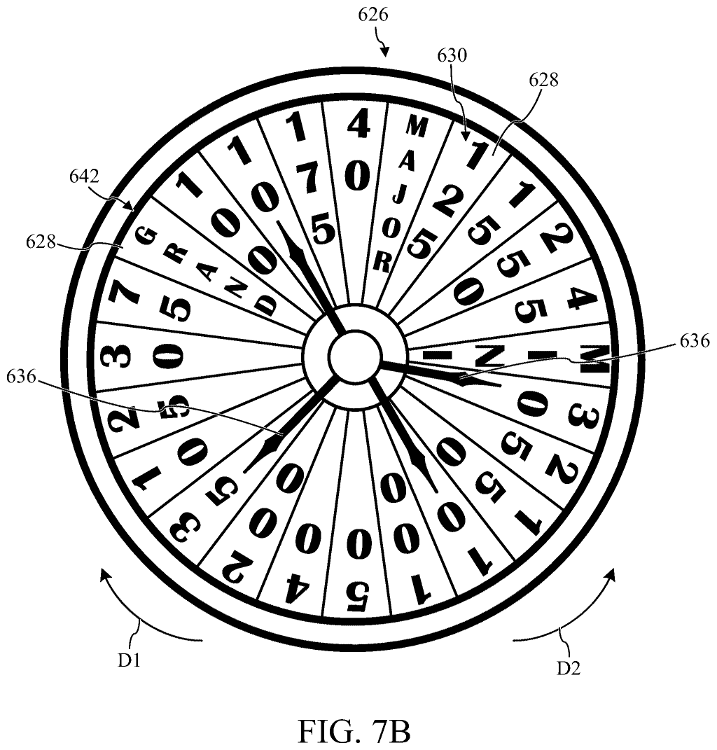

Bonus wheel game 500 displayed on display 412 includes a wheel feature 426. In the non-limiting example, only a portion (e.g., half) of wheel feature 426 is depicted. In other non-limiting examples (e.g., FIGS. 7A-14), the entirety of wheel feature 426 may be displayed in bonus wheel game 500. Wheel feature 426 includes a plurality of wedges 428. More specifically, wheel feature 426 may be formed and/or divided into a plurality of wedges 428 disposed circumferentially about a center reference point. In the non-limiting example shown, each wedge may be sized equally. However, in other non-limiting examples (not shown), the plurality of wedges 428 may include distinct sizes with respect to one another.

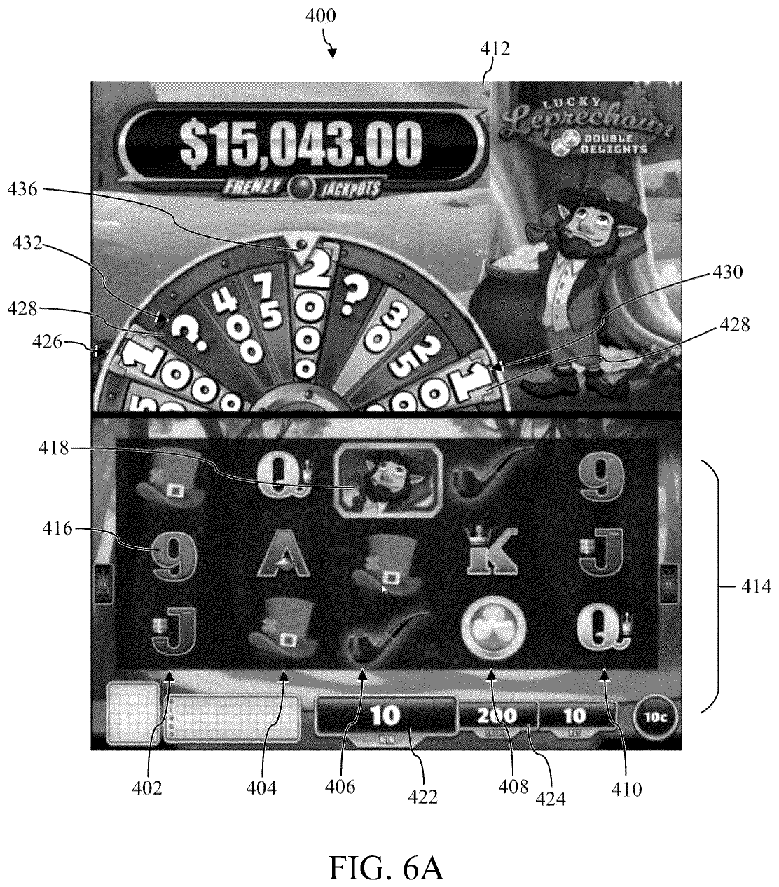

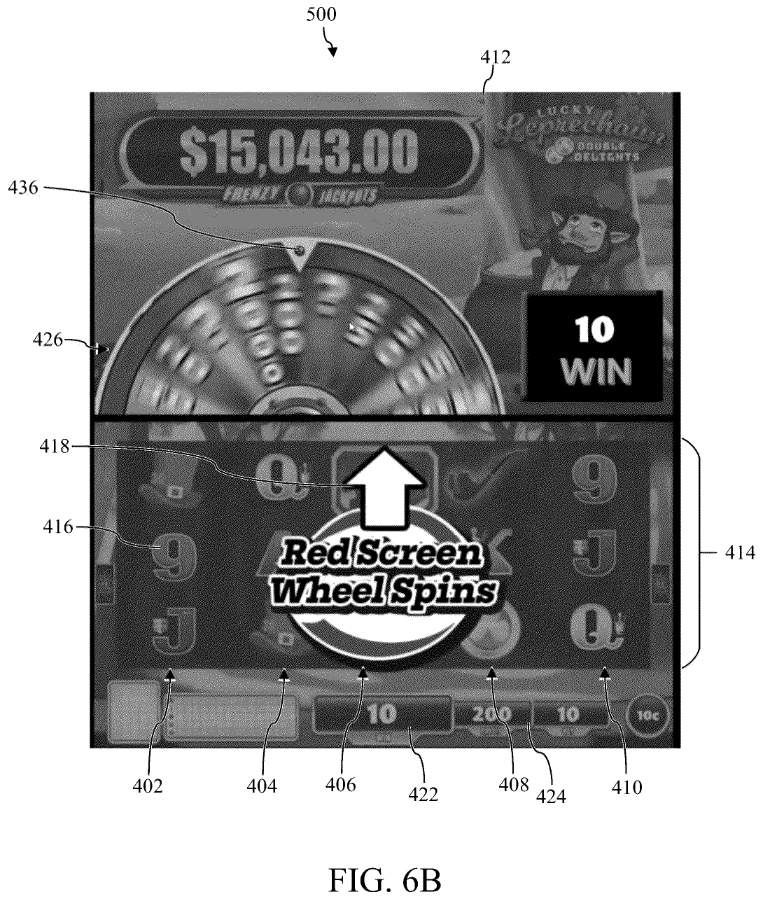

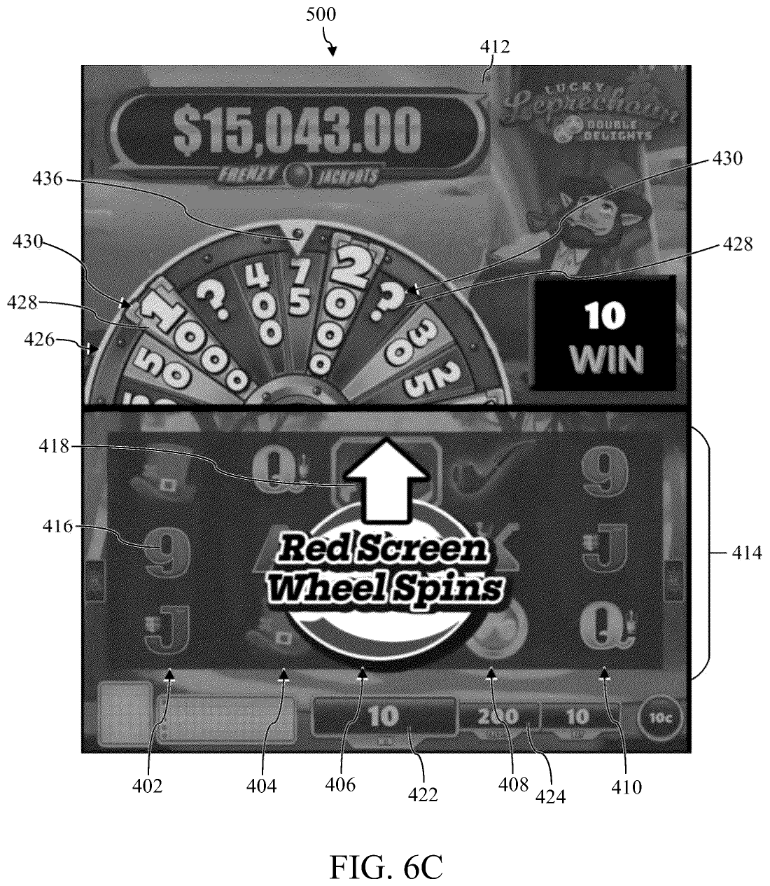

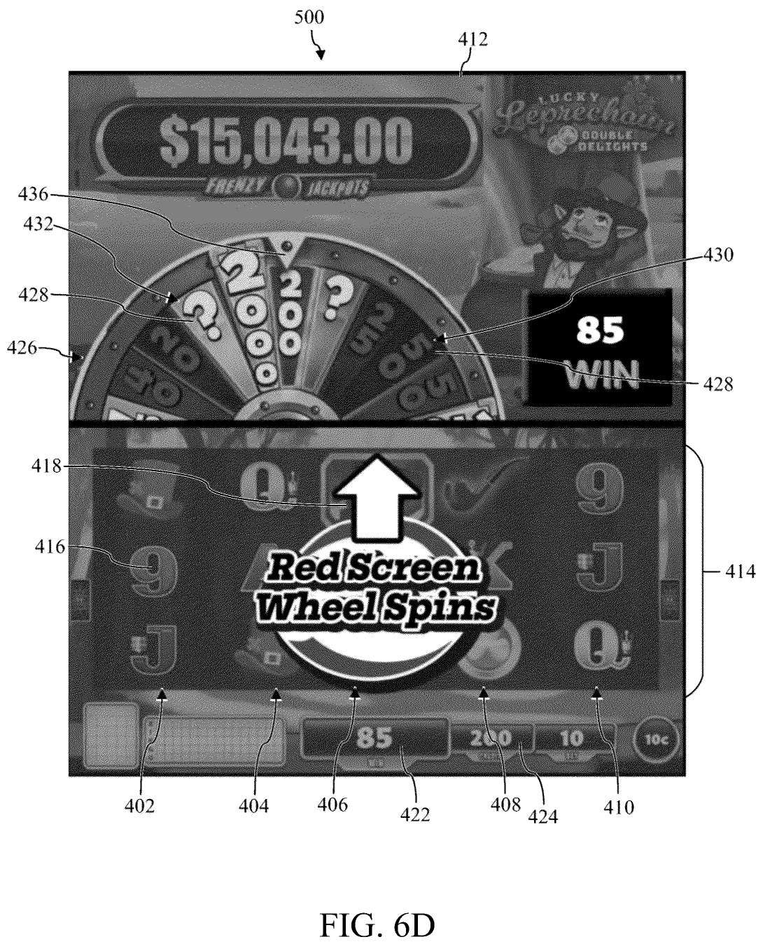

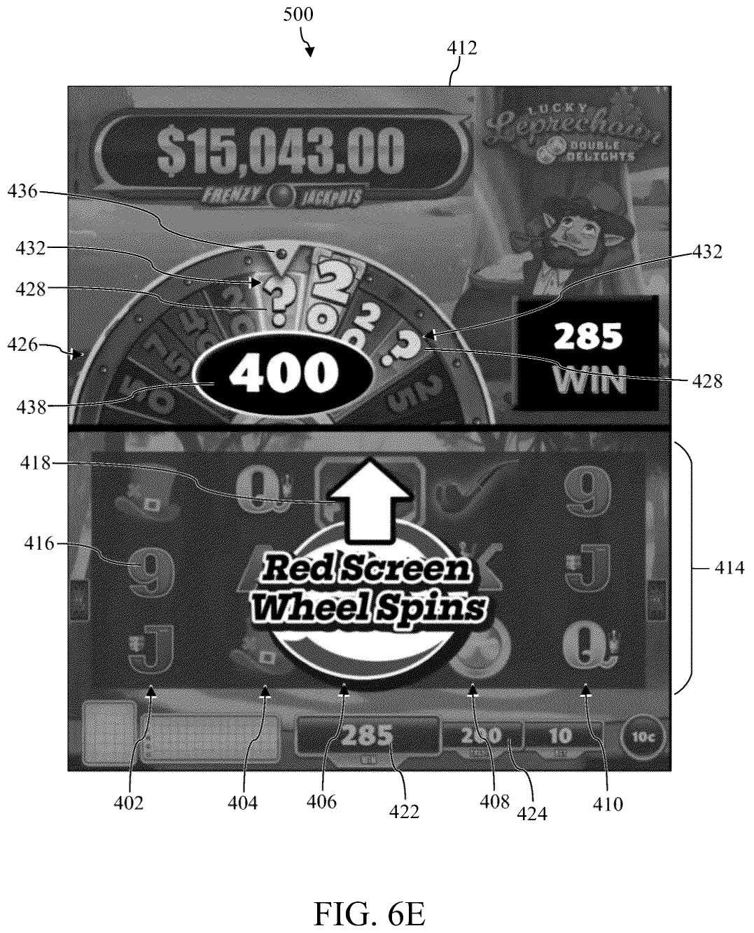

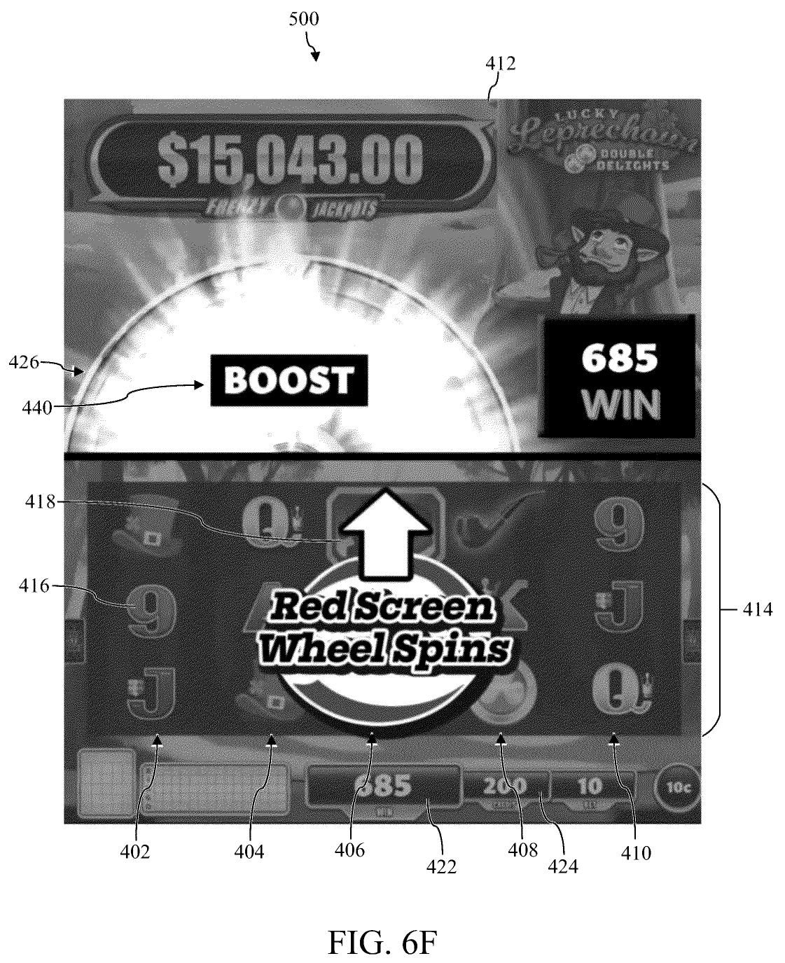

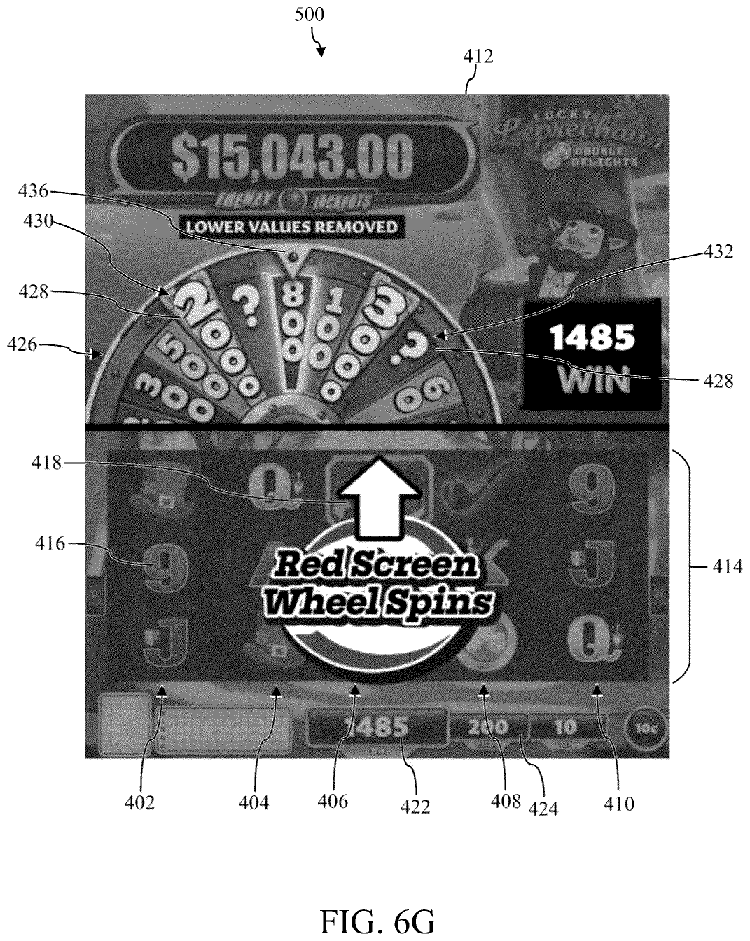

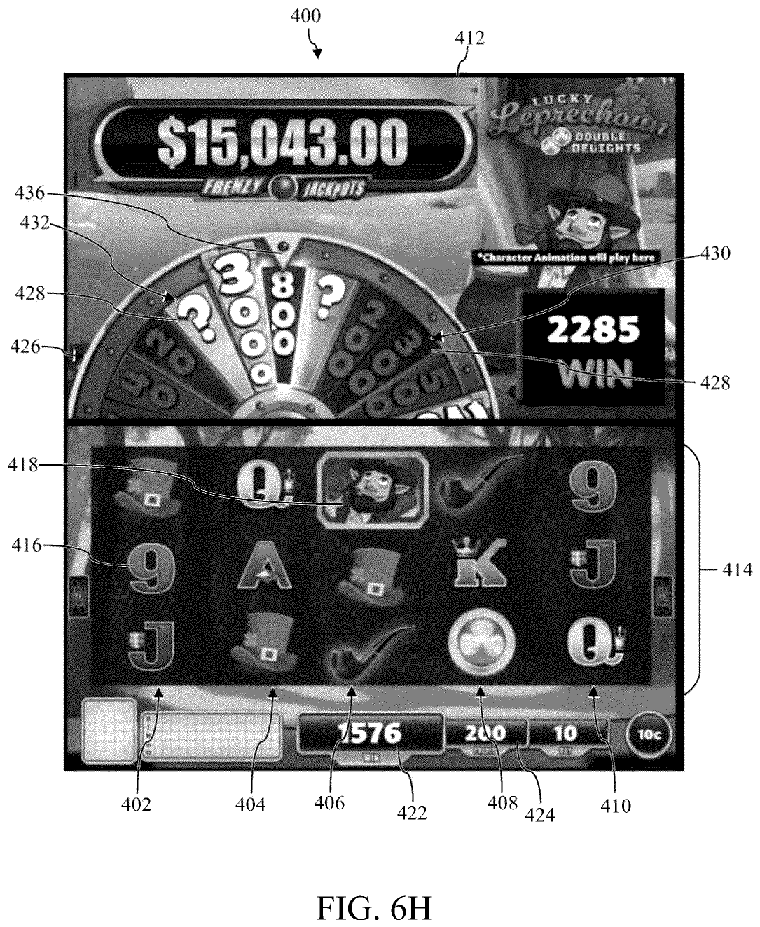

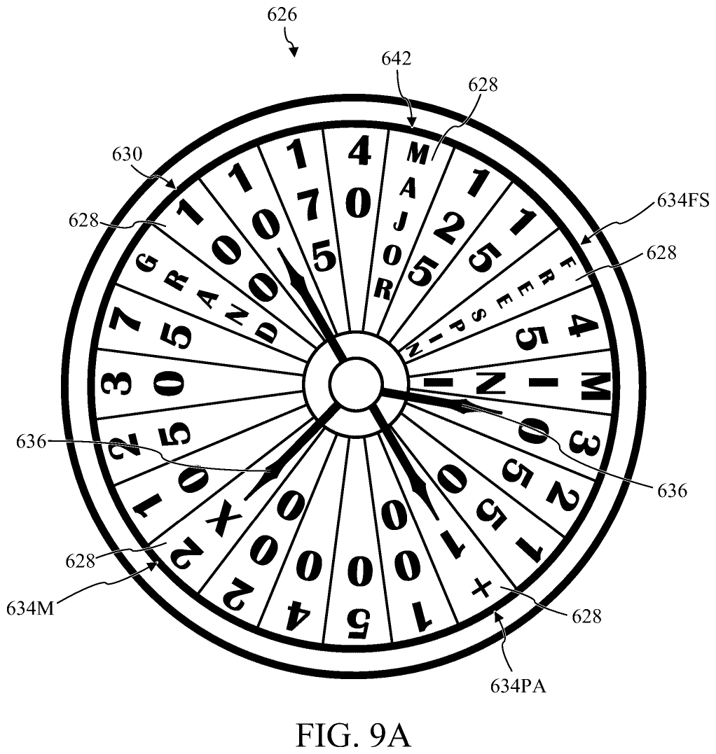

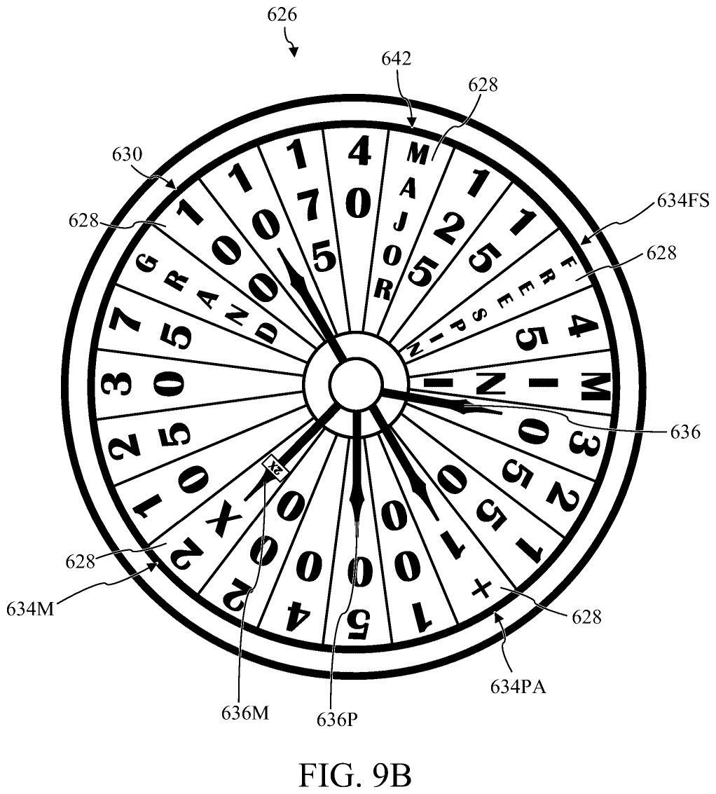

Each wedge of the plurality of wedges 428 may depict a credit value 430, a mystery credit value 432, or an action feature (see, FIG. 9A; 634). The credit value 430 depicted, displayed, and/or associated with each wedge of the plurality of wedges 428 represents a predetermined credit value that can provide additional award credits to the player during the bonus wheel game 500, as discussed herein. The mystery credit value 432 depicted, displayed, and/or associated with wedge(s) 428 can include a subsequently determined credit value that can provide additional award credits to the player during the bonus wheel game 500. That is, where credit values 430 associated with wedges 428 do not include an awarded credit value owed to the player based on the base reel game outcome or bingo game outcome, mystery credit value 432 may depict the required award credit value to the player (see, FIG. 6E). As similarly discussed herein, game controller 202 and/or processor 204 may utilize mystery credit value 432 to display award credit value(s) that may not otherwise be included in credit values 430 and/or depicted on wheel feature 426 during bonus wheel game 500.

Bonus wheel game 500 also includes at least one pointer 436. Pointer 436 is positioned adjacent to wheel feature 426. More specifically, an outer rim pointer 436, as shown in FIG. 5, is positioned adjacent to an outer rim or perimeter of wheel feature 426, radially opposite a center of wheel feature 426. Pointer 436 is also configured to cover at least a portion of one of the plurality of wedges 428 of wheel feature 426. During the free spin and/or free game play of bonus wheel game 500, pointer 436 may visually identify the wedge 428 of wheel feature 426 that has been selected and/or awarded to the player. That is, once wheel feature 426 stops spinning during bonus wheel game 500, pointer 436 identifies and/or indicates the wedge 428, and associated credit value 430, 432, that may be awarded to the player during that particular free spin. As discussed herein, the credit value 430 identified by pointer 436 is referred to as the bonus wheel game outcome. As shown in FIG. 5, pointer 436 is formed and/or depicted as a triangle. However, it should be understood that pointer 436 can be formed as any shape, symbol, figure, and/or graphic that can readily identify wedges 428 of wheel feature 426 during bonus wheel game 500. Additionally, although one pointer 436 is shown in the exemplary embodiment of FIG. 5, it should be understood that bonus wheel game 500 can include a plurality of pointers 436 (see e.g., FIG. 7A).

FIGS. 6A-6H are exemplary user interfaces or screen shots of a sequence between the base reel game 400 (FIG. 4) and the bonus wheel games 500 (FIG. 5). As shown in FIG. 6A, and as previously discussed herein, the displayed base reel game outcome of the base reel game 400 may present, represent, and/or depict a winning primary game outcome. For example, the reel outcome (base reel game outcome) may correspond to at least one winning bingo pattern for a primary or underlying Class II game. Alternatively, the base game reel outcome, determined randomly, may represent a winning pattern of the plurality of game symbols 414 included in base reel game 400 (e.g., in Class III games). As shown in the non-limiting example, win meter 422 includes a 10-credit win for base reel game 400 and/or base reel game outcome, dependent upon results of the bingo pattern or the plurality of game symbols 414 displayed in reels 402-410. However, and as similarly discussed herein, the credit value depicted in win meter 422 may not represent the total credit value award for base reel game outcome of base reel game 400. Rather, the remainder of the credit value awarded to the player based on the base reel game outcome may be awarded and/or presented in bonus wheel game 500. As such, it may be determined that base reel game 400 and/or base reel game outcome, as depicted in FIG. 6A may trigger, activate, and/or engage bonus wheel game 500 in display 412.

FIG. 6B is an exemplary user interface or screen shot showing the bonus wheel 426 spinning after the bonus wheel game 500 has been triggered. In the exemplary embodiment, display 412 shown in FIG. 6B provides the overlaid translucent color graphic effect (e.g., red screen) to indicate that the base reel game outcome for base reel game 400 has triggered the bonus wheel game 500. Additionally, as shown in the non-limiting example, wheel feature 426 of bonus wheel game 500 may begin to spin and/or rotate, while pointer 436 remains stationary.

FIG. 6C is an exemplary user interface or screen shot that shows an exemplary bonus wheel game outcome for bonus wheel game 500. More specifically, FIG. 6C shows a user interface or screen shot depicting the bonus wheel game outcome for a first spin of the at least one free spin for bonus wheel game 500. In the non-limiting example, bonus wheel game outcome may award the player 75 credits. That is, when wheel feature 426 stops spinning, pointer 436 of bonus wheel game 500 identifies wedge 428 of wheel feature 426 that includes credit value 430 equal to or depicting “75” credits. The awarded credits identified in wheel feature 426 is subsequently added to win meter 422 (see, FIG. 6D). In a non-limiting example where it is determined that bonus wheel game 500 only includes a single free spin of wheel feature 426, display 412 may remove and/or cease displaying the overlaid translucent color graphic effect (see, FIG. 6H). Conversely, where bonus wheel game 500 includes a plurality of free spins, wheel feature 426 may spin and/or rotate again after displaying bonus wheel game outcome (e.g., 75 credits) for the first free spin of bonus wheel game 500.

FIG. 6D is an exemplary user interface or screen shot that shows a distinct bonus wheel game outcome for bonus wheel game 500. For example, display 412 shows a distinct or second bonus wheel game outcome for a subsequent/second spin for bonus wheel game 500. As shown, bonus wheel game outcome may award the player “200” credits. More specifically, and distinct from the exemplary embodiment shown in FIG. 6C, pointer 436 of bonus wheel game 500 identifies wedge 428 of wheel feature 426 that includes credit value 430 equal to or depicting “200” credits; which is subsequently added to win meter 422, as discussed herein.

Additionally, as shown in FIG. 6D, wedges 428 of wheel feature 426 including credit value 430 that are less than the previously awarded credit value (e.g., 75 credits) are dimmed or shaded out. More specifically, before or simultaneous to re-spinning wheel feature 426 for the second free spin of bonus wheel game 500, any wedge 428 of wheel feature 426 that includes credit value 430 lower than credit value 430 associated with the first bonus wheel game outcome (see, FIG. 6C) is dimmed or shaded out. The dimming and/or shading of the specific wedges 428 of wheel feature 426 may indicate to the player of bonus wheel game 500 that the dimmed wedges 428 are not a winning option and/or will not be identified by pointer 436 in subsequent games. As such, and as discussed herein, with each subsequent spin of wheel feature 426 the awarded credit value is equal to or greater than the credit value awarded in the previous spin for bonus wheel game 500.

FIG. 6E is an exemplary user interface or screen shot that shows a distinct/third bonus wheel game outcome for the third spin for bonus wheel game 500. Distinct from the exemplary embodiments shown and discussed herein with respect to FIGS. 6C and 6D, pointer 436 in FIG. 6E indicates and/or identifies wedge 428 including mystery credit value 432. As discussed herein, mystery credit value 432 provides a determined credit value that may not be present on wheel feature 426 during bonus wheel game 500. For example, with each additional respin or subsequent bonus wheel game 500, more wedges 428 may be dimmed on 426. As such, wedges 428 including mystery credit value 432 are configured to provide credit values that are greater than credit values awarded in previous spins and are not present or visually represented by credit value 430 included on the plurality of wedges 428 forming wheel feature 426. As shown in the non-limiting example, bonus wheel game outcome may award the player “400” credits. A credit value pop-up or animation 438 (hereafter, “credit value pop-up 438”) may be presented to the player when the bonus wheel game outcome identifies or includes mystery credit value 432. Credit value pop-up 438 allows the player to clearly see the credit value awarded with the third bonus wheel game outcome and/or third spin of wheel feature 426 for bonus wheel game 500.

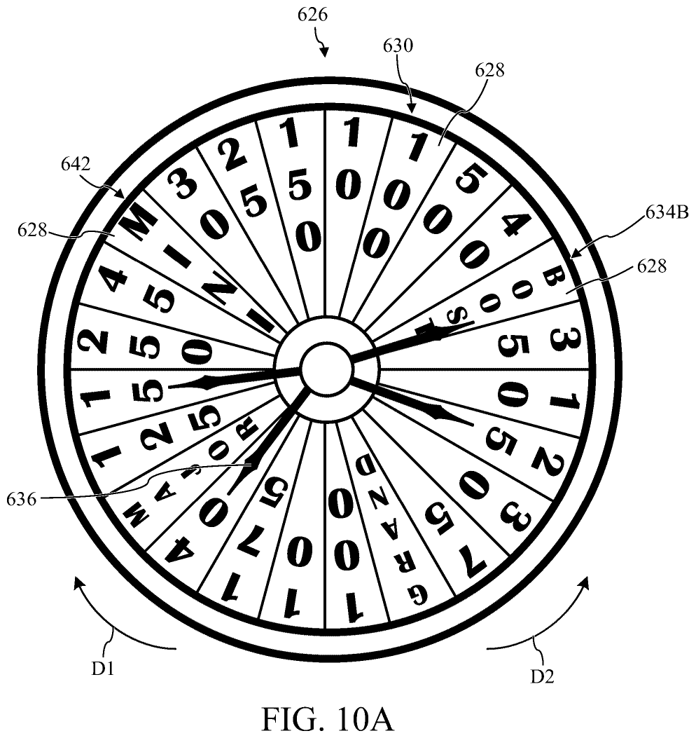

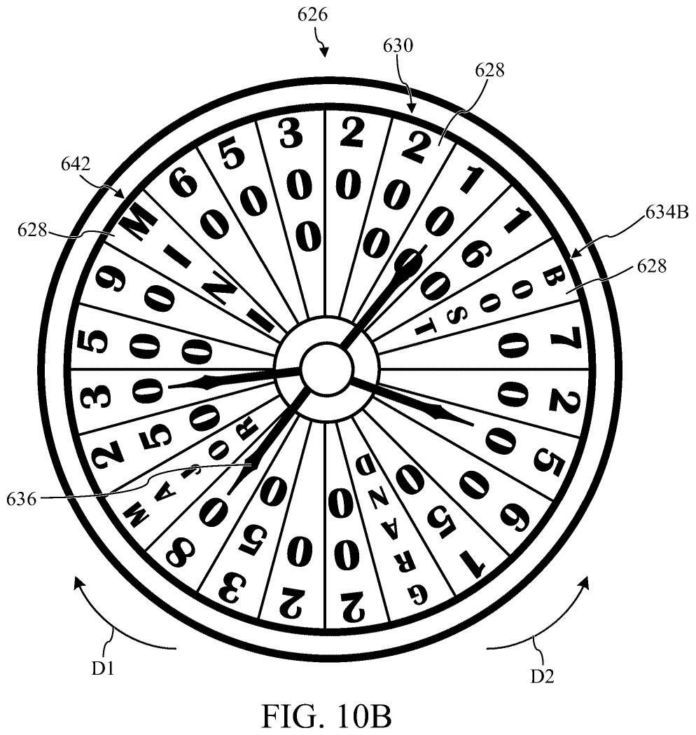

FIG. 6F is an exemplary user interface or screen shot that shows bonus wheel game 500 before a subsequent (e.g., fourth) spin of wheel feature 426. As shown, an animation and/or pop-up 440 is displayed to the player indicating that 426 is undergoing a transformation, change, and/or action feature. In the exemplary embodiment shown in FIG. 6F, the wheel feature 426 of bonus wheel game 500 may undergo a boost transformation or action feature. More specifically, credit values 430 (and mystery credit value 432) included on each of the plurality of wedges 428 forming wheel feature 426 may be increased, and the newly increased credit value 430 may be depicted in the subsequent free spin for bonus wheel game 500. In an example, the boost action feature can double each credit value 430 included on wheel feature 426. The boost action feature can be triggered for wheel feature 426 under various gameplay conditions for bonus wheel game 500. For example, after a plurality of free spins (e.g., 4 or 5 free spins) for wheel feature 426 and based on the increasing awarded credit value for each subsequent bonus wheel game outcome, nearly all wedges 428 of wheel feature 426 may become dimmed. As such, wheel feature 426 may undergo an automatic boost action feature to reset, and/or revive (e.g., undim) all wedges 428 forming wheel feature 426 with new/increased credit values 430 displayed thereon. In another non-limiting example discussed herein (see, FIGS. 10A and 10B), wheel feature 426 may be boosted and/or undergo a boost action feature as a result of pointer 436 identifying wedge 428 included in wheel feature 426 that includes a boost action feature (see, FIG. 9A; 634).

FIG. 6G is an exemplary user interface or screen shot that shows a bonus wheel game outcome for bonus wheel game 500 based on boosted wheel feature 426 (e.g., FIG. 6F). For example, display 412 shows a distinct and subsequent bonus wheel game outcome for a subsequent spin for bonus wheel game 500 after wheel feature 426 and credit value 430 included on each wedge 428 are boosted. As shown, bonus wheel game outcome may award the player “800” credits. That is, pointer 436 of bonus wheel game 500 identifies wedge 428 of wheel feature 426 that includes credit value 430 equal to or depicting “800” credits; which is subsequently added to win meter 422, as discussed herein.

FIG. 6H is an exemplary user interface or screen shot after the bonus wheel games 500 are complete. More specifically, after the last awarded or determined free spin for bonus wheel game 500 is complete, display 412 may remove and/or cease displaying the overlaid translucent color graphic effect to indicate to the player that the bonus wheel game 500 is complete. Wheel feature 426 of bonus wheel game 500 may no longer spin or rotate, and/or may operate in a distinct manner than as presented during bonus wheel game 500 (e.g., FIGS. 6B-6G). Additionally, all credit values awarded during base reel game 400 and bonus wheel game 500 are added to win meter 422, and subsequently to credit meter 424 as shown in display 412. The player may subsequently be prompted to adjust their bet value and/or spin the reels 402-410 for base reel game 400.

FIGS. 7A-14 show exemplary front views of various wheel features 626 and pointers 636 for bonus wheel game 500. That is, FIGS. 7A-14 are exemplary embodiments of wheel features 626 and pointers 636 included within bonus wheel game 500 presented, displayed, and/or played on EGM 104, and as similarly discussed herein (e.g., FIGS. 4-6H). It should be understood that the non-limiting examples of wheel feature 626 and pointer 636 discussed herein are presented and/or displayed on display 412, similar to wheel feature 426 and pointer 436 (see, FIGS. 4-6H). It should be further understood that similarly numbered and/or named components may function in a substantially similar fashion. Redundant explanations of these components have been omitted for clarity.

FIG. 7A is an exemplary embodiment of wheel feature 626 of bonus wheel game 500. As similarly discussed herein, wheel feature 626 includes a plurality of wedges 628, where at least a portion of each wedge 628 includes credit values 630. In the non-limiting example, at least one wedge 628 also includes a jackpot feature 642. More specifically, three (3) wedges 628 of wheel feature 626 include distinct jackpot features 642, where each jackpot feature 642 corresponds to and/or facilitates the awarding of a certain jackpot for bonus wheel game outcome of bonus wheel game 500 if pointer 636 indicates the award, as discussed herein. Additionally in the exemplary embodiment, and during bonus wheel game 500, wheel feature 626 can rotate or spin in a first direction (D1) or a second direction (D2). Furthermore, the direction of rotation for wheel feature 626 can change every free spin of wheel feature 626 during bonus wheel game 500. In another non-limiting example, wheel feature 626 may remain stationary. In this exemplary embodiment, and as discussed herein, at least one pointer 636 may rotate about a center of wheel feature 626.

Distinct from wheel feature 426 discussed herein, the exemplary embodiment of wheel feature 626 shown in FIG. 7A includes a plurality of pointers 636. More specifically, a plurality of inner pointers 636 extend radially outward from a center of wheel feature 626 and cover at least portion of and/or point or identify a wedge 628 of wheel feature 626 during bonus wheel game 500. In the exemplary embodiment, and during bonus wheel game 500, each of the plurality of pointers 636 can rotate or spin in a first direction (D1) or a second direction (D2)—similar to wheel feature 626. Furthermore, the direction of rotation for pointers 636 can change every free spin of wheel feature 626 during bonus wheel game 500. Additionally, a portion (e.g., two) of the plurality of pointers 636 can rotate in the first direction (D1), while the remaining portion of the plurality of pointers 636 can rotate in a second direction (D2). In a non-limiting example where wheel feature 626 remains stationary, the plurality of pointers 636 may rotate about the center of wheel feature 626 during bonus wheel game 500. In another non-limiting example, the plurality of pointers 636 may remain stationary, and wheel feature 626 in a first direction (D1) or second direction (D2) during bonus wheel game 500. In a further exemplary embodiment, wheel feature 626 and at least one of the plurality of pointers 636 can simultaneously rotate during bonus wheel game 500. In this example, wheel feature 626 may rotate in the same direction as all, some, or none of the plurality of plurality of rotating pointers 636.

FIG. 7B is an exemplary embodiment of wheel feature 626 of bonus wheel game 500 after a free spin of wheel feature 626 and the plurality of pointers 636. That is, and with comparison to FIG. 7A, wheel feature 626 shown in FIG. 7B displays a bonus wheel game outcome for bonus wheel game 500 after the spinning/rotating and subsequent stopping of wheel feature 626 and the plurality of pointers 636, respectively. In non-limiting examples, wheel feature 626 may stop first, the plurality of pointers 636 may stop first, both wheel feature 626 and the plurality of pointers 636 may stop simultaneously, or a portion of the plurality of pointers 636 may stop before wheel feature 626, while a remainder of pointers 636 stop after wheel feature 626. Bonus wheel game outcome for bonus wheel game 500 based on wheel feature 626 may award the player all credit values indicated, identified, and/or selected by the plurality of pointers 636. That is, when wheel feature 626 and/or the plurality of pointers 636 stop spinning, the awarded credit value for the bonus wheel game outcome is equal to the total of all credit values 630 associated with wedges 628 that are identified, aligned with, and/or pointed to by pointers 636. In the non-limiting example, pointers 636 point to wedges 628 that include credit values 630 including “10”, “30”, “10”, and “35” credits. As such, the awarded credit value for the bonus wheel game outcome shown in FIG. 7B is “85” credits. As similarly discussed herein, where it is determined that bonus wheel game 500 only includes a single free spin of wheel feature 626 and/or the plurality of pointers 636, display 412 may remove and/or cease displaying the overlaid translucent color graphic effect (see, FIGS. 6B and 6H), and discontinue free spins for wheel feature 626 and/or the plurality of pointers 636. Conversely, where bonus wheel game 500 includes a plurality of free spins, wheel feature 626 and/or pointers 636 may spin and/or rotate again after displaying bonus wheel game outcome (e.g., 85 credits) for the free spin of bonus wheel game 500, as shown in FIG. 7B.

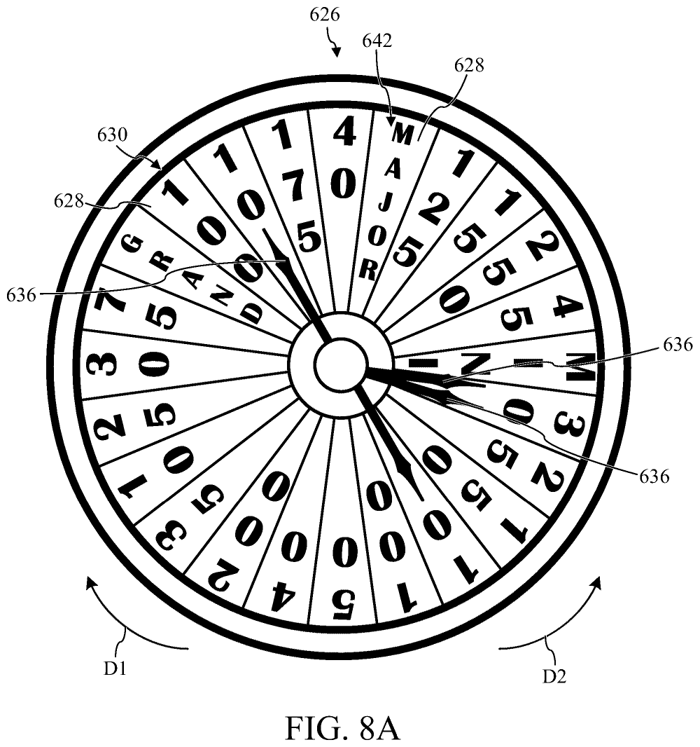

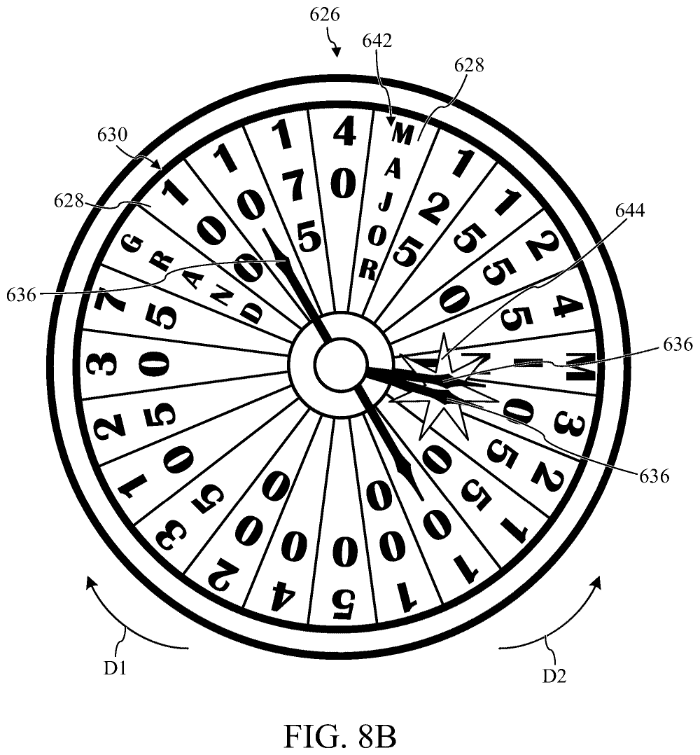

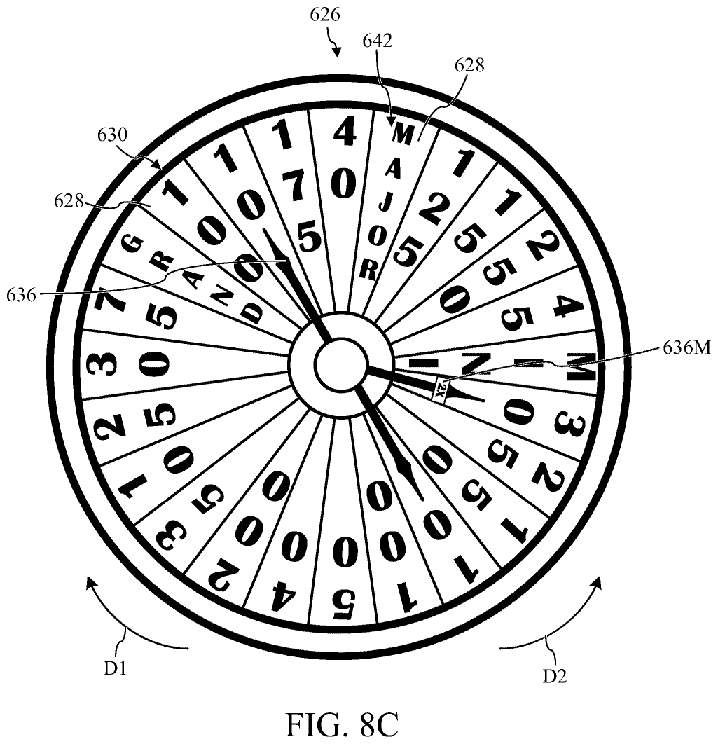

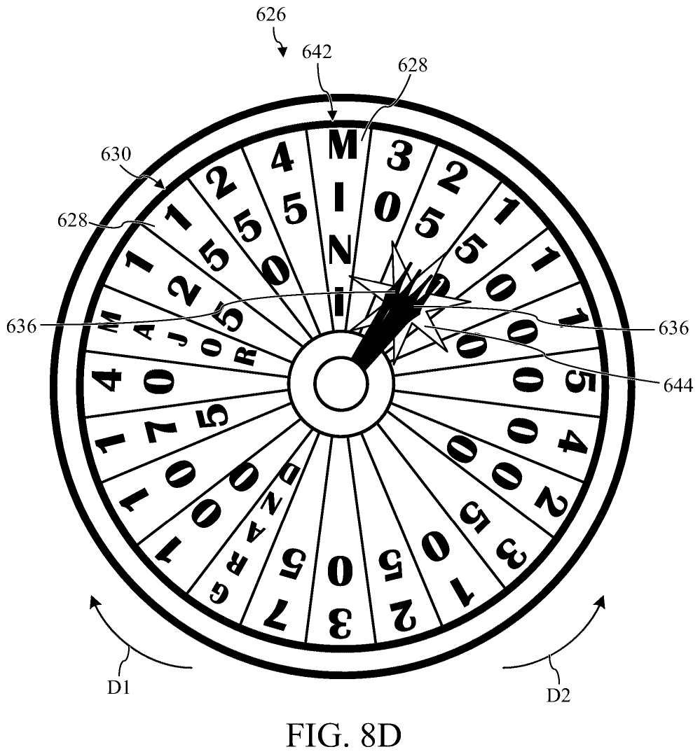

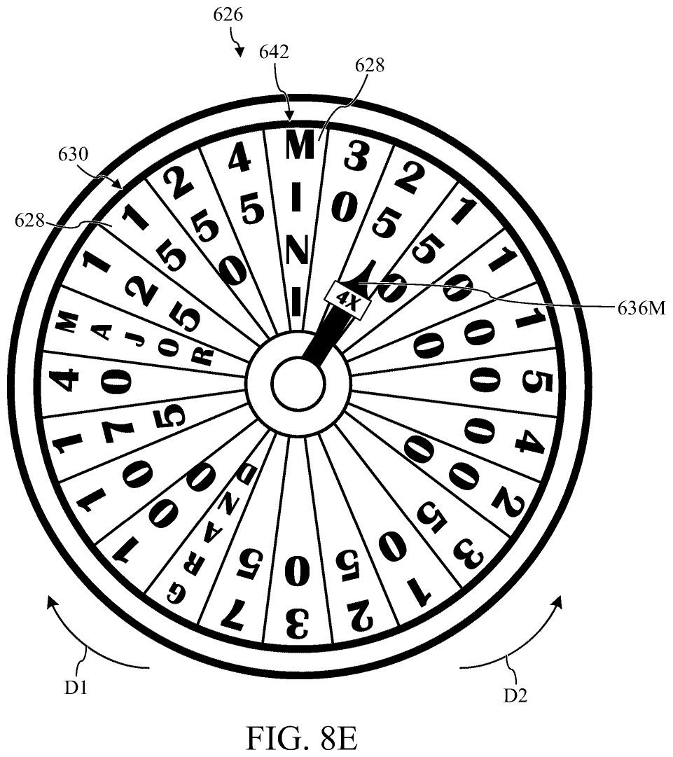

In other non-limiting examples, the position of pointers 636 on wheel feature 626 when displaying the bonus wheel game outcomes may also trigger additional, action features and/or transformations. For example, FIG. 8A is an exemplary embodiment of wheel feature 626 of bonus wheel game 500 after a free spin of wheel feature 626 and the plurality of pointers 636. As shown, two pointers 636 are positioned directly adjacent one another and/or are both pointing or identifying wedge 628 that includes credit values 630 of “30” credits. In response to two or more pointers 636 identifying and/or covering the same wedge 628 of wheel feature 626, the adjacent pointers 636 may be combined to form a multiplier pointer 636M. In a non-limiting example shown in FIG. 8B, an indicator, pop-up, and/or an animation 644 may be displayed to identify to the player that an action feature is taking place within bonus wheel game 500. Continuing the example, and as shown in FIG. 8C, once animation 644 is complete, the two distinct pointers of the plurality of pointers 636 may be transformed into the single multiplier pointer 636M. In subsequent spins during bonus wheel game 500, the credit value 630 associated with the wedge 628 multiplier pointer 636M lands on may be multiplied when included within the awarded credit values for the bonus wheel game outcome. For example, if during a subsequent spin of wheel feature 626 and/or the plurality of pointers 636, 636M, multiplier pointer 636M lands on wedge 628 displaying a “100” credit value 630, the bonus wheel game outcome shall include any credit value identified by the plurality of pointers 636, plus “200” credits (e.g., 100 cr.×2=200 cr.), as identified by multiplier pointer 636M. In non-limiting examples, multiplier pointer 636M may only remain in bonus wheel game 500 for one subsequent free spin of bonus wheel game 500 or may remain until all free spins are completed within bonus wheel game 500. Alternatively, multiplier pointer 636M may remain in bonus wheel game 500 indefinitely and/or for a predetermined time and/or number of bonus wheel games 500.

FIGS. 8D and 8E are exemplary embodiments of the wheel feature 626 of bonus wheel game 500 after a free spin of wheel feature 626. FIGS. 8D and 8E show another non-limiting example of forming multiplier pointer 636M. As shown in FIG. 8D, all four (4) of the plurality of pointers 636 may stop adjacent one another, but not necessarily on and/or over the same wedge 628 of wheel feature 626. However, all four (4) of the plurality of pointers 636 displaying the bonus wheel game outcome may stop within a predetermined distance of one another. As such, and as similarly discussed herein (e.g., FIGS. 8A-8C), all four (4) of the plurality of pointers 636 may be combined to form multiplier pointer 636M. After animation 644 (see, FIG. 8D), and as shown in FIG. 8E, all four (4) of the plurality of pointers 636 are combined to form a 4× multiplier pointer 636M.

Although shown and discussed herein as 2× (see, FIGS. 8A-8C) or 4× (see, FIGS. 8D and 8E) multiplier pointers 636M, it should be understood that multiplier pointer 636M can include any numerical multiplier (e.g., 5×, 10×, 15×, 100×, etc.). The numerical multiplier may be dependent, at least in part, on the number of pointers 636 included in bonus wheel game 500 and/or whether the plurality of pointers 636 must land on the same wedge 628 or within a predetermined distance of adjacent pointers 636 to form multiplier pointer 636M, as discussed herein.

FIG. 9A is an exemplary embodiment of a bonus wheel game outcome for bonus wheel game 500 after the spinning/rotating and subsequent stopping of wheel feature 626 and/or the plurality of pointers 636. In the non-limiting example, wedges 628 forming wheel feature 626 may include credit values 630 as well as action features 634. More specifically, at least a portion of the plurality of wedges 628 can include a multiplier action feature 634M (e.g., “2×”), a free spin action feature 634FS (e.g., “FREE SPIN”), and a pointer addition action feature 634PA (e.g., “+1”). In the example, each one of the action features 634M, 634FS, 634PA may alter, edit, and/or adjust bonus wheel game 500 and/or the visual components forming bonus wheel game 500. For example, and as shown in FIGS. 9A and 9B, where pointer 636 lands on wedge 628 including multiplier action feature 634M, that specific pointer, or alternatively all pointers 636, may be transformed into multiplier pointer 636M (see, FIG. 9B). Additionally, in response to pointer 636 identifying wedge 628 including pointer addition action feature 634PA, a distinct pointer 636P (see, FIG. 9B) may be added to and/or included within bonus wheel game 500. In another example, if pointer 636 is aligned with wedge 628 including free spin action feature 634FS, an additional free spin of wheel feature 626 and/or pointers 636, 636M, 636P may be added to bonus wheel game 500.

FIGS. 10A and 10B shown an additional exemplary embodiments of bonus wheel game outcome for bonus wheel game 500. Wheel feature 626 shown in FIGS. 10A and 10B includes additional examples of action features 634. More specifically, a wedge 628 forming wheel feature 626 may include a boost action feature 634B. Boost action feature 634B may boost and/or increase credit values 630 included on each wedge 628 of wheel feature 626 prior to a subsequent free spin during bonus wheel game 500, as similarly discussed herein (e.g., FIGS. 6F and 6G). That is, in response to pointer 636 identifying wedge 628 including boost action feature 634B, all credit values 630 included on the plurality of wedges 628 forming wheel feature 626 may increase. FIG. 10A depicts wheel feature 626 prior to the boosting of credit values 630, and FIG. 10B depicts wheel feature 626 after the boosting of credit values 630, but before a subsequent free spin of wheel feature 626 takes place for bonus wheel game 500. In the non-limiting example, each credit value 630 for the plurality of wedges 628 forming wheel feature 626 is doubled in value as a result of pointer 636 identifying wedge 628 including boost action feature 634B (see, FIG. 10A). In non-limiting examples, wheel feature 626 including boosted credit values 630 may only remain in bonus wheel game 500 for one subsequent free spin or may remain until all free spins are completed within bonus wheel game 500. Alternatively, wheel feature 626 including boosted credit values 630 may remain in bonus wheel game 500 indefinitely and/or for a predetermined time and/or number of bonus wheel games 500.

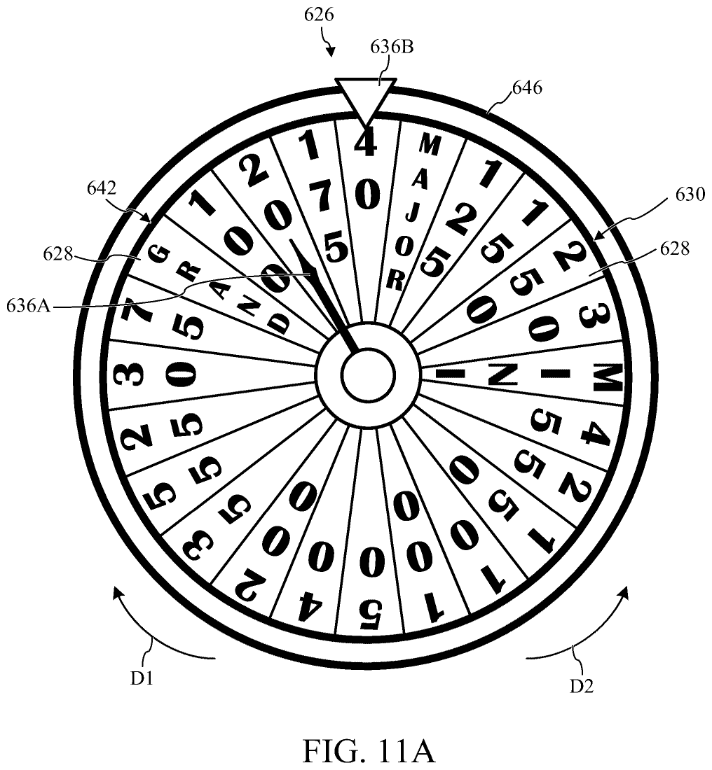

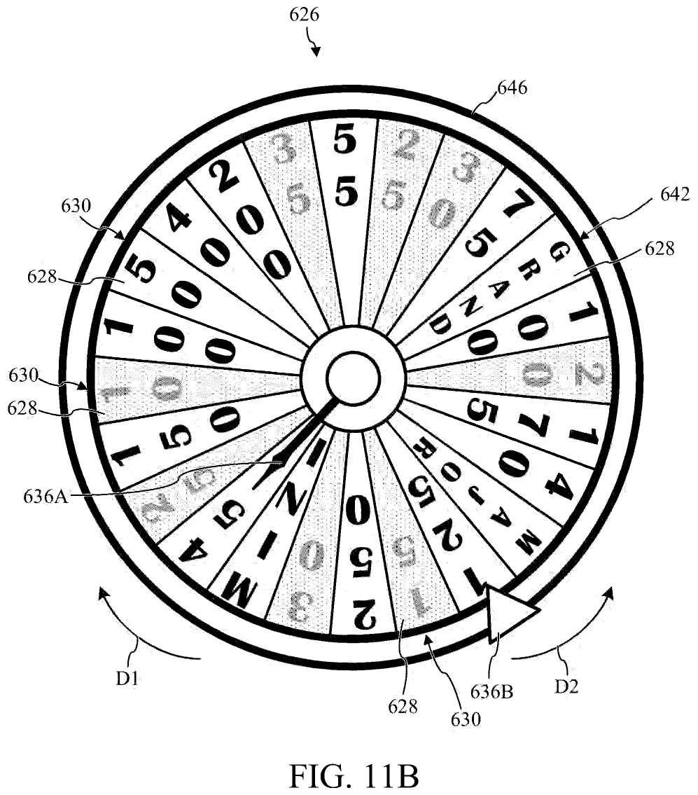

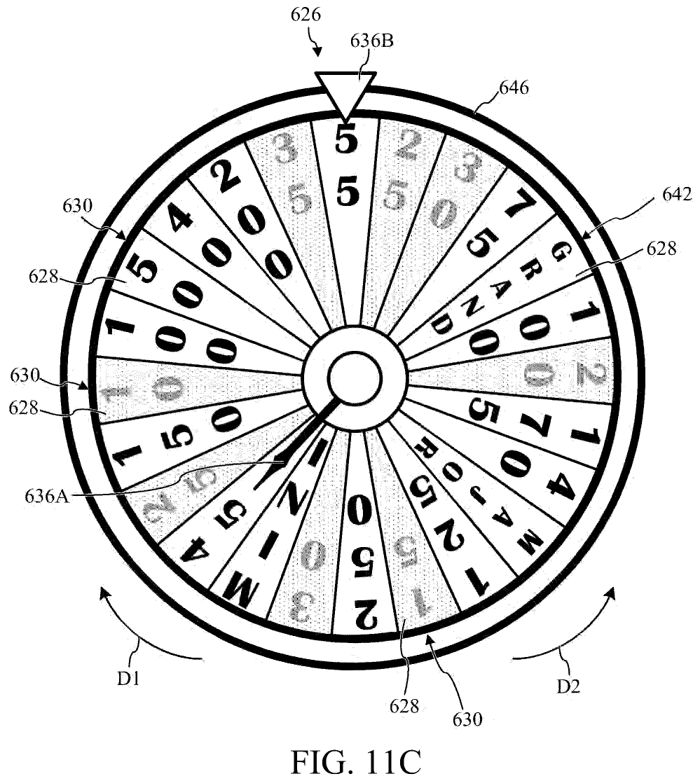

FIG. 11A is another exemplary embodiment of wheel feature 626 of bonus wheel game 500 prior to spinning or rotating. As shown, and similarly discussed herein (e.g., FIG. 7A), wheel feature 626 includes a single inner pointer 636A extending radially outward from a center of wheel feature 626, and/or radially toward a perimeter or rim 646 of wheel feature 626. Additionally in the non-limiting example, bonus wheel game 500 includes a rim pointer 636B positioned adjacent to perimeter or rim 646 of wheel feature 626, radially opposite the center of wheel feature 626. Each pointer 636A, 636B is configured to cover at least a portion of one of the plurality of wedges 628 of wheel feature 626 during bonus wheel game 500. Similar to inner pointer 636A, and during bonus wheel game 500, rim pointers 636B can rotate or spin in a first direction (D1) or a second direction (D2)—similar to wheel feature 626. Furthermore, the direction of rotation for pointers 636B can change every free spin of wheel feature 626 during bonus wheel game 500. Additionally, rim pointer 636B can rotate in the first direction (D1), while inner pointers 636A and/or wheel feature 626 can rotate in a second direction (D2)—and vice versa. In a non-limiting example where wheel feature 626 remains stationary, pointers 636A, 636B may rotate about the center of wheel feature 626 during bonus wheel game 500. FIG. 11B shows an exemplary embodiment of a bonus wheel game outcome for bonus wheel game 500, after the rotating/spinning and subsequent stoppage of wheel feature 626, as well as both inner pointer 636A and rim pointer 636B.

In another non-limiting example, rim pointers 636B may remain stationary, and inner pointer 636A and/or wheel feature 626 may rotate in a first direction (D1) and/or second direction (D2) during bonus wheel game 500. FIG. 11C depicts a bonus wheel game outcome for bonus wheel game 500. In the exemplary embodiment, wheel feature 626 and inner pointer 636A may rotate about the center of wheel feature 626, but rim pointer 636B may remain stationary during each free spin of bonus wheel game 500. In an additionally non-limiting example, at least one of pointer 636A, 636B and/or wheel feature 626 may alternate between being stationary and rotating or spinning during each free spin of bonus wheel game 500.

In non-limiting examples, wheel feature 626 may stop first, the plurality of pointers 636A, 636B may stop first, both wheel feature 626 and pointers 636A, 636B may stop simultaneously, or one pointer 636A, 636B may stop before wheel feature 626, while the distinct pointers 636A, 636B may stop after wheel feature 626. Bonus wheel game outcome for bonus wheel game 500 based on wheel feature 626 and pointers 636A, 636B shown in FIGS. 11A-11C may award the player all credit values indicated, identified, and/or selected by the plurality of pointers 636A, 636B. That is, when wheel feature 626 and/or the plurality of pointers 636A, 636B stop spinning, the awarded credit value for the bonus wheel game outcome is equal to the total of all credit values 630 associated with wedges 628 that are identified, aligned with, and/or pointed to by pointers 636A, 636B. In the non-limiting example shown in FIG. 11C, inner pointer 636A points to wedge 628 of wheel feature 626 that includes a credit value 630 of “30” credits. Additionally, rim pointer 636B identifies wedge 628 that includes a credit value 630 of “55” credits. As such, the awarded credit value for the bonus wheel game outcome shown in FIG. 11C is “85” credits.

Additionally, as shown in the exemplary embodiment of FIGS. 11A-11C, and as similarly discussed herein (e.g., FIGS. 6C-6E), at least a portion of wedges 628 forming wheel feature 626 may be dimmed or shaded out after displaying bonus wheel game outcomes and/or between free spins for bonus wheel game 500. In a non-limiting example, all wedges 628 including credit values 630 less than the highest credit value 630 included within the bonus wheel game outcome may be dimmed for subsequent free spins of wheel feature 626 in bonus wheel game 500. As shown in FIG. 11A, inner pointer 636A identifies wedge 628 including a depicted credit value 630 of “20” credits for the bonus wheel game outcome, while rim pointer 636B points to wedge 628 including a depicted credit values 630 of “40” credits. As such, and as shown in FIG. 11B, a subsequent free spin and/or subsequent bonus wheel game outcome for bonus wheel game 500 can include wedges 628 depicting credit values 630 less than “40” credits to be dimmed and/or not identifiable by pointers 636A, 636B. Specifically, wedges 628 depicting credit values 630 of “10”, “15”, “20”, “25”, “30”, and “35” credits are dimmed in the exemplary embodiment shown in FIG. 11B. In other exemplary embodiments, all wedges 628 including credit values 630 less than the lowest credit value 630 included within the bonus wheel game outcome may be dimmed for subsequent free spins of wheel feature 626 in bonus wheel game 500.

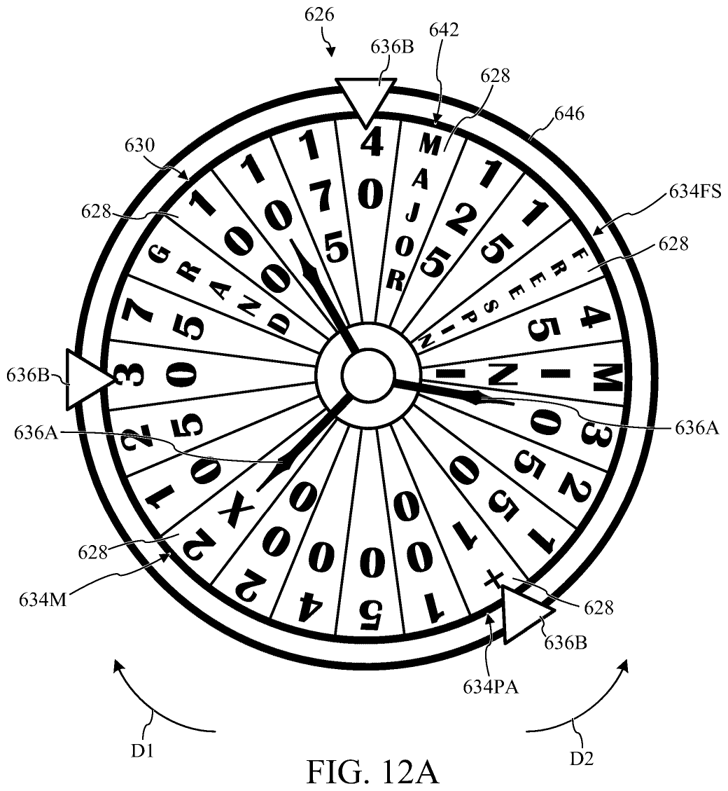

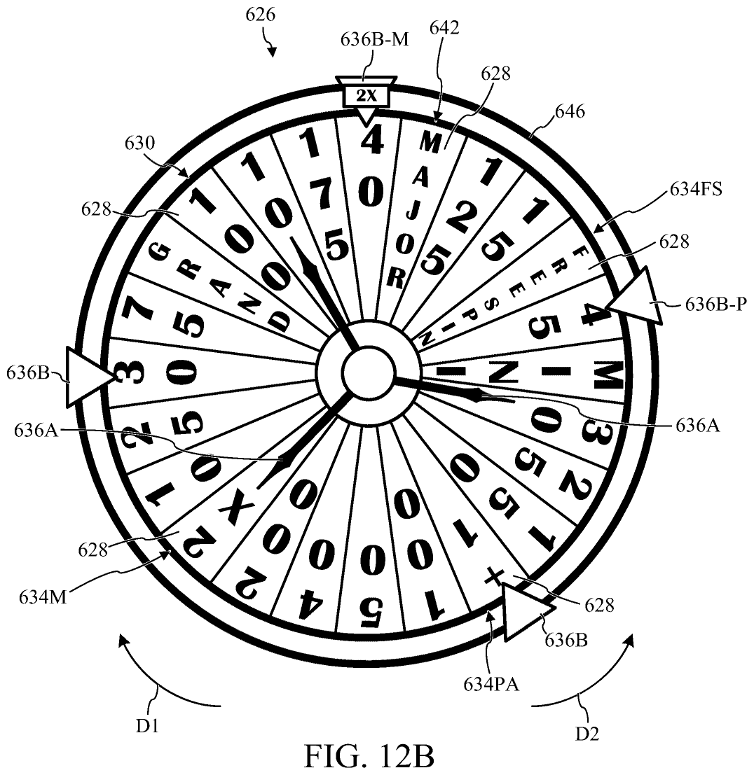

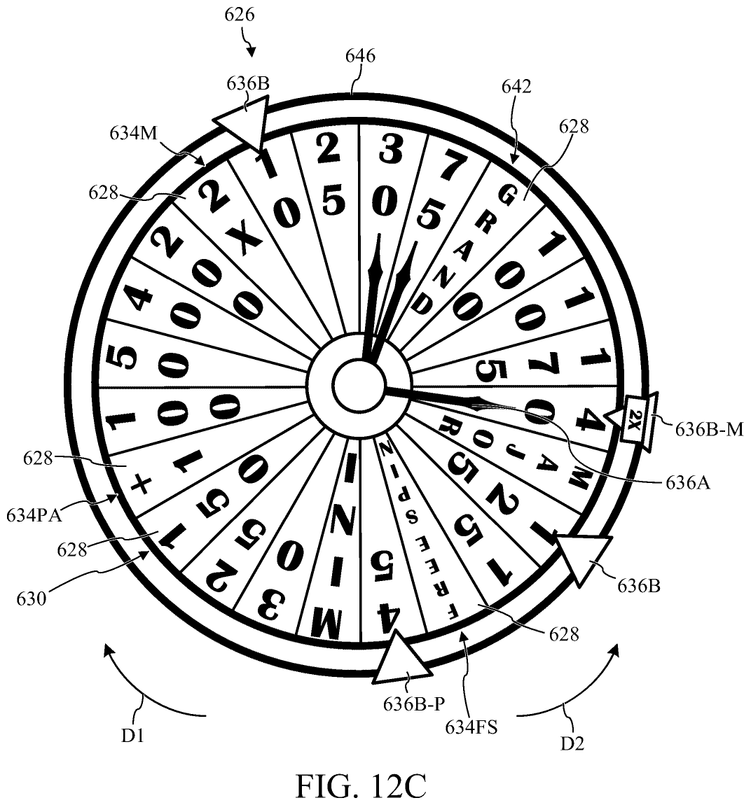

FIGS. 12A-12C are additional exemplary views of wheel feature 626 included in bonus wheel game 500. Specifically, FIG. 12A shows wheel feature 626 including a bonus wheel game outcome for bonus wheel game 500, FIG. 12B shows wheel feature 626 including the bonus wheel game outcome, after a transformation of enhancement of rim pointers 636B, and FIG. 12C shows wheel feature 626 including a distinct bonus wheel game outcome and the transformed or enhanced rim pointers 636B. As shown, wheel feature 626 can include a plurality of inner pointers 636A extending radially outward from the center of wheel feature 626, as well as a plurality of rim pointers 636B positioned adjacent to a perimeter and/or rim 646 of wheel feature 626. Each of the plurality of pointers 636A, 636B, as well as wheel feature 626 may be configured to rotate and/or spin during bonus wheel game 500, as similarly discussed herein.

Similar to FIG. 9A, the non-limiting example shown in FIG. 12A includes wedges 628 forming wheel feature 626 having credit values 630 as well as action features 634. More specifically, at least a portion of the plurality of wedges 628 can include a multiplier action feature 634M (e.g., “2×”), a free spin action feature 634FS (e.g., “FREE SPIN”), and a pointer addition action feature 634PA (e.g., “+1”). Each one of the action features 634M, 634FS, 634PA may alter, edit, and/or adjust bonus wheel game 500 and/or the visual components forming bonus wheel game 500. However, and distinct from the exemplary embodiment shown and discussed herein with respect to FIGS. 9A and 9B, when pointers 636A, 636B land on wedge 628 including action features 634M, 634FS, 634PA, the action feature and/or transformations may affect rim pointers 636B only. For example, one inner pointer 636A identifies multiplier action feature 634M of wheel feature 626. Additionally, one rim pointer 636B is aligned with pointer addition action feature 634PA included in wheel feature 626. As such, and as shown in FIG. 12B, one rim pointer 636B may be transformed into a multiplier rim pointer 636B-M, and a distinct rim pointer 636B-P may be added to wheel feature 626 for bonus wheel game 500. All rim pointers 636B, 636B-M, 636B-P may rotate about wheel feature 626 during subsequent bonus wheel game 500, as similarly discussed herein. Additionally, in non-limiting examples, multiplier rim pointer 636B-M and/or distinct rim pointer 636B-P may only remain in bonus wheel game 500 for one subsequent free spin of bonus wheel game 500 or may remain until all free spins are completed within bonus wheel game 500. Alternatively, multiplier rim pointer 636B-M and/or distinct rim pointer 636B-P may remain in bonus wheel game 500 indefinitely and/or for a predetermined time and/or number of bonus wheel games 500.

Although discussed herein as only effecting rim pointers 636B, it should be understood that action features 634 can affect and/or transform inner pointers 636A, rim pointers 636B, or any combination thereof. For example, inner pointers 636A that align with action features 634 on wheel feature 626 may transform and/or adjust inner pointers 636A, while rim pointers 636B aligned with action features 634 transform and/or adjust rim pointers 636B—and vice versa.

FIG. 12C shows a distinct bonus wheel game outcome for bonus wheel game 500, subsequent to transforming rim pointers 636B based on action features 634M, 634PA. The bonus wheel game outcome for bonus wheel game 500 based on wheel feature 626 and pointers 636A, 636B shown in FIG. 12C may award the player all credit values indicated, identified, and/or selected by the plurality of pointers 636A, 636B. That is, when wheel feature 626 and/or the plurality of pointers 636A, 636B stop spinning, the awarded credit value for the bonus wheel game outcome is equal to the total of all credit values 630 associated with wedges 628 that are identified, aligned with, and/or pointed to by pointers 636A, 636B. In the non-limiting example shown in FIG. 12C, inner pointer 636A points to wedges 628 of wheel feature 626 that include credit values 630 of “30”, “75”, and “40” credits. Additionally, rim pointer 636B identifies wedges 628 that include credit values 630 of “10” and “125” credits. Two times (2×) multiplier rim pointer 636B-M is aligned with wedge 628 that includes a credit value 630 of “40” credits, and distinct rim pointer 636B-P is aligned with wedge 628 that includes credit value 630 of “45” credits. As such, the awarded credit value for the bonus wheel game outcome shown in FIG. 12C is “405” credits.

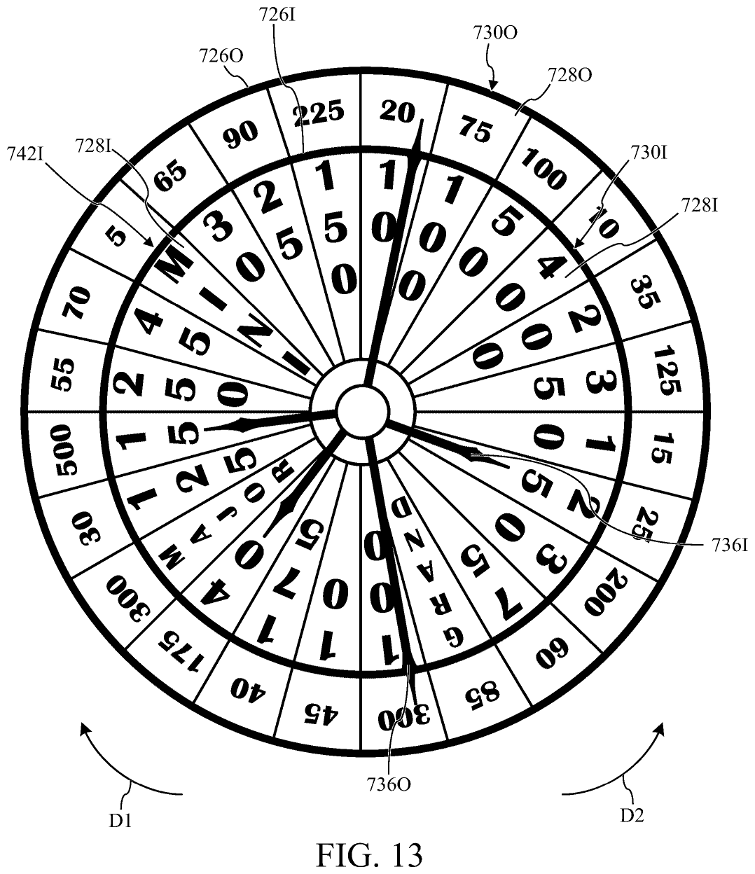

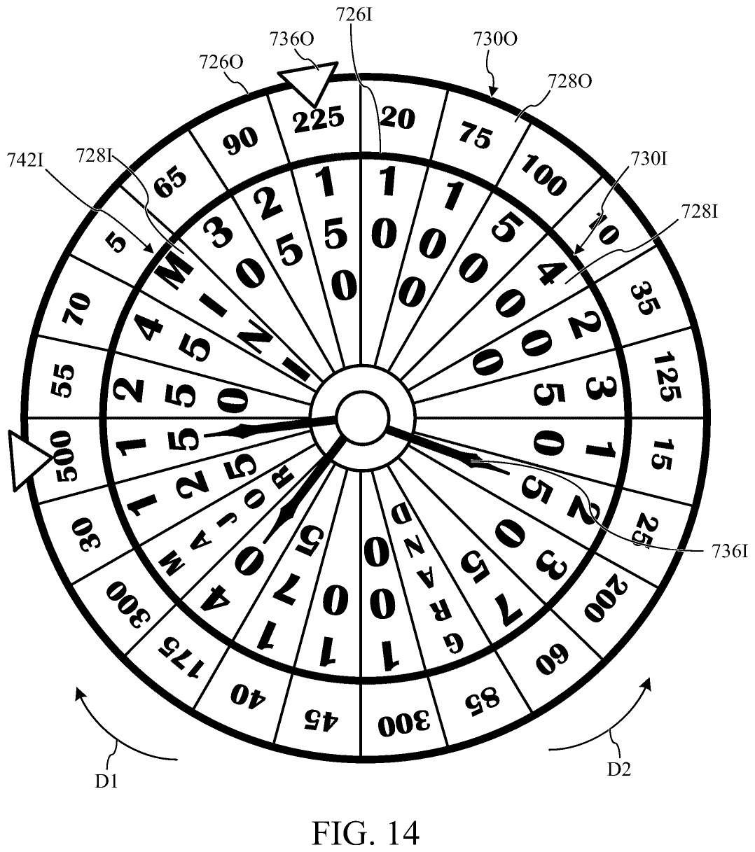

FIGS. 13 and 14 are exemplary views of various wheel features 726I, 726O and pointers 736I, 736O for bonus wheel game 500 depicting a bonus wheel game outcome. That is, FIGS. 13 and 14 are exemplary embodiments of wheel features 726I, 726O and pointers 736I, 736O included within bonus wheel game 500 presented, displayed, and/or played on EGM 104, and as similarly discussed herein (e.g., FIGS. 4-6H).

As shown in the non-limiting example of FIG. 13, bonus wheel game 500 can include two distinct wheel features 726. More specifically, bonus wheel game 500 includes a first or inner wheel feature 726I, and a distinct or outer wheel feature 726O disposed around, adjacent to, and/or concentrically aligned with inner wheel feature 726I. As similarly discussed herein, each wheel feature 726I, 726O can include a plurality of wedges 728I, 728O. In the non-limiting example, each wedge 728I, 728O can display and/or depict credit values 730I, 730O or jackpot features 742I, 742O. In other non-limiting examples, wedges 728I, 728O of wheel features 726I, 726O can include mystery credit values and/or action features. During bonus wheel game 500, each wheel feature 726I, 726O can rotate or spin in first direction (D1) or second direction (D2). Furthermore, the direction of rotation for wheel features 726I, 726O can change every free spin during bonus wheel game 500. Additionally, inner wheel feature 726I can rotate in the first direction (D1), while outer wheel feature 726O can rotate in the second direction (D2)—and vice versa. In another non-limiting example at least one wheel feature 726I, 726O can remain stationary during bonus wheel game 500, and pointers 736I, 736O may rotate about the center of wheel features 726I, 726O during bonus wheel game 500, as discussed herein.

Bonus wheel game 500 also includes a plurality of pointers 736I, 736O. More specifically, inner pointers 736I and outer pointers 736O each extend radial outward from the center of wheel features 726I, 726O. However, inner pointers 736I include a length that is shorter than a length of outer pointers 736O. As shown in FIG. 13, outer pointers 736O extend radially to be aligned with and/or identify wedges 728O included in outer wheel feature 726O, while inner pointers 736I extend radially to only cover a portion of wedges 728I included in inner wheel feature 726I. As such, inner pointers 736I can identify the credit values 730I for inner wheel feature 726I associated with bonus wheel game outcome, while outer pointers 736O can identify the credit values 730O for outer wheel feature 726O, respectively. During bonus wheel game 500, and similar to each wheel feature 726I, 726O, pointers 736I, 736O can rotate or spin in first direction (D1) or second direction (D2). Furthermore, the direction of rotation for pointers 736I, 736O can change every free spin during bonus wheel game 500. Additionally, inner pointers 736I can rotate in the first direction (D1), while outer pointers 736O can rotate in the second direction (D2)—and vice versa. Furthermore, a portion of each of the plurality of pointers 736I, 736O may rotate in the first direction (D1), while the remaining portion of pointers 736I, 736O rotate in the second direction (D2). In another non-limiting example, at least one pointer 736I, 736O can remain stationary during bonus wheel game 500, and wheel features 726I, 726O may rotate or spin during bonus wheel game 500, as discussed herein.

In the non-limiting example of the bonus wheel game outcome shown in FIG. 13, inner pointers 736I point to inner wedges 728I of inner wheel feature 726I that include credit values 730I of “15”, “40”, and “25” credits. Additionally, outer pointers 736O point to outer wedges 728O of outer wheel feature 726O that include credit values 730O of “20” and “300” credits. As a result, the total awarded credit value for the bonus wheel game outcome for the player is “400” credits.

FIG. 14 shows another non-limiting example of distinct wheel features 726I, 726O and pointers 736I, 736O for bonus wheel game 500 displaying a bonus wheel game outcome. In the example, and as similar discussed herein (e.g., FIGS. 11A-11C), outer pointers 736O can be formed adjacent to outer wheel feature 726O and/or an outer rim of outer wheel feature 726O, radially opposite the center of wheel features 726I, 726O (e.g., rim pointer).

Although discussed herein as being included in and/or representing bonus wheel game 500, it should be understood that wheel feature 626, 726 and plurality of pointers 636, 736 can also represent a base game, similar to base reel game 400. That is, the exemplary embodiments of wheel feature 626, 726 and plurality of pointers 636, 736 discussed herein can be included in bonus wheel game 500, or alternatively, can represent a base wheel game that may trigger a distinct bonus wheel game 500, as similarly discussed herein (e.g., FIGS. 4-6H). In another non-limiting example, wheel feature 626, 726 and plurality of pointers 636, 736 can represent both a base wheel game and a bonus wheel game. In this example, the base wheel game can include only a single or a first predetermined number of pointers 636, 736, and the bonus wheel game can include a second predetermined number of pointers 636, 736, greater than the first, and/or both wheel features.

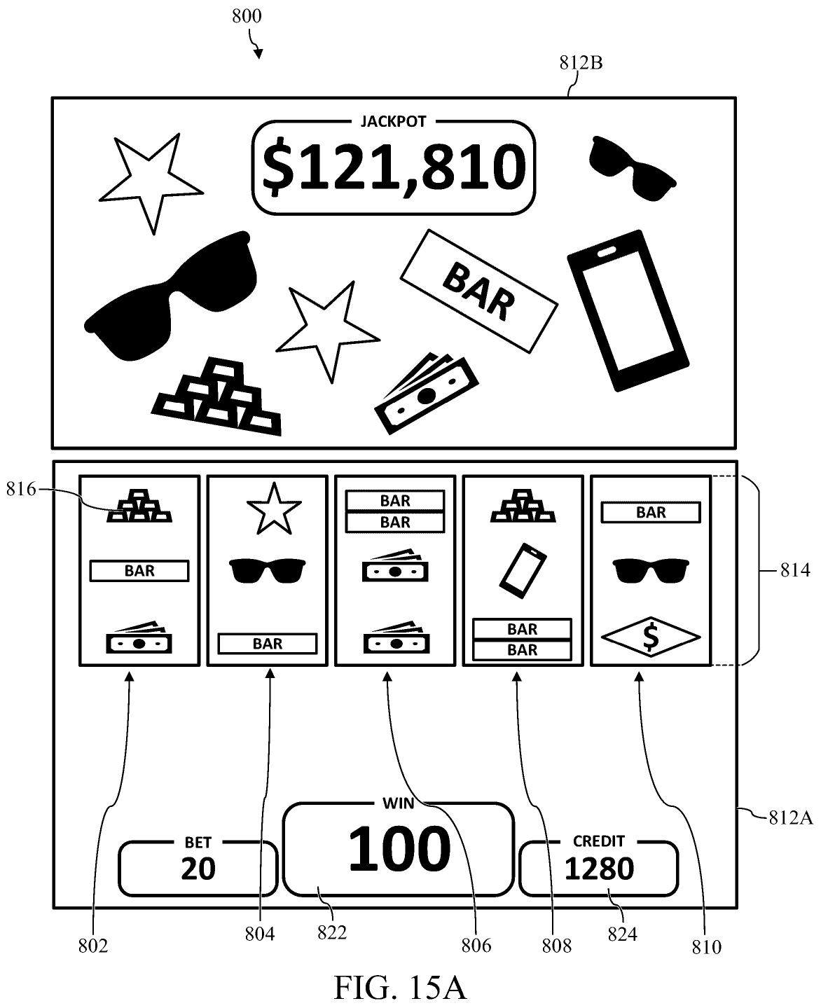

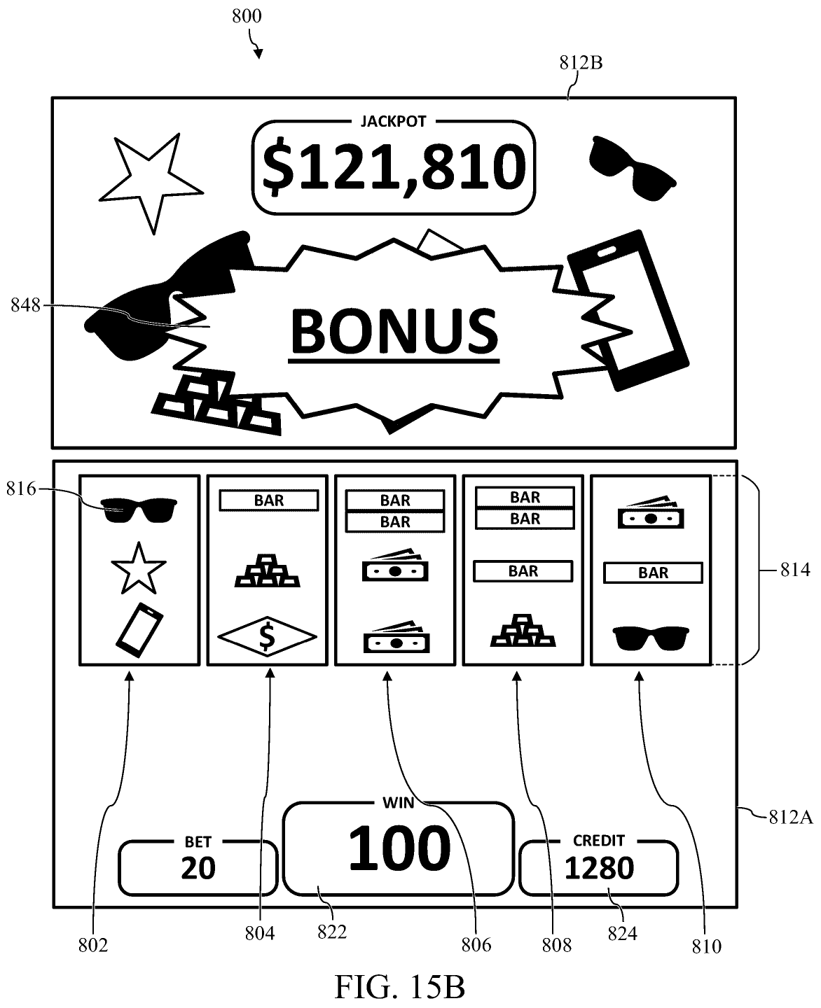

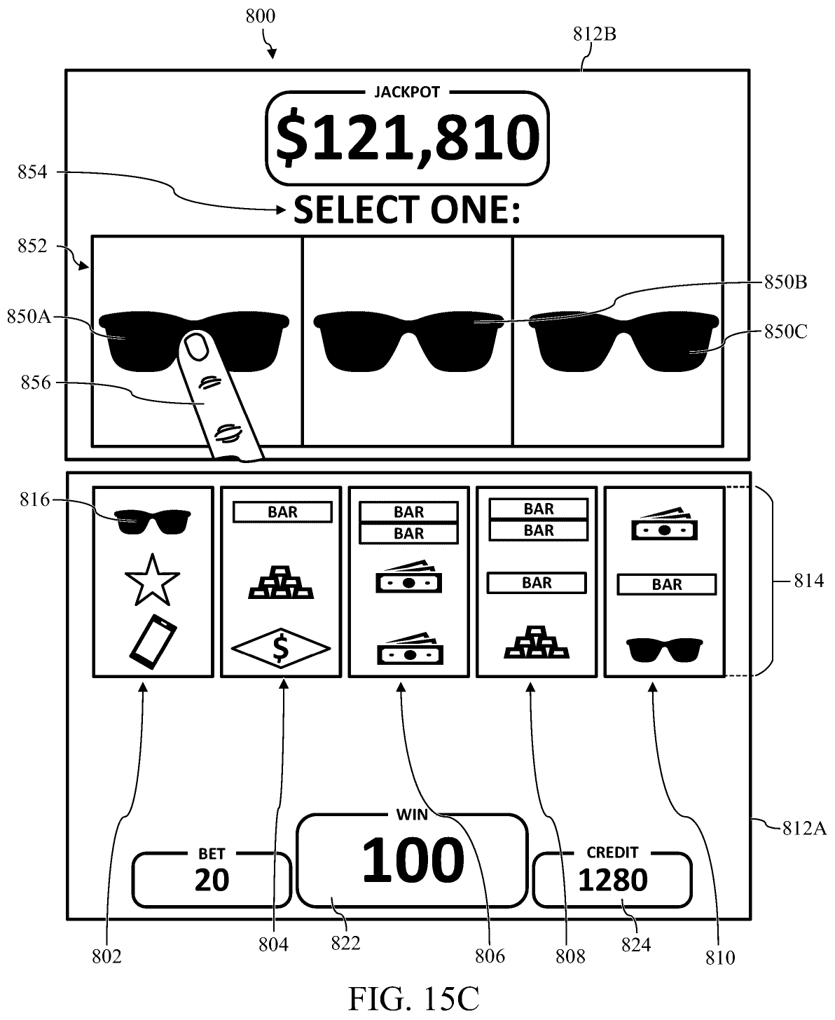

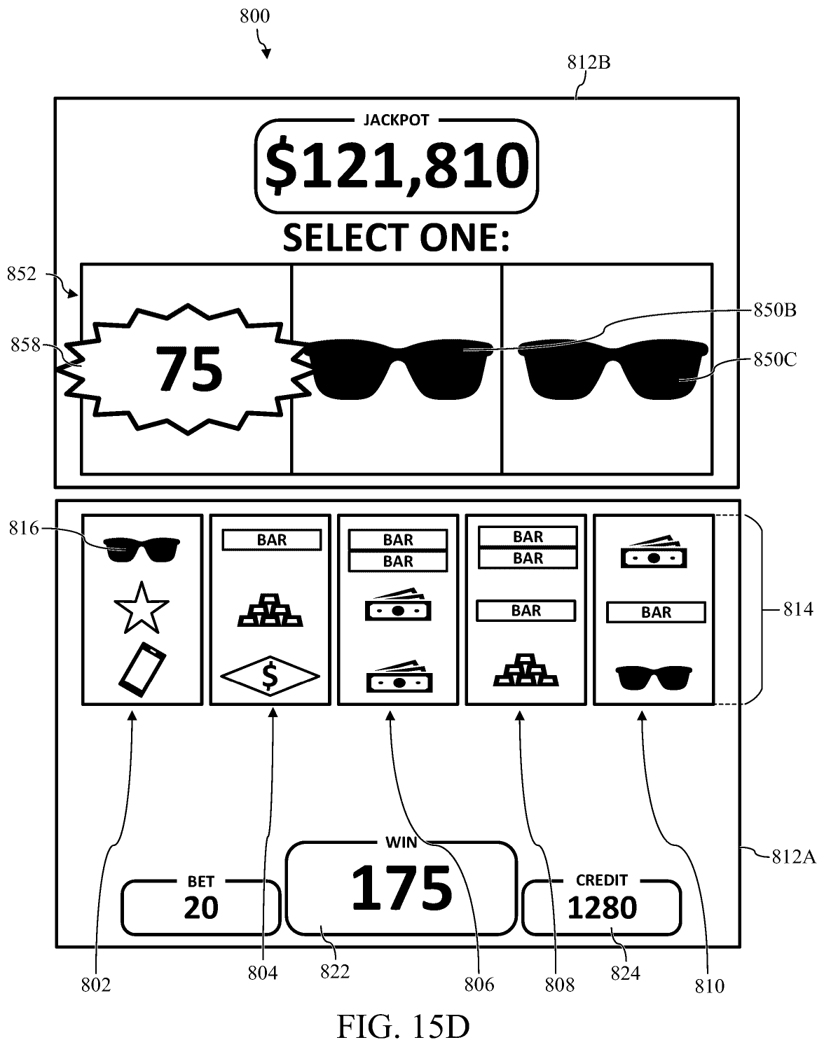

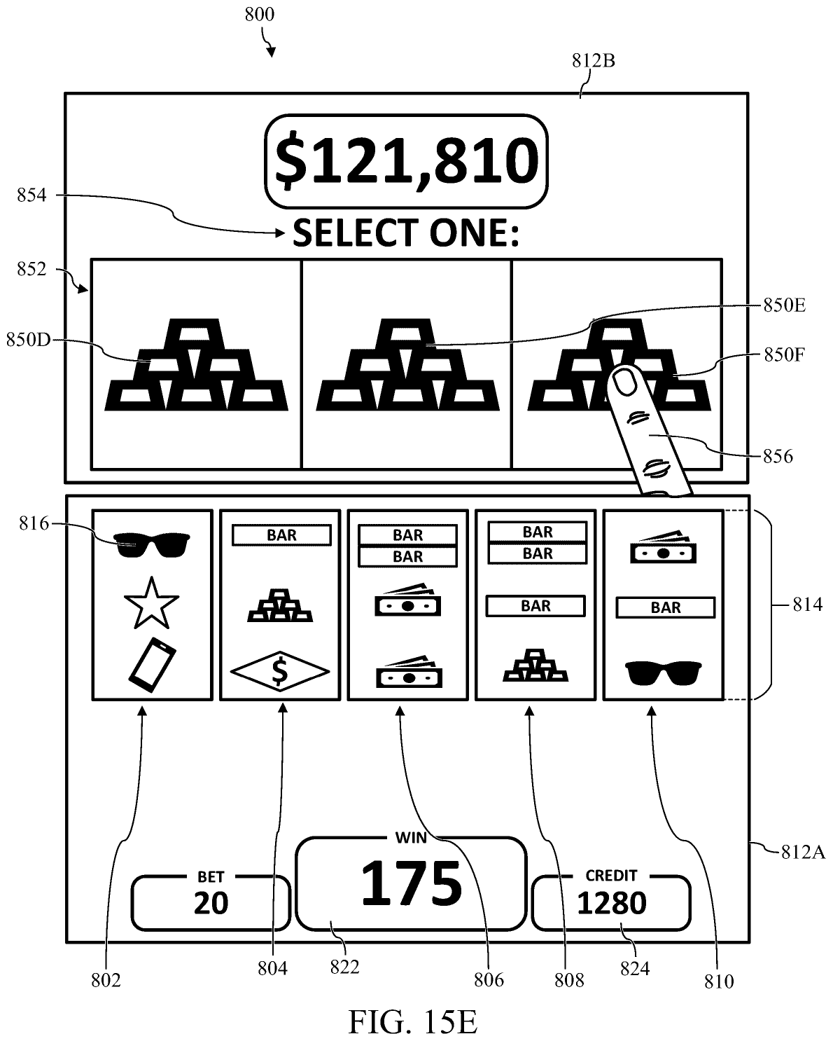

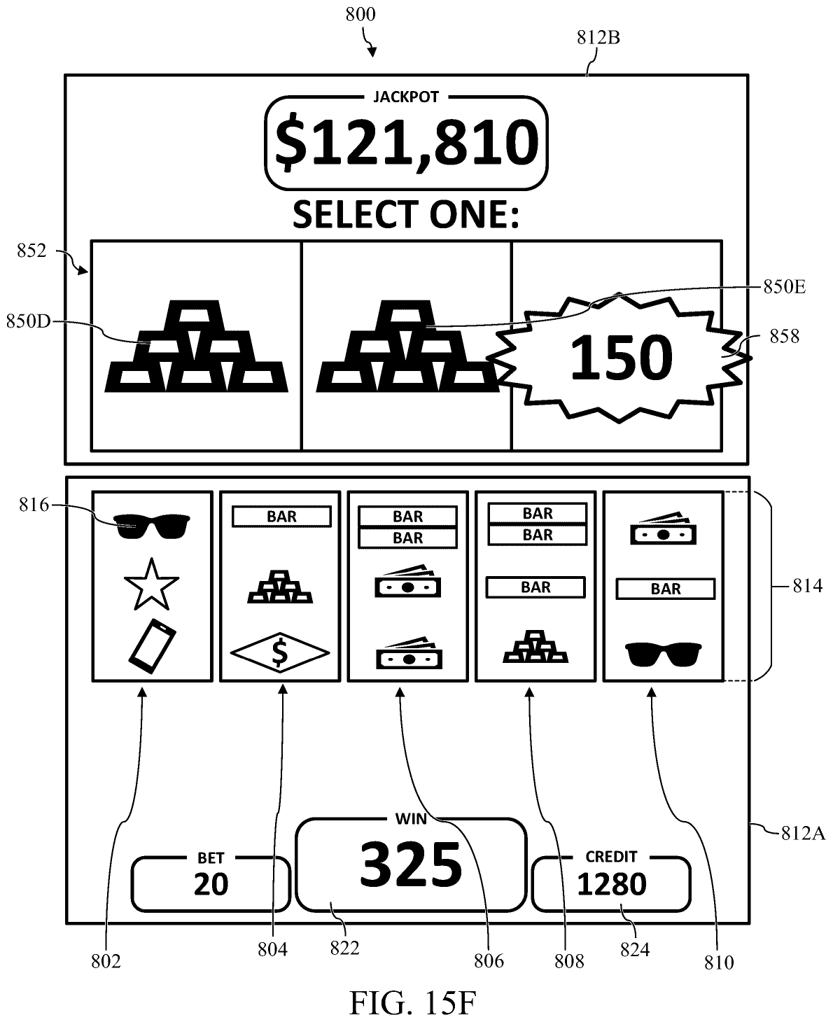

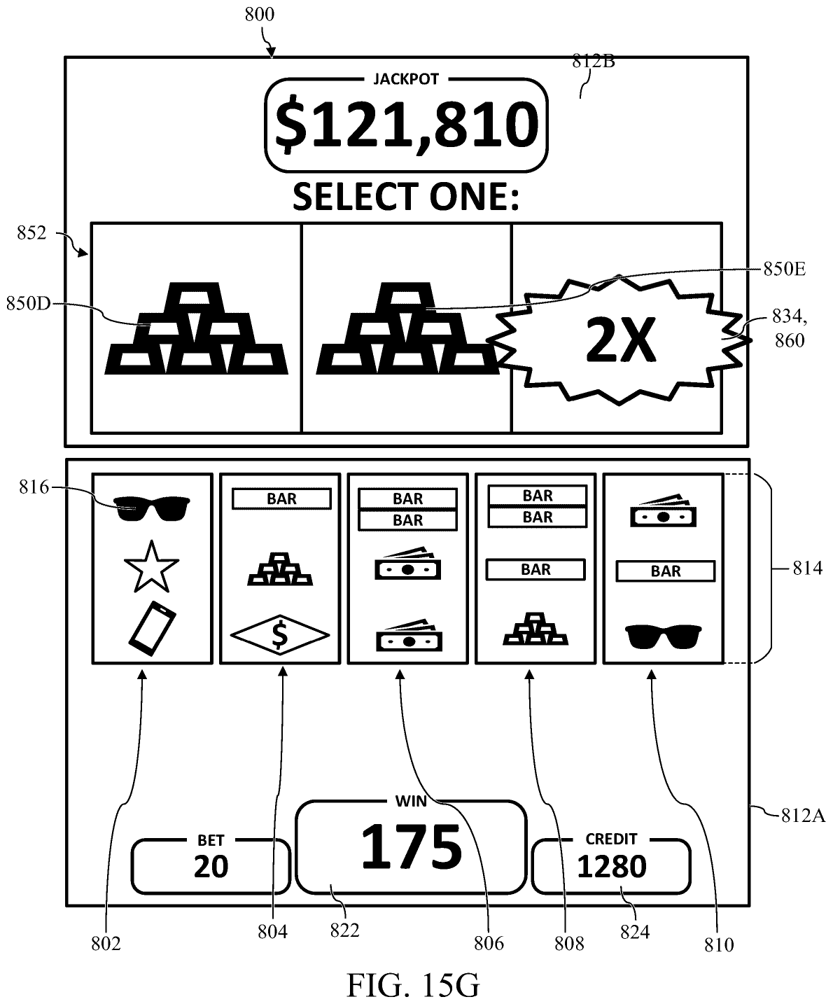

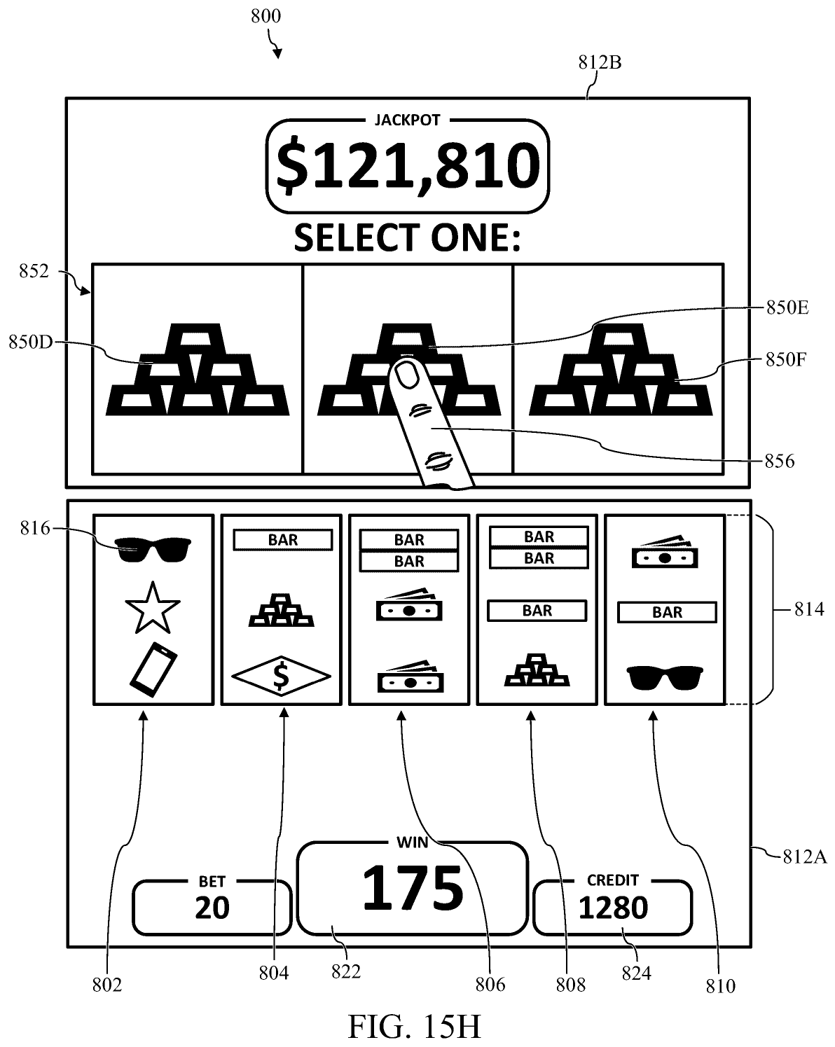

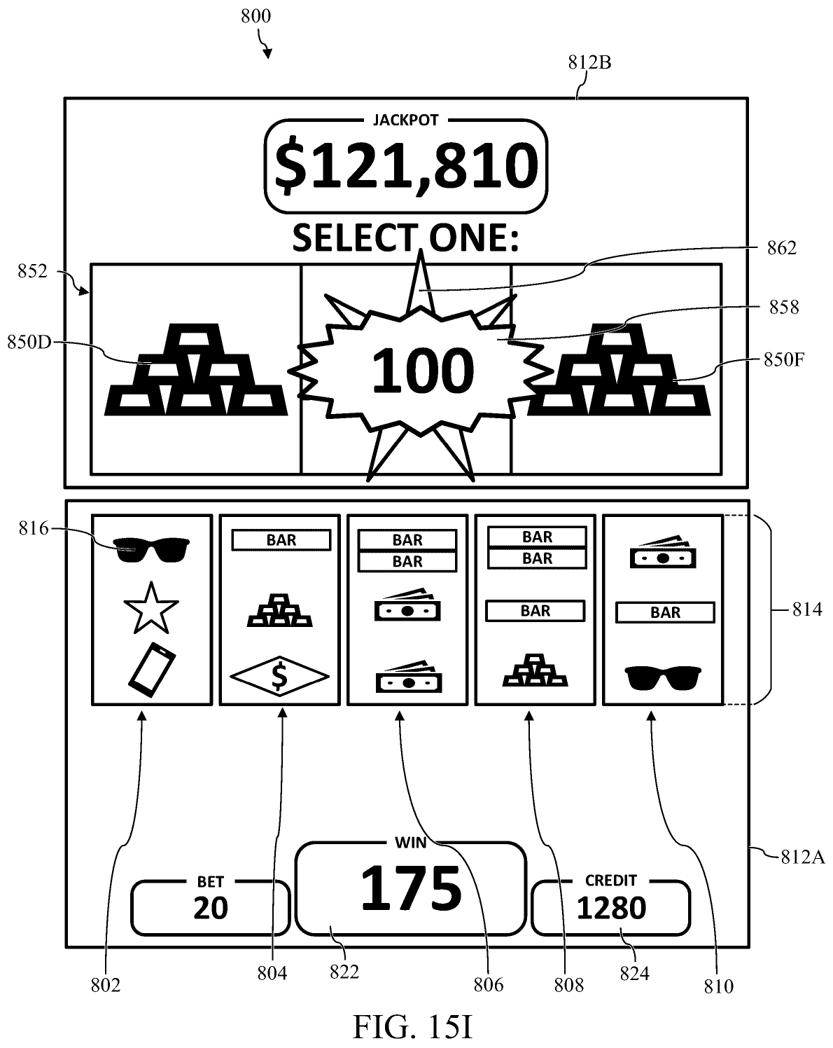

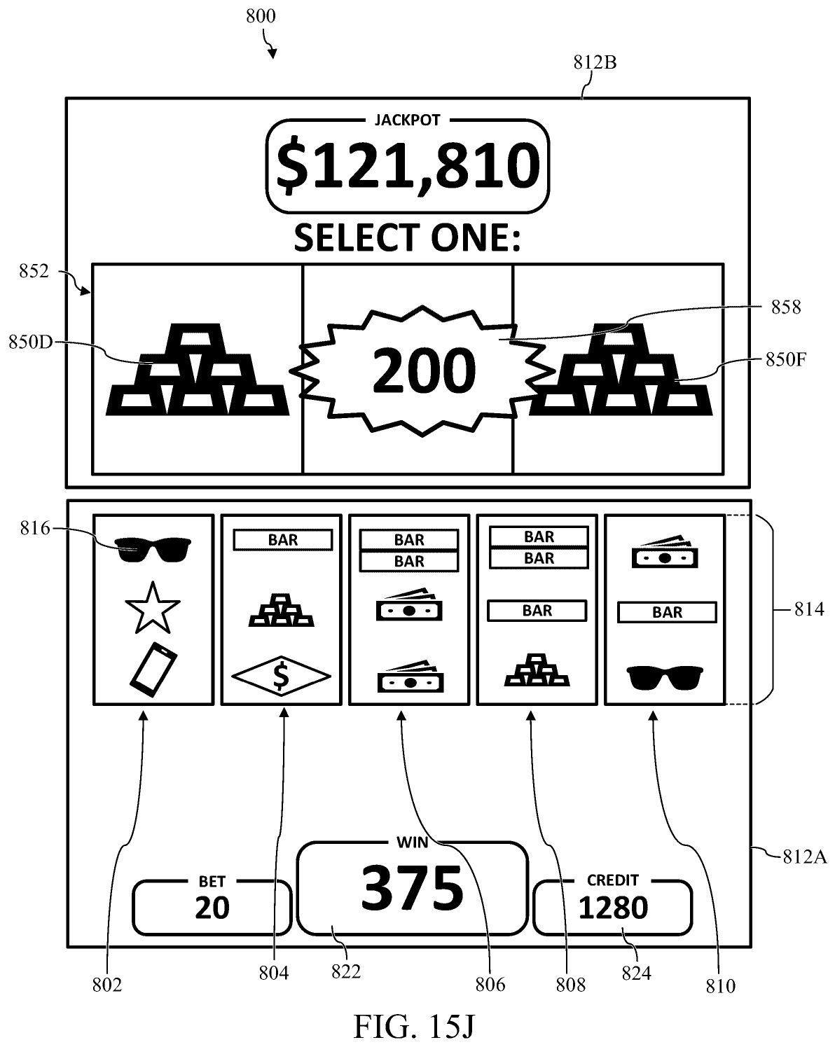

FIGS. 15A-15J are user interfaces or screen shots of a sequence between the base reel game 400 (FIG. 15A) and interactive bonus games 800 (FIGS. 15B-15J). As discussed herein, interactive bonus games 800 may take the place of bonus wheel game 500, as discussed herein. As such, and other than the distinctions discussed in detail herein, bonus game 800 may function, operate, and/or interact with game controller 202 and/or processors 204 of EGM 104 similar to bonus wheel game 500.

FIG. 15A, shows an exemplary user interface or screen shot of base reel game 400. As previously discussed herein (e.g., FIG. 4), a displayed base reel game outcome of the base reel game 400 may present, represent, and/or depict a winning primary game outcome. For example, the reel outcome (base reel game outcome) may correspond to at least one winning bingo pattern for a primary or underlying Class II game. Alternatively, the base game reel outcome, determined randomly, may represent a winning pattern of the plurality of game symbols 814 included in base reel game 400 (e.g., in Class III games). As shown in the non-limiting example, win meter 822 includes a 100-credit win for base reel game 400 and/or base reel game outcome, dependent upon results of the bingo pattern or the plurality of game symbols 814 in reels 802-810 depicted in display 412A. However, and as similarly discussed herein, the credit value depicted in win meter 822 may not represent the total credit value award for base reel game outcome of base reel game 400. Rather, the remainder of the credit value awarded to the player based on the base reel game outcome may be awarded and/or presented in interactive bonus game 800 (see, FIGS. 15B-15F). As such, it may be determined that base reel game 400 and/or base reel game outcome, as depicted in FIG. 15A may trigger, activate, and/or engage interactive bonus game 800 in display 812B.

FIG. 15B is an exemplary user interface or screen shot after the bonus game 800 has been triggered. In the exemplary embodiment, display 812B shown in FIG. 15B provides a bonus game notification and/or animation 848 indicating that the base reel game outcome for base reel game 400 has triggered the interactive bonus game 500. In the non-limiting example, and as discussed herein, secondary display 812B of EGM 104 (see, FIG. 1) may be configured as a touch enabled display device to allow the player to engage with and/or play interactive bonus game 800, once triggered and displayed on touch enabled display 812B. Although discussed herein as being displayed on secondary display 812B, it should be understood that interactive bonus game 800 can be displayed and/or played on display 812A. Alternatively where only a single display is included in EGM 104, the single display may be formed as a touch enabled device, and both base reel game 400 and bonus game 800 can be played on the single display. In this example, interactive bonus game 800 may replace and/or overlap base reel game 400 once triggered.

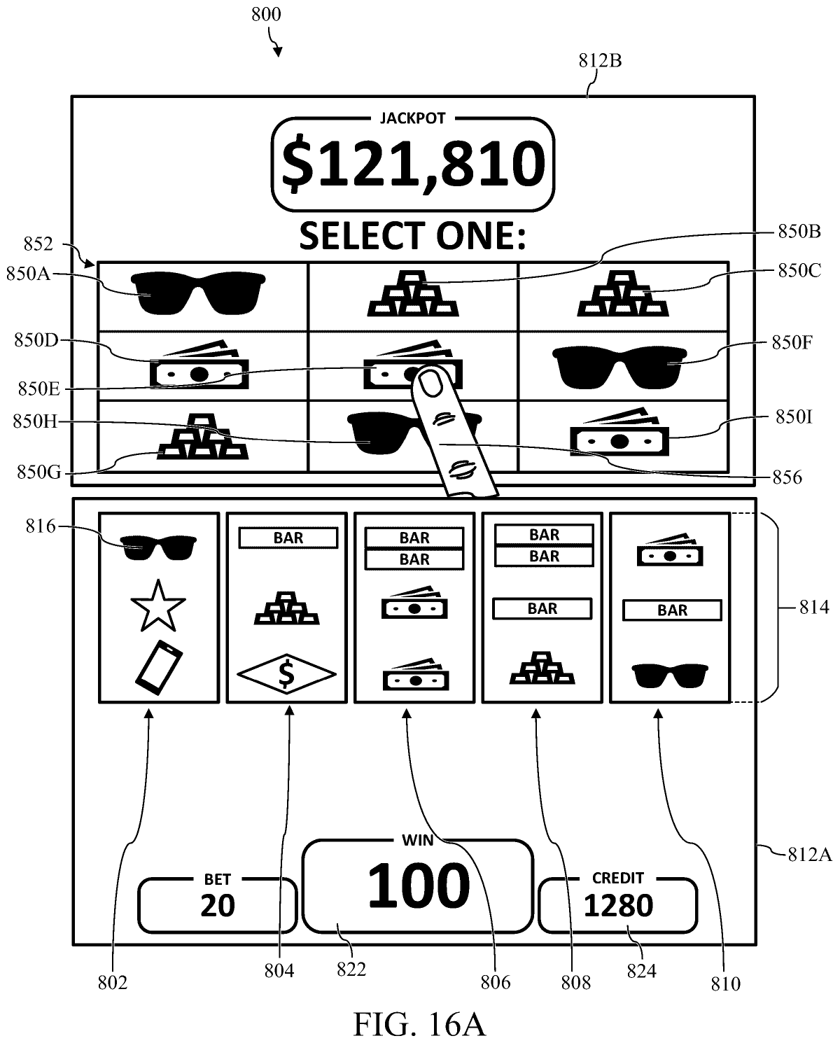

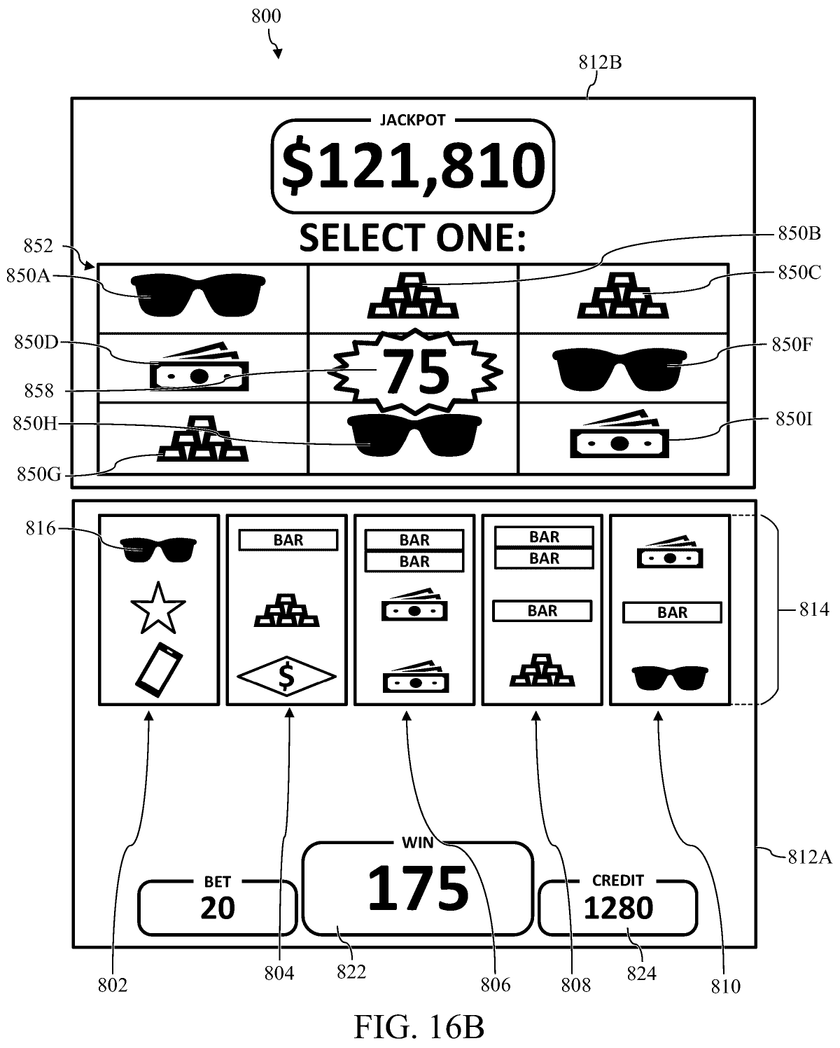

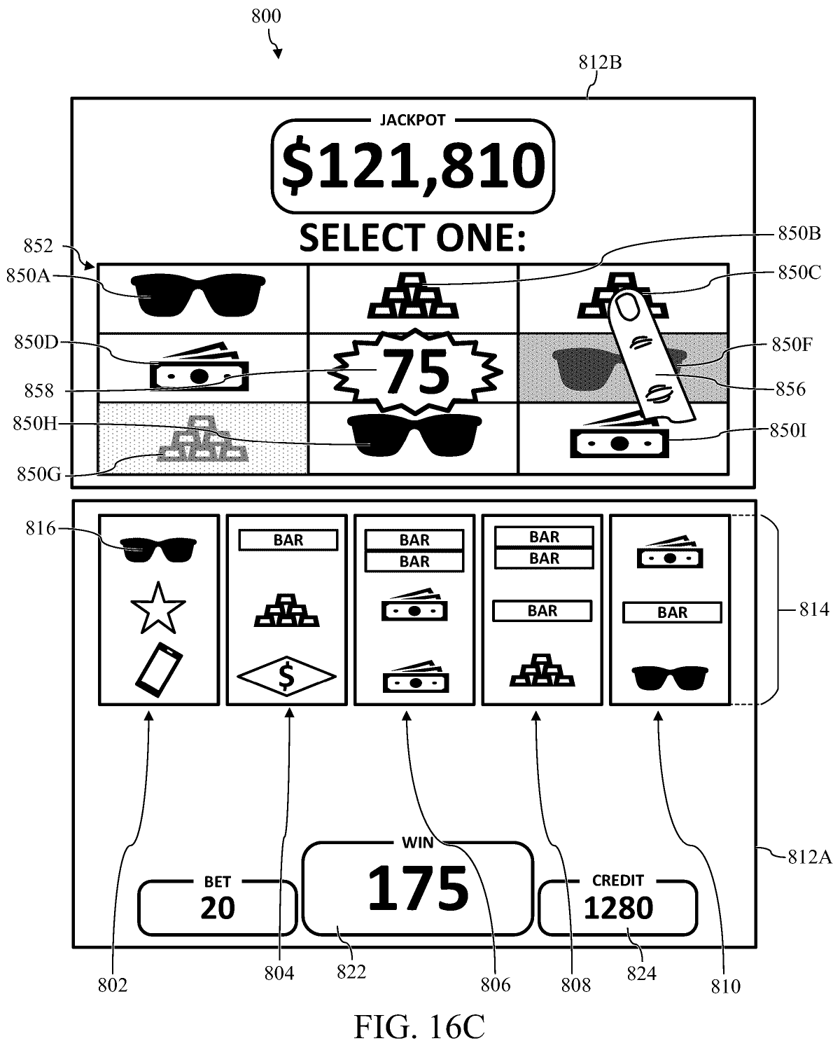

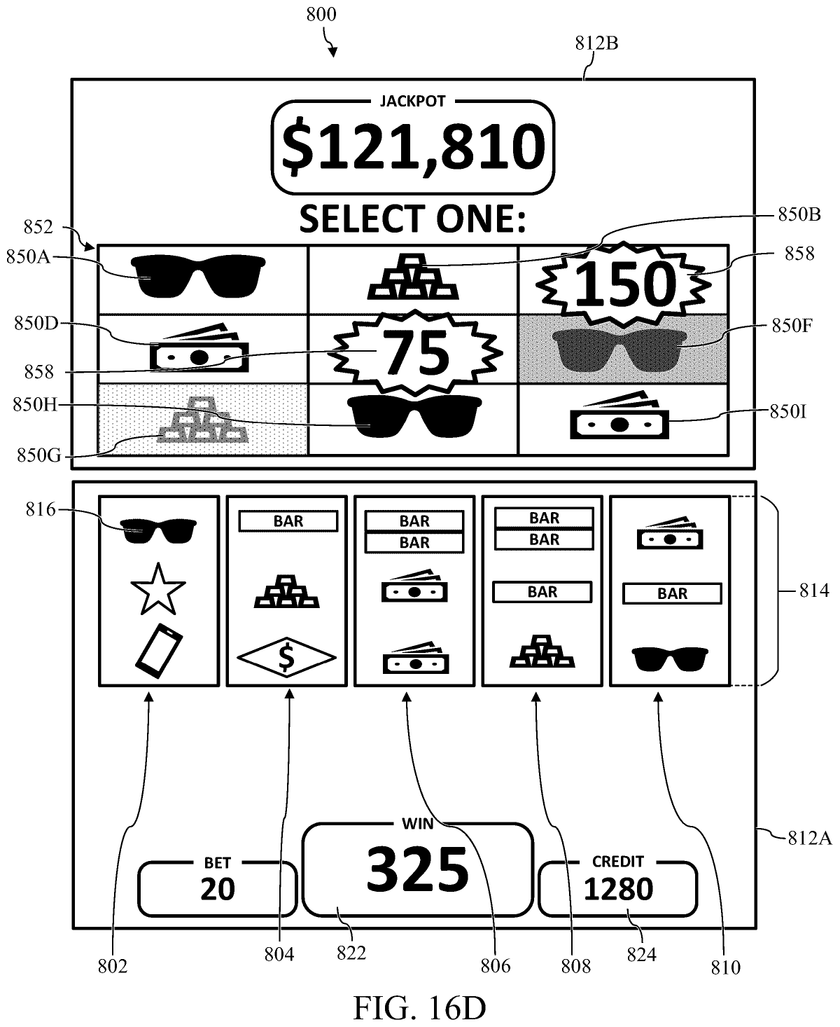

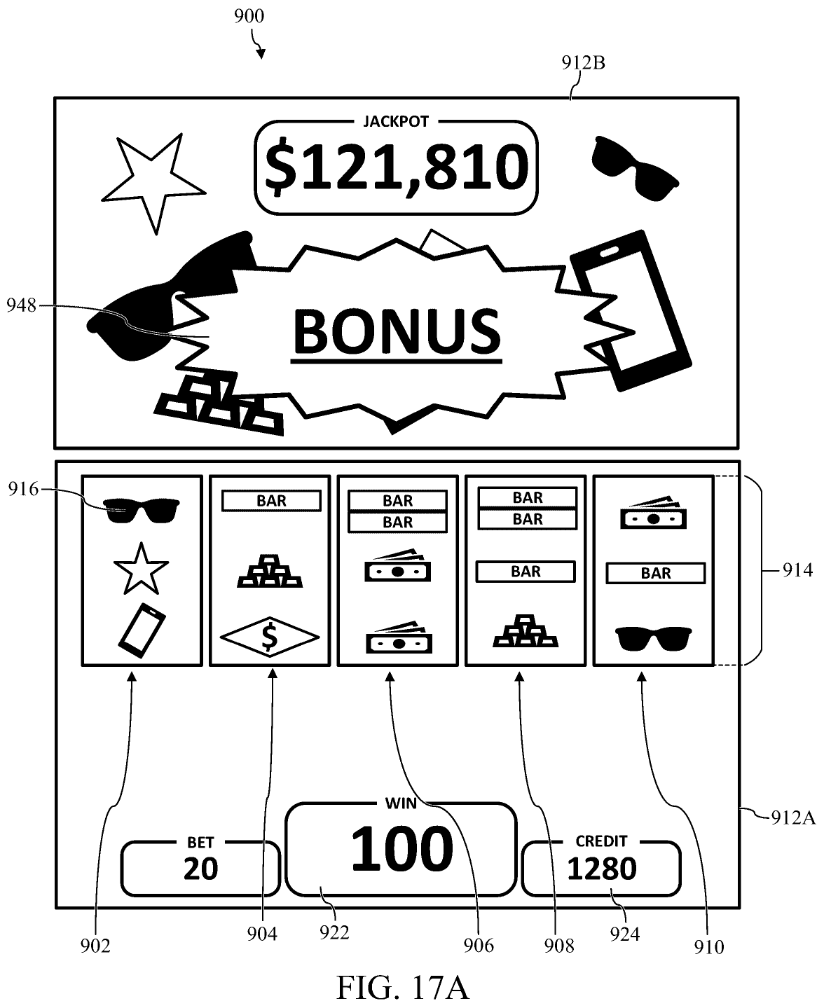

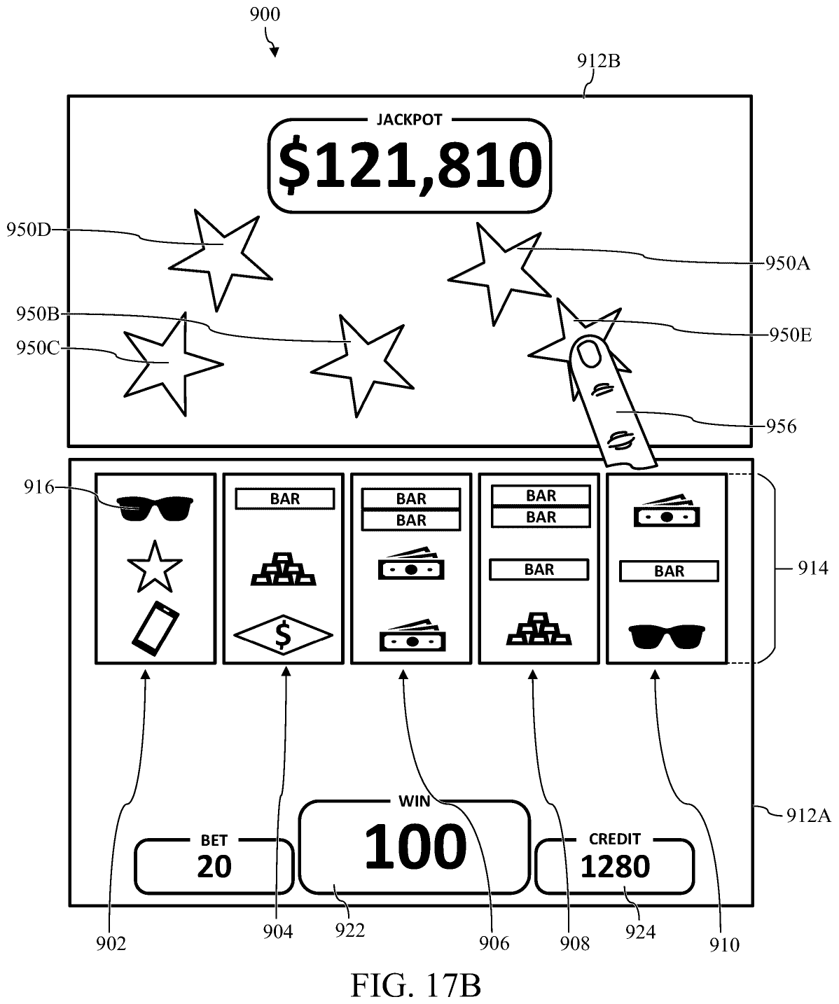

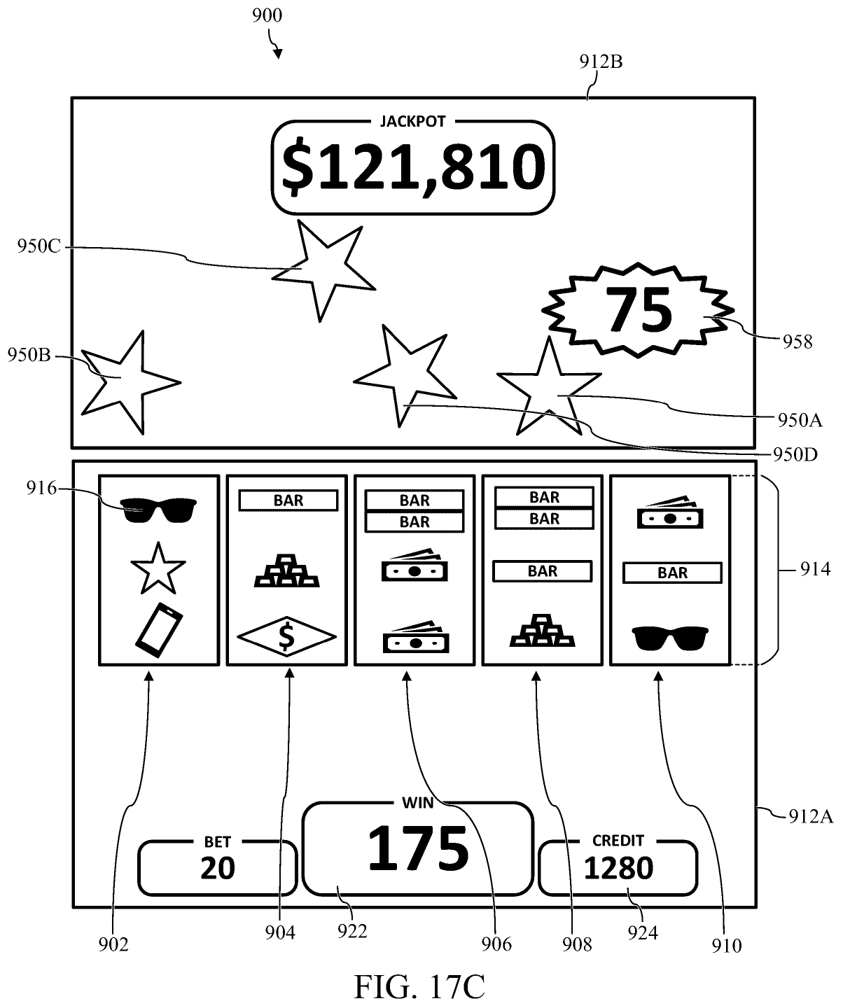

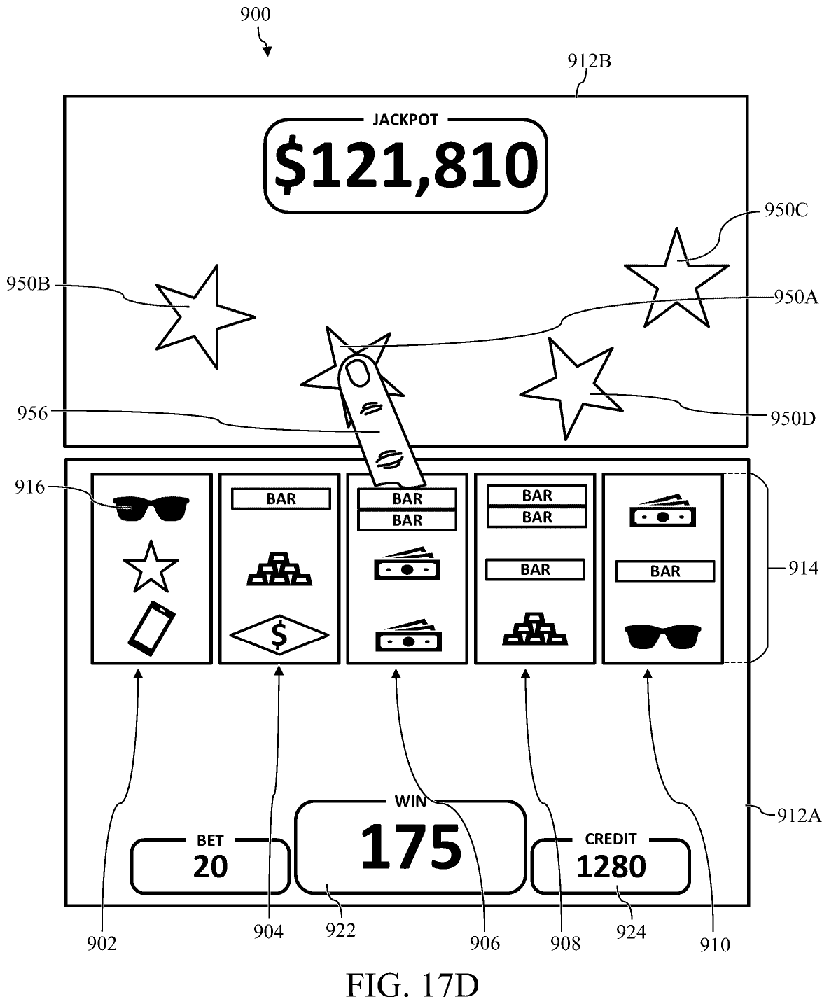

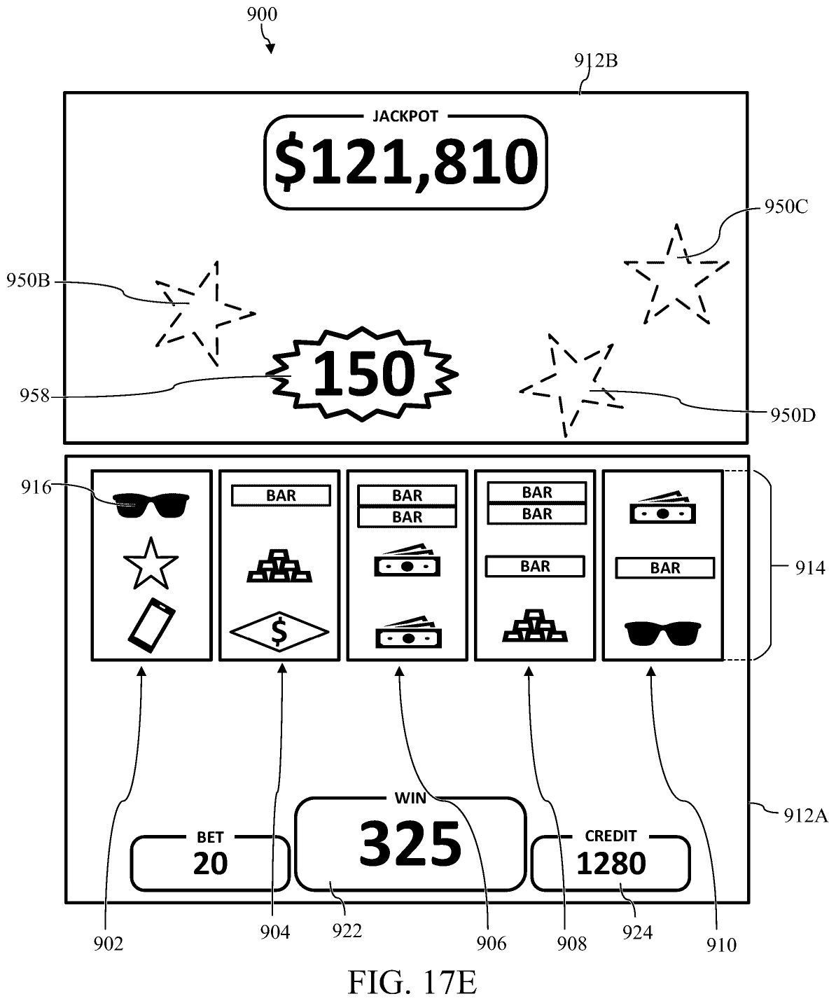

FIG. 15C is a user interface or screen shot displaying interactive bonus game 800 before a player selection. Interactive bonus game 800 includes a plurality of bonus game symbols 850 that are presented to the player on display 812B. In the non-limiting example, three bonus game symbols 850A, 850B, 850C are included in interactive bonus game 800 and are arranged in a grid pattern 852 on display 812B. In other non-limiting examples (see, FIG. 17A-17G), the plurality of bonus game symbols 850 can include more or less than three (3) symbols (see, FIG. 16A) and/or may continuously move in a random pattern. Additionally, as shown, interactive bonus game 800 can include instructions or a player prompt 854 instructing the player of EGM 100 to select one of the plurality of bonus game symbols 850A, 850B, 850C displayed on display 812B. In the non-limiting example, the user or player 856 may touch one of the plurality of bonus game symbols (e.g., bonus symbol 850A) depicted on display 812B. Touch enabled display 812B (and/or controller 202/processor 204) may detect, recognize, and/or identify the player's 856 touch, and determine player 856 has selected bonus symbol 850A included in grid 852 of interactive bonus game 800.

FIG. 15D shows a user interface or screen shot of an interactive bonus game outcome for interactive bonus game 800. More specifically, FIG. 15D shows the bonus game outcome for a first selection of bonus game symbols 850 by player 856 (see, FIG. 15C) of the at least one free selection or free play for bonus game 800. In the non-limiting example, bonus game outcome may award the player “75” credits. That is, after player 856 selects bonus game symbol 850A in grid pattern 852, an award credit notification 858 equal to or depicting “75” credits is presented to player 856 on display 812B. As shown, award credit notification 858 may take the place of and/or overlap bonus symbol 850A and be displayed in grid pattern 852. As similarly discussed herein, the credit value included in award credit notification 858 may be dependent upon and/or may include the credit value owed to the player based on the base reel game outcome (e.g., Class III game) or bingo game outcome (e.g., Class II game). The awarded credits identified by award credit notification 858 is subsequently added to win meter 822. In a non-limiting example where it is determined that the interactive bonus game 800 only includes a single free play, display 812B may remove and/or cease displaying interactive bonus game 800. Conversely, where interactive bonus game 800 includes a plurality of free plays, display 812B may be updated, adjusted, and/or altered to present additional free plays of interactive bonus game 800, as discussed herein.

In some embodiments, the credit values displayed on the display 812B, and associated with interactive bonus game symbols 850, are randomly selected using an RNG and a table stored in memory. In other embodiments, the credit values or symbols are selected based upon the winning outcomes associated with the player. In other words, when a player received a winning outcome, the overall credit value associated with the winning outcome is part of a look up within a façade table that helps to determine how the overall credit value will be awarded to the player (e.g., how many free plays and what value is awarded on each free play) and, as part of that lookup, the values and symbols to be displayed on display 812B are provided.

FIG. 15E is an exemplary user interface or screen shot displaying interactive bonus game 800 after a first free play. As shown, and subsequent to the first interactive bonus game outcome shown in FIG. 15D, interactive bonus game 800 may reset, be updated, and/or altered to present a subsequent or second free play. In the non-limiting example, interactive bonus game 800 may present the player 856 with a new set of bonus game symbols 850D, 850E, 850F in grid 852. Player 856 may again touch one of the plurality of bonus game symbols (e.g., bonus symbol 850F) depicted on display 812B. Touch enabled display 812B (and/or controller 202/processor 204) may detect, recognize, and/or identify the player's 856 touch, and determine player 856 has selected bonus symbol 850F included in grid 852 of interactive bonus game 800.

FIG. 15F is another exemplary user interface or screen shot of a distinct bonus game outcome for interactive bonus game 800. For example, display 812B shows a distinct or second bonus game outcome for a subsequent/second free play for interactive bonus game 800. In the non-limiting example, bonus game outcome may award the player “150” credits. That is, after player 856 selects bonus game symbol 850F in grid pattern 852, award credit notification 858 equal to or depicting “150” credits is presented to player 856 on display 812B. As shown, award credit notification 858 may take the place of and/or overlap bonus symbol 850F and be displayed in grid pattern 852. The awarded credits identified by award credit notification 858 is subsequently added to win meter 822.

In an exemplary embodiment, and as similarly discussed herein, each free play of interactive bonus game 800 may award the player with an increased credit value. More specifically, with each subsequent free play of interactive bonus game 800, the awarded credit value is equal to or greater than the credit value awarded in the previous free play for interactive bonus game 800. As such, player 856 may readily understand that with each free play of interactive bonus game 800, the awarded credit value will typically increase each play.

FIG. 15G is an exemplary user interface or screen shot that shows a bonus game outcome for interactive bonus game 800. That is, instead of presenting award credit notification 858 (see, FIG. 15F), player 856 may be presented with an action feature 834, such as a multiplier feature. In the non-limiting example, bonus game outcome shown in FIG. 15G may award the player a 2× multiplier feature 834. That is, after player 856 selects bonus game symbol 850F in grid pattern 852, action feature notification 860 depicts a “2×” symbol to player 856 on display 812B. Action feature notification 860 may indicate to player 856 that award credit values included in the bonus game outcomes for subsequent free plays of interactive bonus game 800 are multiplied (e.g., 2×). In non-limiting examples, multiplier action feature 834 may only take place for one subsequent free play of interactive bonus game 800 or may continue until all free plays are completed within interactive bonus game 800. Alternatively, multiplier action feature 834 occur indefinitely and/or for a predetermined time and/or number of interactive bonus games 800.

FIG. 15H is an exemplary user interface or screen shot displaying interactive bonus game 800 after a second free play and/or the selection of multiplier action feature 834 (see, FIG. 15G). As shown, interactive bonus game 800 may reset, be updated, and/or altered to present a subsequent or second free play. In the non-limiting example, interactive bonus game 800 may present the player 856 (again) with the new set of bonus game symbols 850D, 850E, 850F in grid 852. Player 856 may touch one of the plurality of bonus game symbols (e.g., bonus symbol 850E) depicted on display 812B. Touch enabled display 812B (and/or controller 202/processor 204) may detect, recognize, and/or identify the player's 856 touch, and determine player 856 has selected bonus symbol 850E included in grid 852 of interactive bonus game 800.

FIG. 15I is an exemplary user interface or screen shot showing interactive bonus game 800 after the selection of bonus game symbol 850E (see, FIG. 15H), and before the determination and/or generation of the bonus game outcome. In the example, after player 856 selects bonus game symbol 850E in grid pattern 852, award credit notification 858 equal to or depicting “100” credits is presented to player 856 on display 812B. However, because player 856 previously selected and/or was awarded 2× multiplier feature 834 (see, FIG. 15G), award credit notification 858 shown in FIG. 15I may not represent that actual credit value to be award to the player 856 for interactive bonus game 800. In the exemplary embodiment, award credit notification 858 may be accompanied with an animation and/or transformative indication (hereafter, “animation 862”). Animation 862 indicates to player 856 that the credit value depicted in award credit notification 858 will be adjusted and/altered, and more specifically, multiplied.

FIG. 15J is an exemplary user interface or screen shot showing a distinct bonus game outcome for interactive bonus game 800. Specifically, the bonus game outcome shown in FIG. 15J is displayed after animation 862 is presented on display 812B, and the credit value depicted in award credit notification 858 is altered, adjusted, and/or multiplied. In the non-limiting example where the player previously selected and/or was awarded 2× multiplier feature 834 (see, FIG. 15G), the credit value initially shown in award credit notification 858 (see, FIG. 15I) is multiplied by 2×, before the final bonus game outcome is presented. Award credit notification 858 depicted in FIG. 15J accurately displays the multiplied credit value (e.g., 200 cr.=100 cr.×2) to be awarded to player 856 of interactive bonus game 800. The awarded credits identified by award credit notification 858 are subsequently added to win meter 822.

FIGS. 16A-16D are exemplary user interfaces or screen shots showing a sequence for interactive bonus games 800. Specifically, FIGS. 16A-16D depict another non-limiting example of interactive bonus game 800 included on display 812B for players 856 of EGM 104.

FIG. 16A is an exemplary user interface or screen shot displaying interactive bonus game 800. As discussed herein, interactive bonus game 800 includes a plurality of bonus game symbols 850 that are presented to the player on display 812B. In the non-limiting example, nine bonus game symbols 850A-850I are included in interactive bonus game 800 and are arranged in a grid pattern 852 on display 812B. In the non-limiting example, player 856 may touch one of the plurality of bonus game symbols (e.g., bonus symbol 850E) depicted on display 812B. Touch enabled display 812B (and/or controller 202/processor 204) may detect, recognize, and/or identify the player's 856 touch, and determine player 856 has selected bonus symbol 850E included in grid 852 of interactive bonus game 800.

FIG. 16B is an exemplary user interface or screen shot showing an interactive bonus game outcome for interactive bonus game 800. More specifically, FIG. 16B shows the bonus game outcome for a first selection of bonus game symbols 850 by player 856 (see, FIG. 16A) of the at least one free selection or free play for bonus game 800. In the non-limiting example, bonus game outcome may award the player “75” credits. That is, after player 856 selects bonus game symbol 850E in grid pattern 852, an award credit notification 858 equal to or depicting “75” credits is presented to player 856 on display 812B. As shown, award credit notification 858 may take the place of and/or overlap bonus symbol 850E and be displayed in grid pattern 852. The awarded credits identified by award credit notification 858 is subsequently added to win meter 822.

FIG. 16C is an exemplary user interface or screen shot displaying interactive bonus game 800 after a first free play. As shown, and subsequent to the first interactive bonus game outcome shown in FIG. 16B, interactive bonus game 800 may continue to display all unselected bonus game symbols 850A-850D, 850F-850I. That is, all unselected bonus game symbols 850A-850D, 850F-850I of interactive bonus game 800 remain in grid 852 and/or are continuously presented on display 812B during at least one subsequent free play of interactive bonus game 800. Additionally, as shown in FIG. 16C, at least one of the bonus game symbols 850 may be dimmed or shaded out for player 856. More specifically, unselected bonus game symbols 850F, 850G are dimmed in grid 852 and/or on display 812B to indicate to player 856 that the dimmed, bonus symbols 850F, 850G may not be selected in subsequent free plays of interactive bonus game 800. Unselected bonus symbols 850F, 850G may be dimmed because an associated credit value for those specific symbols are less than the previously awarded credit value (e.g., 75 credits). That is, before or simultaneous to the subsequent free play of interactive bonus game 800, any bonus symbol 850 included in grid 852 that includes a credit value lower than the credit value associated with the first bonus game outcome is dimmed. As such, and as discussed herein, with each subsequent free play of interactive bonus game 800, the awarded credit value is equal to or greater than the credit value awarded in the previous free play.

In the non-limiting example shown in FIG. 16C, and as similarly discussed herein, player 856 may again touch one of the plurality of bonus game symbols (e.g., bonus symbol 850C) depicted on display 812B. Touch enabled display 812B (and/or controller 202/processor 204) may detect, recognize, and/or identify the player's 856 touch, and determine player 856 has selected bonus symbol 850C included in grid 852 of interactive bonus game 800.

FIG. 16D is an exemplary user interface or screen shot showing a distinct bonus game outcome for interactive bonus game 800. For example, display 812B shows a distinct or second bonus game outcome for a subsequent/second free play for interactive bonus game 800. In the non-limiting example, bonus game outcome may award the player “150” credits. That is, after player 856 selects bonus game symbol 850C in grid pattern 852, award credit notification 858 equal to or depicting “150” credits is presented to player 856 on display 812B. As shown, award credit notification 858 may take the place of and/or overlap bonus symbol 850C and be displayed in grid pattern 852. The awarded credits identified by award credit notification 858 is subsequently added to win meter 822.

In an exemplary embodiment, and as similarly discussed herein, each free play of interactive bonus game 800 may award the player with an increased credit value. More specifically, with each subsequent free play of interactive bonus game 800, the awarded credit value is equal to or greater than the credit value awarded in the previous free play for interactive bonus game 800. As such, player 856 may readily understand that with each free play of interactive bonus game 800, the awarded credit value will typically increase each play.

FIGS. 17A-17E are exemplary user interfaces or screen shots showing a sequence for interactive bonus games 900. Specifically, FIGS. 17A-17E depict another non-limiting example of interactive bonus game 900 included on display 912B for players 956 of EGM 104. As discussed herein, the plurality of bonus game symbols 950 may continuously move around 912B, in a random pattern, until player 956 touches or selects the bonus game symbol(s) 950.

FIG. 17A is an exemplary user interface or screen shot after the bonus game 900 has been triggered. In the exemplary embodiment, display 912B shown in FIG. 17A provides a bonus game notification and/or animation 948 indicating that the base reel game outcome for base reel game 400 has triggered the interactive bonus game 900. Animation 948 may also provide instructions to player 956 that when interactive bonus game 900 begins, they must select or touch as many bonus game symbols 950 presented on display 912B as possible. As discussed herein, secondary display 912B of EGM 104 (see, FIG. 1) may be configured as a touch enabled display device to allow the player to engage with and/or play interactive bonus game 800.

FIG. 17B is an exemplary user interface or screen shot displaying interactive bonus game 900. Interactive bonus game 900 includes a plurality of bonus game symbols 950 that are presented to the player on display 812B. In the non-limiting example, five (5) bonus game symbols 950A, 950B, 950C, 950D, 950E are included in interactive bonus game 800. As discussed herein, each bonus game symbol 950 may continuously move in a random pattern around display 912B during interactive bonus game 900. In the non-limiting example, the user or player 956 may touch one of the plurality of bonus game symbols (e.g., bonus symbol 950E) depicted on display 812B. Touch enabled display 912B (and/or controller 202/processor 204) may detect, recognize, and/or identify the player's 956 touch, and determine player 956 has selected bonus symbol 950E visually moving around display 912B of interactive bonus game 800.

FIG. 17C is an exemplary user interface or screen shot showing an interactive bonus game outcome for interactive bonus game 900. More specifically, FIG. 17C shows the bonus game outcome for a first selection of bonus game symbols 950 by player 956 (see, FIG. 17B) of the at least one free selection or free play (e.g., bonus game symbol selection) for bonus game 900. In the non-limiting example, bonus game outcome may award the player “75” credits. That is, after player 956 selects bonus game symbol 950E in display 912B, an award credit notification 958 equal to or depicting “75” credits is presented to player 956. As shown, award credit notification 958 may take the place of bonus symbol 950E and/or bonus symbol 950E may disappear from display 912B. As similarly discussed herein, the credit value included in award credit notification 958 may be dependent upon and/or may include the credit value owed to the player based on the base reel game outcome (e.g., Class III game) or bingo game outcome (e.g., Class II game). The awarded credits identified by award credit notification 958 is subsequently added to win meter 922. In a non-limiting example where it is determined that the interactive bonus game 900 only includes a single free play (e.g., one bonus game symbol selected), display 912B may remove and/or cease displaying interactive bonus game 900. Conversely, where interactive bonus game 900 includes a plurality of free plays (e.g., multiple bonus game symbol selected), display 912B may allow player 956 to continue to select or touch bonus game symbols 950, as discussed herein.

FIG. 17D is an exemplary user interface or screen shot displaying interactive bonus game 900 after a first free play or the first selection of bonus game symbol 950E. As shown, and subsequent to the first interactive bonus game outcome shown in FIGS. 17B and 17C, interactive bonus game 900 may continue to display all unselected bonus game symbols 950A-950D. That is, all unselected bonus game symbols 950A-950D of interactive bonus game 900 continue to move around display 912B in a random pattern and/or are continuously presented on display 912B during at least one subsequent free play of interactive bonus game 900. In the non-limiting example shown in FIG. 17D, and as similarly discussed herein, player 956 may again touch one of the plurality of bonus game symbols (e.g., bonus symbol 950A) depicted on display 912B. Touch enabled display 912B (and/or controller 202/processor 204) may detect, recognize, and/or identify the player's 956 touch, and determine player 956 has selected bonus symbol 950A presented on display 912B of interactive bonus game 900.

FIG. 17E is an exemplary user interface or screen shot showing a distinct bonus game outcome for interactive bonus game 800. For example, display 912B shows a distinct or second bonus game outcome for a subsequent/second free play (e.g., second bonus game symbol selection) for interactive bonus game 900. In the non-limiting example, bonus game outcome may award the player “150” credits. That is, after player 956 selects bonus game symbol 950A (see, FIG. 17D), award credit notification 958 equal to or depicting “150” credits is presented to player 956. As shown, award credit notification 958 may take the place of bonus symbol 950A and/or bonus symbol 950A may disappear. Additionally in the non-limiting example, all unselected bonus symbols 950B, 950C, 950D (shown in phantom) may also disappear in display 912B. The disappearing and/or removal of bonus symbols 950B, 950C, 950D while displaying the bonus game outcome may indicate to player 956 that interactive bonus game 900 is complete and no more bonus game symbols 950 may be selected in display 912B.

In an exemplary embodiment, and as similarly discussed herein, each free play (e.g., bonus game symbol selection) of interactive bonus game 900 may award the player with an increased credit value. More specifically, with each subsequent free play or subsequently selected bonus game symbol of interactive bonus game 900, the awarded credit value is equal to or greater than the credit value awarded in association with the previously selected bonus game symbol. As such, player 956 may readily understand that with each time they select a bonus game symbol during interactive bonus game 900, the awarded credit value associated with each selected bonus game symbol 950 will typically increase.

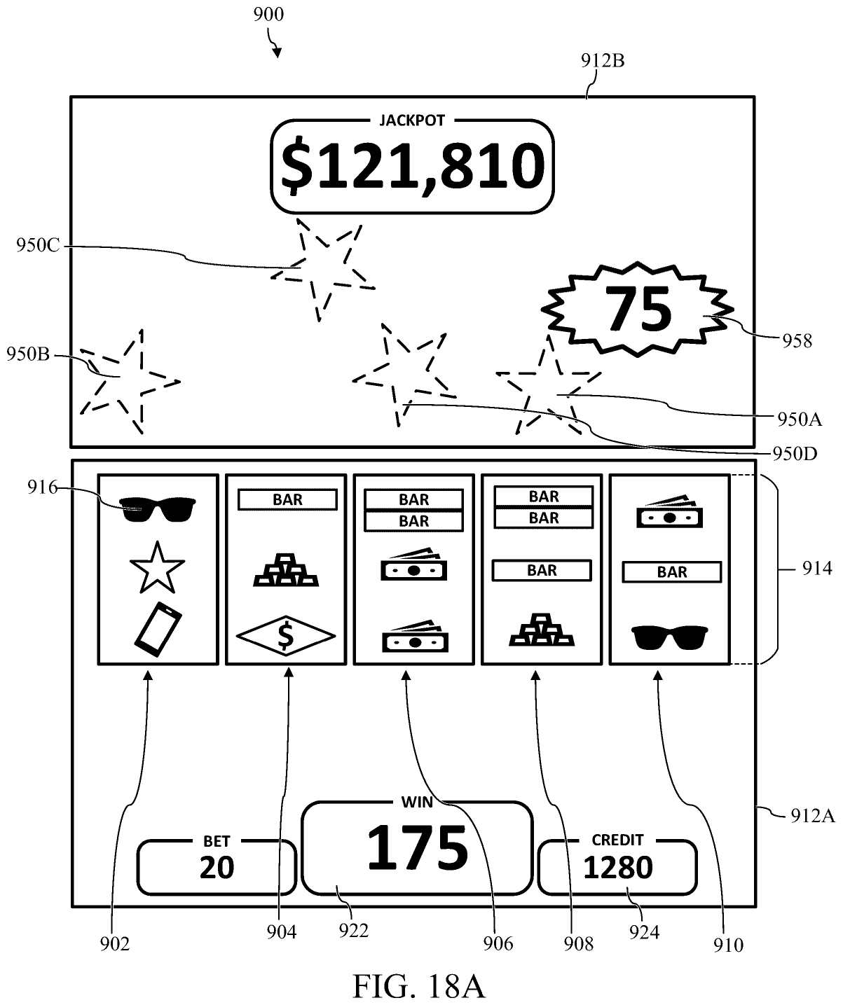

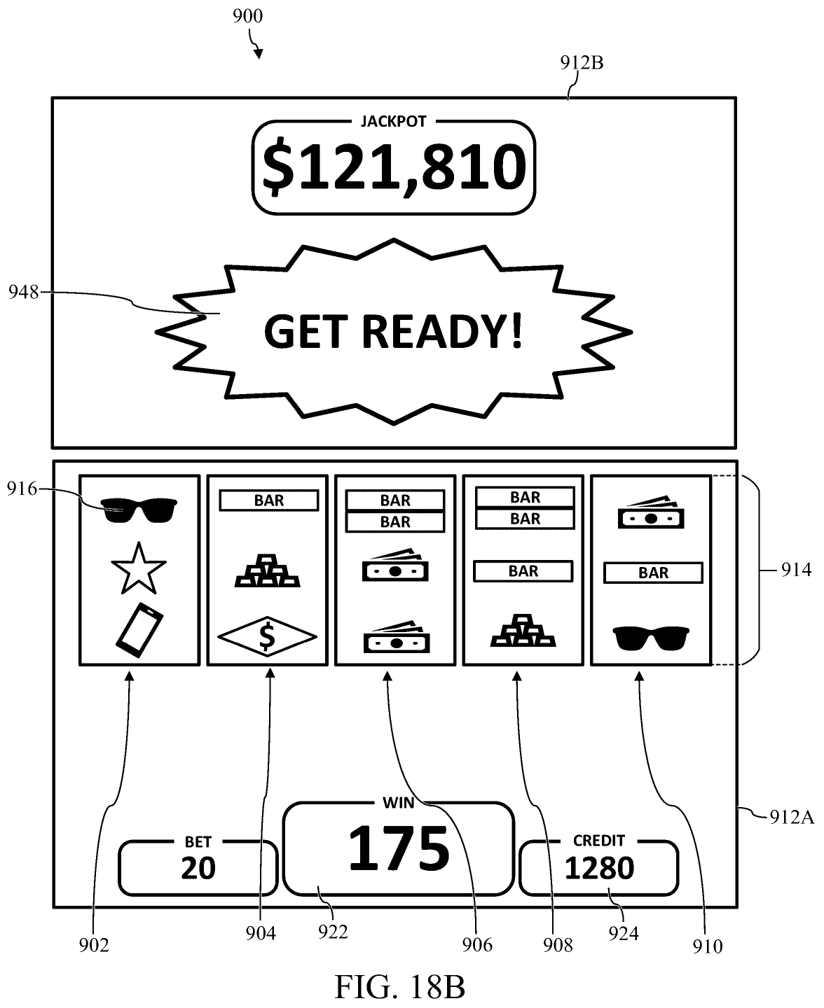

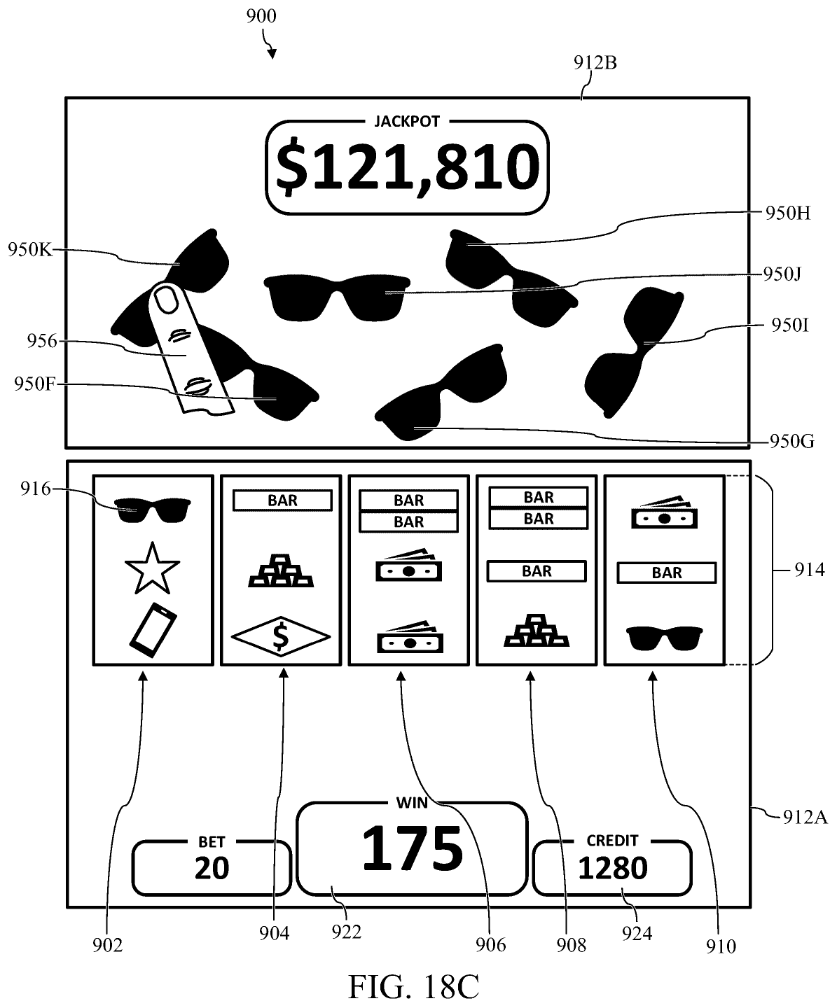

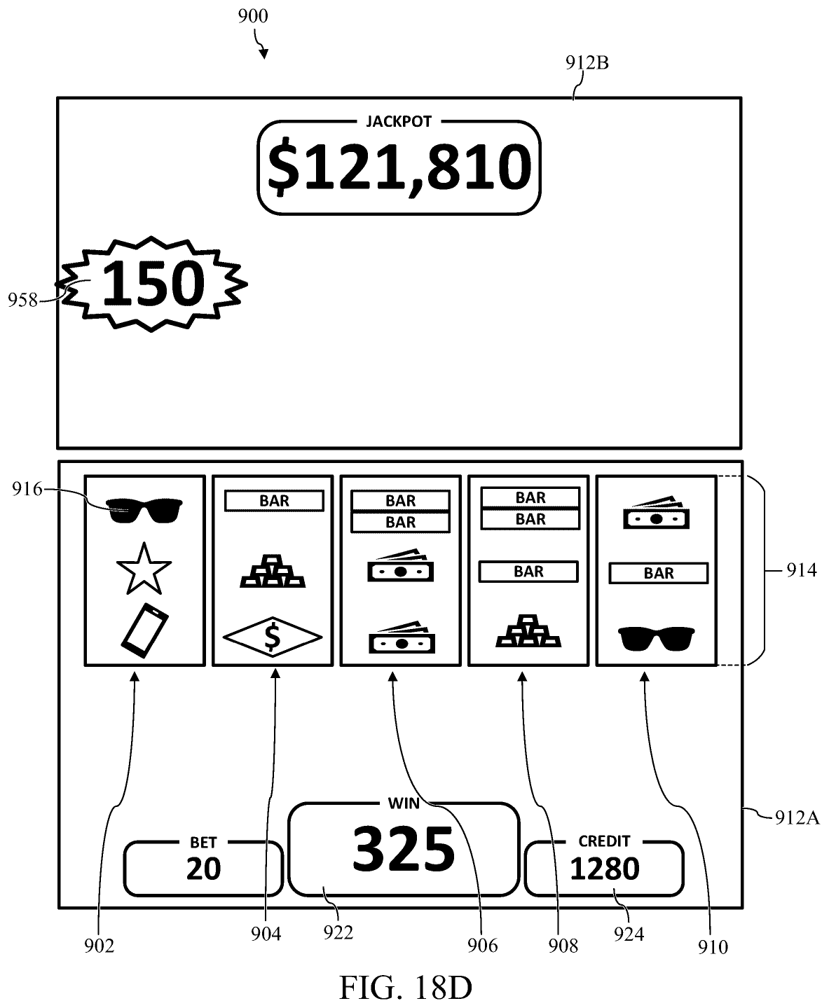

FIGS. 18A-18D are exemplary user interfaces or screen shots showing a sequence for interactive bonus games 900. Specifically, FIGS. 18A-18D depict another non-limiting example of interactive bonus game 900 included on display 912B for player 956 of EGM 104.

FIG. 18A shows an interactive bonus game outcome for interactive bonus game 900. More specifically, FIG. 18A shows the bonus game outcome for a first selection of bonus game symbols 950 by player 956 (see e.g., FIG. 17B) for bonus game 900. In the non-limiting example, bonus game outcome may award the player “75” credits. That is, after player 956 selects bonus game symbol 950 in display 912B, an award credit notification 958 equal to or depicting “75” credits is presented to player 956. As shown, all unselected bonus symbols 950A, 950B, 950C, 950D (shown in phantom) may also disappear in display 912B. In a non-limiting example, the disappearing and/or removal of bonus symbols 950A, 950B, 950C, 950D while displaying the bonus game outcome may indicate to player 956 that interactive bonus game 900 is complete and no more bonus game symbols 950 may be selected in display 912B. Alternatively, and as discussed herein, the disappearing and/or removal of bonus symbols 950A, 950B, 950C, 950D may indicate to player 956 that this “round” of selecting bonus game symbols is over, and a new round is to follow.

FIG. 18B is an exemplary user interface or screen shot after a first round of bonus game 900 has been played. More specifically, FIG. 18B depicts a user interface or screen shot of interactive bonus game 900, prior to the start of a second or subsequent round where player 956 can select another bonus game symbol 950. In the exemplary embodiment, display 812B provides a bonus game notification and/or animation 948 indicating or providing instructions for the next round of interactive bonus game 900 (e.g., “GET READY”).

FIG. 18C is a user interface or screen shot displaying interactive bonus game 900 after a first round of play (e.g., FIG. 18A). As shown, and subsequent to the first interactive bonus game outcome shown in FIG. 18A, interactive bonus game 900 may reset, be updated, and/or altered to present a subsequent or second free play. In the non-limiting example, interactive bonus game 900 may present the player 956 with a new set of bonus game symbols 950F-950K. Player 956 may again touch one of the plurality of bonus game symbols (e.g., bonus symbol 950K) depicted on display 912B.

FIG. 18D is an exemplary user interface or screen shot showing a distinct bonus game outcome for interactive bonus game 900. For example, display 912B shows a distinct or second bonus game outcome for a subsequent/second free play (e.g., second bonus game symbol selection) for interactive bonus game 900. In the non-limiting example, bonus game outcome may award the player “150” credits. That is, after player 956 selects bonus game symbol 950K (see, FIG. 18C), award credit notification 958 equal to or depicting “150” credits is presented to player 956. In the non-limiting example, all unselected bonus symbols 950F-950J (see, FIG. 18C) may also disappear in display 912B. The disappearing and/or removal of bonus symbols 950F-950J indicate to player 956 that interactive bonus game 900 is complete and no more bonus game symbols 950 may be selected in display 912B.

Although discussed herein as being included in and/or representing interactive bonus game 800, 900, it should be understood that touch enabled display 812B, 912B and bonus game symbols 850, 950 can also represent a base game, similar to base reel game 400. That is, the exemplary embodiments of enabled display 812B, 912B and bonus game symbols 850, 950 discussed herein can be included in bonus game 800, 900, or alternatively, can represent a base wheel game that may trigger a distinct bonus game 800, 900 as similarly discussed herein with respect to FIGS. 15A-18D. In another non-limiting example, enabled display 812B, 912B and bonus game symbols 850, 950 can represent both a base wheel game and a bonus game.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a display device; and
a game controller in communication with the display device, the game controller including at least one processor and at least one memory, the at least one memory for storing instructions, which when executed by the at least one processor, cause the game controller to:
control the display device to display a base reel game including a plurality of reels;
determine that a base reel game outcome of the base reel game triggers a bonus wheel game; and
control the display device to display the bonus wheel game including:
causing to be displayed a wheel feature including a plurality of wedges, each wedge of the plurality of wedges depicting one of a credit value or an action feature,
causing to be displayed at least one pointer positioned adjacent the wheel feature and configured to identify one of the plurality of wedges of the wheel feature, and
control at least one of the wheel feature or the at least one pointer to rotate and subsequently stop to determine a bonus wheel game outcome for a first free spin of at least one free spin, the bonus wheel game outcome including at least one of (i) the credit value depicted on at least one wedge of the plurality of wedges identified by the at least one pointer, or (ii) the action feature depicted on at least one wedge of the plurality of wedges identified by the at least one pointer.

2. The electronic gaming system of claim 1, wherein the instructions stored in the memory, when executed by the processor, further cause the game controller to:
control at least one of the wheel feature or the at least one pointer to rotate and subsequently stop to determine a distinct bonus wheel game outcome for a second free spin of the at least one free spin, the distinct bonus wheel game outcome including at least one of: (i) the credit value depicted on at least one wedge of the plurality of wedges identified by the at least one pointer, wherein the credit value of the distinct bonus wheel game outcome for the second free spin is equal to or greater than the credit value of the bonus wheel game outcome for the first free spin, or (ii) the action feature depicted on at least one wedge of the plurality of wedges identified by the at least one pointer.

3. The electronic gaming system of claim 1, wherein the at least one pointer includes at least one of:
an inner pointer extending radially outward from a center of the wheel feature, or
an outer rim pointer positioned adjacent to an outer rim of the wheel feature, radially opposite the center.

4. The electronic gaming system of claim 3, wherein in response to controlling at least one of the wheel feature or the at least one pointer to rotate and subsequently stop to determine the bonus wheel game outcome for the first free spin, the at least one processor further causes the game controller to:
control the wheel feature to rotate and subsequently stop, the wheel feature rotating in a first direction;
control the inner pointer to rotate and subsequently stop, the inner pointer rotating in the first direction or a second direction, opposite the first direction;
control the outer rim pointer to rotate and subsequently stop, the outer rim pointer rotating in the first direction or the second direction; and
determine the bonus wheel game outcome for the first free spin, the bonus wheel game outcome including:
the credit value depicted on at least one wedge of the plurality of wedges identified by at least one of the inner pointer or the outer rim pointer, or
the action feature depicted on at least one wedge of the plurality of wedges identified by at least one of the inner pointer or the outer rim pointer.

5. The electronic gaming system of claim 4, wherein in response to controlling the inner pointer and the outer rim pointer to rotate and subsequently stop on a first wedge of the plurality of wedges, the at least one processor further causes the game controller to:
determine the bonus wheel game outcome for the first free spin of the at least one free spin, the bonus wheel game outcome including the credit value of the first wedge of the plurality of wedges multiplied by two (2).

6. The electronic gaming system of claim 1, wherein the action feature further includes:
a free spin feature for adding a subsequent spin after the first free spin to the bonus wheel game;
a multiplier feature for transforming the at least one pointer to a multiplier pointer,
wherein the bonus wheel game outcome includes the credit value depicted on the at least one wedge identified by the multiplier pointer multiplied by a predetermined multiplier factor;
a pointer addition feature for adding at least one distinct pointer to the at least one pointer of the bonus wheel game; and
a boost feature for adjusting the credit value depicted on each wedge of the plurality of wedges.

7. The electronic gaming system of claim 1, wherein in response to controlling the display device to display the bonus wheel game, the at least one processor further causes the game controller to:
cause to be displayed a distinct wheel feature disposed around the wheel feature, the distinct wheel feature including a distinct plurality of wedges, each wedge of the distinct plurality of wedges depicting the credit value; and
cause to be displayed at least one distinct pointer configured to identify one of the distinct plurality of wedges of the distinct wheel feature.

8. The electronic gaming system of claim 7, wherein in response to controlling the display device to display the bonus wheel game, the at least one processor further causes the game controller to:
control at least one of the distinct wheel feature or the at least one distinct pointer to rotate and subsequently stop to determine the bonus wheel game outcome for the first free spin of the at least one free spin, the bonus wheel game outcome including:
the credit value depicted on at least one wedge of the plurality of wedges identified by the at least one pointer, and
the credit value depicted on at least one wedge of the distinct plurality of wedges identified by the at least one distinct pointer.

9. An electronic gaming system comprising:
at least one touch enabled display device; and
a game controller in communication with the at least one touch enabled display device, the game controller including at least one processor and at least one memory, the at least one memory for storing instructions, which when executed by the at least one processor, cause the game controller to:
control the at least one touch enabled display device to display a base reel game including a plurality of reels;
determine that a base reel game outcome of the base reel game triggers an interactive bonus game; and
control the at least one touch enabled display device to display the interactive bonus game including:
causing to be displayed a plurality of interactive bonus game symbols displayed on the at least one touch enabled display device, each of the plurality of interactive bonus game symbols associated with a credit value or an action feature, and
in response to at least one interactive bonus game symbol of the plurality of interactive bonus game symbols being selected via the at least one touch enabled display device, determine an interactive bonus game outcome for a first free play of at least one free play for the interactive bonus game, the interactive bonus game outcome including at least one of (i) the credit value associated with the at least one, selected interactive bonus game symbol of the plurality of interactive bonus game symbols, or (ii) the action feature associated with the at least one, selected interactive bonus game symbol of the plurality of interactive bonus game symbols.

10. The electronic gaming system of claim 9, wherein in response to controlling the at least one touch enabled display device to display the interactive bonus game, the at least one processor further causes the game controller to:
cause to be displayed on the at least one touch enabled display device the interactive bonus game symbols in a grid pattern, or
cause to be displayed on the at least one touch enabled display device the interactive bonus game symbols in a continuously moving, random pattern.

11. The electronic gaming system of claim 9, wherein in response to determining the interactive bonus game outcome for the first free play of the at least one free play, the at least one processor further causes the game controller to:
detect a user's touch on the at least one touch enabled display device to select the at least one interactive bonus game symbol;
cause to be displayed one of (i) the credit value associated with the at least one, selected interactive bonus game symbol of the plurality of interactive bonus game symbols, or (ii) the action feature associated with the at least one, selected interactive bonus game symbol of the plurality of interactive bonus game symbols;
in response to determining the interactive bonus game is complete, cause to be displayed on the at least one touch enabled display device the base reel game; and
in response to determining the interactive bonus game includes a second free play, cause to be displayed on the at least one touch enabled display device one of (i) unselected, interactive bonus game symbols of the plurality of interactive bonus game symbols, or (ii) a distinct plurality of interactive bonus game symbols, each of the distinct plurality of interactive bonus game symbols associated with the credit value or the action feature.

12. The electronic gaming system of claim 11, wherein the instructions stored in the memory, when executed by the processor, further cause the game controller to:
in response to at least one of the unselected, interactive bonus game symbols of the plurality of interactive bonus game symbols being selected via the at least one touch enabled display device, determine a distinct interactive bonus game outcome for the second free play for the interactive bonus game, the distinct interactive bonus game outcome including the credit value associated with the selected, unselected interactive bonus game symbol of the plurality of interactive bonus game symbols,
wherein the credit value of the distinct interactive bonus game outcome for the second free play is equal to or greater than the credit value of the interactive bonus game outcome for the first free play.

13. The electronic gaming system of claim 11, wherein the instructions stored in the memory, when executed by the processor, further cause the game controller to:
in response to at least one of the distinct plurality of interactive bonus game symbols being selected via the at least one touch enabled display device, determine a distinct interactive bonus game outcome for the second free play for the interactive bonus game, the distinct interactive bonus game outcome including the credit value associated with the selected, distinct interactive bonus game symbol of the distinct plurality of interactive bonus game symbols,
wherein the credit value of the distinct interactive bonus game outcome for the second free play is equal to or greater than the credit value of the interactive bonus game outcome for the first free play.

14. The electronic gaming system of claim 11, wherein in response to causing the at least one touch enabled display device to display the unselected interactive bonus game symbols of the plurality of interactive bonus game symbols, the at least one processor further causes the game controller to:
prior to the second free play, control the at least one touch enabled display device to dim the unselected interactive bonus symbols of the plurality of interactive bonus symbols that are associated with the credit value that is less than the credit value associated with the at least one, selected interactive bonus game symbol selected during the first free play.

15. A method of electronic gaming implemented on an electronic gaming machine, the method comprising:
causing to be displayed a base reel game including a plurality of reels;
determining that a base reel game outcome of the base reel game triggers a bonus wheel game;
causing to be displayed the bonus wheel game including:
a wheel feature including a plurality of wedges, each wedge of the plurality of wedges depicting one of a credit value or an action feature, and
at least one pointer positioned adjacent the wheel feature and configured to identify one of the plurality of wedges of the wheel feature; and
controlling at least one of the wheel feature or the at least one pointer to rotate and subsequently stop to determine a bonus wheel game outcome for a first free spin of at least one free spin, the bonus wheel game outcome including at least one of (i) the credit value depicted on at least one wedge of the plurality of wedges identified by the at least one pointer, or (ii) the action feature depicted on at least one wedge of the plurality of wedges identified by the at least one pointer.

16. The method of claim 15, further comprising:
controlling at least one of the wheel feature or the at least one pointer to rotate and subsequently stop to determine a distinct bonus wheel game outcome for a second free spin of the at least one free spin, the distinct bonus wheel game outcome including at least one of: (i) the credit value depicted on at least one wedge of the plurality of wedges identified by the at least one pointer, wherein the credit value of the distinct bonus wheel game outcome for the second free spin is equal to or greater than the credit value of the bonus wheel game outcome for the first free spin, or (ii) the action feature depicted on at least one wedge of the plurality of wedges identified by the at least one pointer.

17. The method of claim 15, wherein the at least one pointer includes at least one of:
an inner pointer extending radially outward from a center of the wheel feature, or
an outer rim pointer positioned adjacent to an outer rim of the wheel feature, radially opposite the center.

18. The method of claim 17, wherein the controlling of at least one of the wheel feature or the at least one pointer to rotate and subsequently stop to determine the bonus wheel game outcome for the first free spin further includes:
controlling the wheel feature to rotate and subsequently stop, the wheel feature rotating in a first direction;
controlling the inner pointer to rotate and subsequently stop, the inner pointer rotating in the first direction or a second direction, opposite the first direction;
controlling the outer rim pointer to rotate and subsequently stop, the outer rim pointer rotating in the first direction or the second direction; and
determining the bonus wheel game outcome for the first free spin, the bonus wheel game outcome including:
the credit value depicted on at least one wedge of the plurality of wedges identified by at least one of the inner pointer or the outer rim pointer, or
the action feature depicted on at least one wedge of the plurality of wedges identified by at least one of the inner pointer or the outer rim pointer.

19. The method of claim 18, wherein the controlling of the inner pointer and the outer rim pointer to rotate and subsequently stop on a first wedge of the plurality of wedges further includes:
determining the bonus wheel game outcome for the first free spin of the at least one free spin, the bonus wheel game outcome including the credit value of the first wedge of the plurality of wedges multiplied by two (2).

20. The method of claim 15, further comprising:
causing to be displayed a distinct wheel feature disposed around the wheel feature, the distinct wheel feature including a distinct plurality of wedges, each wedge of the distinct plurality of wedges depicting the credit value;
causing to be displayed at least one distinct pointer configured to identify one of the distinct plurality of wedges of the distinct wheel feature; and
controlling at least one of the distinct wheel feature or the at least one distinct pointer to rotate and subsequently stop to determine the bonus wheel game outcome for the first free spin of the at least one free spin, the bonus wheel game outcome including:
the credit value depicted on at least one wedge of the plurality of wedges identified by the at least one pointer, and
the credit value depicted on at least one wedge of the distinct plurality of wedges identified by the at least one distinct pointer.
